(19) United States
(12) Patent Application Publication
(10) Pub. No.: US 2006/0287783 A1
(43) Pub. Date: Dec. 21, 2006

(54) Automated accounting system that values, controls, records and bills the uses of equipment/vehicles for society

(75) Inventor: Richard C. Walker, Waldorf, MD (US)

Correspondence Address: WILMER CUTLER PICKERING HALE AND DORR LLP, 1875 PENNSYLVANIA AVE., NW, WASHINGTON, DC, 20004, US

(73) Assignee: Kline & Walker LLC, Potomac, MD (US)

(21) Appl. No.: 11/439,238

(22) Filed: May 24, 2006

Related U.S. Application Data
(63) Continuation-in-part of application No. 10/654,992, filed on Sep. 5, 2003.
Application No. 10/654,992 is a division of application No. 09/738,901, filed on Dec. 18, 2000, now Pat. No. 6,647,328.
Application No. 09/738,901 is a continuation of application No. PCT/US99/13668, filed on Jun. 18, 1999.
(62) Division of application No. 10/401,041, filed on Mar. 28, 2003, now abandoned.
Application No. 10/401,041 is a continuation of application No. 09/357,373, filed on Jul. 20, 1999, now abandoned.
(60) Provisional application No. 60/089,783, filed on Jun. 18, 1998.
(60) Provisional application No. 60/122,108, filed on Feb. 26, 1999.
(60) Provisional application No. 60/139,759, filed on Jun. 15, 1999.
(60) Provisional application No. 60/140,029, filed on Jun. 17, 1999.
(60) Provisional application No. 60/071,392, filed on Jan. 15, 1998.
(60) Provisional application No. 60/089,783, filed on Jun. 18, 1998.

(51) Int. Cl. G06F 19/00

(52) U.S. Cl. 701/29

(57) ABSTRACT

This invention addresses environmental social and commercial uses and includes a monitoring system which is a network of on, in, out and off-board devices working together with people through software and interfaces to provide services and make accountable humanity's machines and their actions through safe secure communication. Control devices are used to provide accountability for their socio-economic and environmental impact. Along with these systems networked together, additional devices and variations needed to complete these operations nationally and world wide are also provided. Unique ways interface a network of separate devices or IC circuits to create an interactive secure control system or center that can be remotely controlled. A control device for society to fairly and accurately monitor and control the impact of equipment use on the world environment, and a nation's infrastructure while developing commercial companies to fulfill these needs and services for the equipment and the people who own and operate them for today and into the future are also provided. A set of secure devices and systems are also included to analyze society and machine interaction.

### RELATED APPLICATIONS

This application is a Continuation-in-Part of U.S. patent application Ser. No. 10/654,992, filed Sep. 5, 2003, which is a Divisional of U.S. patent application Ser. No. 09/738,901, filed Dec. 18, 2000, now U.S. Pat. No. 6,647,328, which is a Continuation of International Application number PCT/US99/13668, filed Jun. 18, 1999 and published in the English language under PCT Article 21(2), which claims priority from U.S. Provisional Application Nos. 60/089,783, filed Jun. 18, 1998, 60/122,108, filed Feb. 26, 1999, 60/139,759, filed Jun. 15, 1999, and 60/140,029, filed Jun. 17, 1999, all of which are incorporated herein by reference.

Additionally, this application is a Divisional of U.S. patent application Ser. No. 10/401,041, filed Mar. 28, 2003, which is a Continuation of U.S. patent application Ser. No. 09/357,373, filed Jul. 20, 1999, which claims priority to U.S. Provisional Application Nos. 60/071,392, filed Jan. 15, 1998 and 60/089,783, filed Jun. 18, 1998, all of which are hereby incorporated by reference.

This application is related to U.S. patent application Ser. No. 08/975,140, filed Nov. 20, 1997 and PCT Application No. PCT/US97/21516, filed on Nov. 24, 1997, both of which claim priority to U.S. Provisional Patent Application No. 60/032,217, filed on Dec. 2, 1996, all of which are hereby incorporated by reference.

### BACKGROUND OF THE INVENTION

### Field of the Invention

This invention addresses environmental, social and commercial uses of a monitoring system. The monitoring system include, a network of on, in, out, and off board devices working together with people through software and interfaces to provide services and make machines and their actions accountable, through safe, secure communication and control devices in real time. The invention is designed to account for all machines vehicles and equipment and their socio-economic and environmental impact world wide.

Along with this completely described system is additional devices networked together and variations of hardware, firmware and software needed to complete these operations locally, nationally, and around the globe. These devices and systems are completely described within this application, and the other related applications incorporated herein by reference.

### BRIEF DESCRIPTION OF THE DRAWINGS

FIG. 1 is a key-coded flowchart diagram explicitly designed to state all the PFN functions from the invention's earlier patent control system embodiment (WO 98/24664 and PCT/US97/21516) stop box, black box which is combined presently with this billing box function designed to retrieve machine data to receive payment for machine use or account for impact fees to the individual, any commercial interests, the environment, and or for all levels of government to monitor, to cost, to report to the public, and/or manage machine use world wide socio-economically and environmentally.

FIG. 2 is a diagram displaying satellite technologies, G.P.S., communications, land-based phone systems and all wireless communication devices tied together to help keep track of the use of equipment worldwide and to link government, people and commercial interests in a coordinated, socially-responsible system.

FIG. 2a is a list or directory of government agencies that are already designed to issue their mass data back to the web account pages that this invention creates through its ability to acquire machine data and deliver it to these agencies and thereby allow them to due their government functions and report their gathered data and activities to the public, commercial interests and government on the specialized web pages described in this application (for local, state, regional, national and/or globally, if sanctioned).

FIG. 2b is an illustration that shows the invention and its explicit capability, as has always been stated from the first patent to monitor and control humanities equipment, machines vehicles and environment to provide a better social, economic, and a more informed public governance for every facet of technical and equipment use.

FIG. 3 is the add-on billing box system designed to initially receive payment for use of equipment and to due it through credit card billing. However, this system is the precursor of the OEM factory primary focal nodes that will be a part of all of humanity's machinery along with personal and environmental PFNs to help humanity assess and account for the use of resources and impact of all equipment on the world.

FIG. 3a is an extension of FIG. 3 and it illustrates how a card swipe is used and incorporated in the billing box or any PFN to enter credit card data into the MMN and account for any machine uses economically. The card swipe illustrates how all the devices can be coupled and or interfaced and have their manufacture software installed into the PFN for securing their interface to a host piece of machinery and deliver a specific data input or service under the electronic control of the processor in the PFN.

FIG. 4 is a example drawing of the function of a standard PFN secure box structure and a detail of the physical properties that are desirable to create the PFN interface to perform all the accountable functions of communications data storage remote control in the standard sedan. It is not the only configuration the invention will be and the description of the structure and materials are meant to also illustrate the concept of a secure environment for all these sensitive expensive electronical devices and critical accountable devices to monitor and control humanities equipment, machinery and/or vehicles.

FIG. 5 is a cutaway view of the secure box illustrating the mobility of the shelves and or trays that hold the interfaced devices as well as a structural illustration of a suggested design for the PFN secure containment in a sedan as pictured in the dash shown in FIG. 4.

FIG. 6 is a diagram of three shelves that are on rollers and powered to eject and retract inside the secure PFN interface and it also shows a suggested arrangement of protected PFN devices, secured customer preferred C.O.T.S. products, and a power tray as a good possible device array for a PFN.

FIG. 7 is a parts combination map of device coupling for the prototypes of the PFN's components. It is also to show the varied level of commercial developments in a general way. Most all devices couple together or interface from left to right and the sophistication of the technology goes from the most simplistic, at the top of the page, to the most complex, at the bottom of the diagram. This is only a general rule as their are a multitude of combinations that will function well to perform many and most all necessary task by different combinations. The device combining criterion is basically cost and efficiency for purpose and function desired.

FIGS. 8-12 show the Mac, PC, PS2 keyboard, mouse, and serial ports and, in fact, the next 5 to 7 Figures are just to name the standard computer connection, e.g., SCSI, IEEE 1394 and the new interfaces, IrDA ports, like in FIG. 11, as well as, other electronic and automotive connectors in FIG. 12. All of these physical connections are all utilized for many of the peripherals and for the many varied PFN configurations.

FIG. 13 is the standard cordless phone short-range interface as has been described earlier as an optional PFN interface. The drawing is an illustration of another use with a cordless phone and a laptop or palm top to get on land phone lines for data transfer without a hard, i.e., connected to the wall. There are two drawings, one pictorial and the other a block circuit drawing, with two options, A or B.

FIG. 14 is a personal locator belt that illustrates a G.P.S. system coupled to a reflex pager for registering and reporting a person's geographic location on a page request to at least one remote location.

### SUMMARY OF THE INVENTION

The present invention uniquely interfaces (on board) a network of separate devices and or interfaced IC circuits together, to create a “Primary Focal Node” (PFN) (ultimately in some form on every piece of equipment in the world). This is an interactive control center (ideally secured and protected) and connected to many peripheral devices and sensors, that can be remotely controlled and monitored from the (PFN). The (PFN) is able to, record and play back various data of different mediums, report this data back, or communicate it with off board “Gateways” to computer networks (like servers on the WWW) and/or receive from these Gateway servers commands to restrict unauthorized, and or affect normal uses of the vehicle/equipment in relationship to its cost and legitimate operation to society and the environment, and or regulate the vehicle to a compliance level to meet with any legal parameters and or commercial contractual agreements in real time. The present invention also uniquely provides a control device for society to fairly and accurately monitor and control the impact of equipment use on the world's environment and a nation's infrastructure.

The invention's (PFN) on board will provide the initial technical processes and hardware to fulfill these needs and services for the equipment and the people, who own and operate them for today and into the future. The total invention is designed to be a set of secure devices and systems interfaced on and off board to analyze society and machine interaction, and to safeguard this world's environment, which is the physical support system of humanities existence.

The invention comprises hardware, hardware embedded software (firmware), software programming, peripherals device and sensors on board and communication devices and computer network systems off board to do this monitoring and accounting business in a realistic and fair manner socially and economically. The invention is a composite of a number unique innovations that also interface uniquely with other commercial products to develop a complete and thorough accounting system, which is completely described in this application and the related filings.

A great deal of explanation is necessary to explain how the world's societies can utilize the total invention system in an optimal manner. So this discussion is based on humanities state of existence technically and socially and how the invention can best be a tool for societies to fairly make and assess their decisions crucial to a healthy existence presently and into the future. This summary of the invention will address accountability, responsibility and freedoms, as it pertains to world's societies, commerce, and the environment.

The present invention accomplishes the accounting and service tasks, by performing them in an efficient, economically expanding, but money saving and responsible manner. The general purpose and scope of this invention is to automate a data collection process, through two-way communication, that controls an onboard network of devices, sensors, machines, and to utilize data gathered from each machine's Primary Focal Node (PFN) to appraise it's impact and affect on the environment world wide and on any nations infrastructure. The present invention also provides software systems and support people to form the necessary set of mechanical and system structures for humanity to control its machines and its economy from now long into the future in a secure manner (i.e., technically, socially, and physically).

Newly created industries (e.g., commercial businesses evolutions), all technical devices and their interfaces, as well as any integrated circuit evolution for onboard, outboard and off board systems (e.g., hardware, firmware, software interfaced C.O.T.S. and personnel) to implement the present invention will be completely described and illustrated as the invention relates to these socio-economic and environmental goals.

Examples of goals include: conserving and using the world's materials and energy sources and resources intelligently and fairly to insure peace in the world, while accounting for that use and any and all impact on this world's environment and humanity's general health physically, socio-emotionally and economically; also, to help provide, organization and control for the maintenance of individually free, lawful and secure societies world wide; to join individuals and their nation states and societies with an accurate understanding of their physical world and their impact on it and each other; and to provide more safe convenient and unintrusive and or individually respective services through new products and innovative uses of already existing technologies to improve the quality of life.

The invention's (PFN) is designed to ultimately create an economic accounting tool to evaluate and bill for the use of resources and provide a fair impact fee system for societies infrastructures as well as create an economic structure and device to fairly bill other safer and less toxic energy sources and systems. The invention's control system is a necessary technical evolution that can adjust the worlds economic tool, while helping to assure the least disruptive socio-economic path for a healthy and stable environment. For this to happen it is necessary to evaluate and account for all the use and impact for any and all energy sources as they are used in real time by all of humanity world wide.

Ultimately secure devices and secure communication are extremely necessary for the systems to have credibility and be respected for their accuracy and fair reporting. For this reason it is important that the accounting process be as secure as possible. The invention's secure (PFN) secure box and off-board systems (continuation from the earlier patent) can serve as an ideal economic transition device or tool, for the replacement of a gallon of gas, a barrel of oil or the tons of coal and coke, which are the measured products of fossil fuel industries that power the industrial nations and their economies. The world seems determined and destined to reduce it's dependancy on these products. And having options is the best form of security to calm real fears for scarcities for what ever reason. Having a way to measure use and impact has been a real major drawback to other energy sources especially some of the new ones, which will utilize readily available compounds and elements found in nature, world wide.

So how can they be economically regulated and made part of the economic tool and it's tax base? Oil products as unsafe as they are to transport, store, and use are easy to account for in charging and taxing for their use. For this reason the exploration and exploitation of different energy systems and technologies are forced to stay on the back burner, especially for mobile vehicles and equipment. It is important to remember individuals and their societies can make good changes and bad changes and good changes require knowledge and thoughtfulness on the economic impacts as well as the environmental impacts. It is important to have order and control when there is any change in the world's economic tool and the world presently has an oil-based economy.

However, with a desired change on the horizon, this is the perfect time to commercialize the invention as a transition system and ultimately as a permanent system for humanity to evaluate, appraise and control all of it's technology into the future. Before this time the inventions technology would be too expensive for any individual mobile piece of equipment. But presently, with all the merging technologies and new services and innovative products linking telecommunication, interactive highways, smart cars and automated robotics systems along with personal computers and global positioning systems and the tremendous development in standard automobiles, as well as a deepening concern for the world's environment, the time is absolutely right for this network remote control data record and accounting system that offers security, organization, accountability and a host of new services and products to the economies of the world presently, and will help for any secure merging or trusted interaction in the future. With the present developments in machine messaging and the latest energy sources and power train developments with electric vehicles, e.g., Electric Wheel, GM's EV1 cars are provided a most important ingredient for their economic acceptance “accountability controls” for their responsible use in and of a societie's environment and infrastructure. And it is a mistake to believe these new technologies will not bring their hazard environmentally as well, e.g., leaking, and gassing battery contents, etc. So the remote control monitoring recording and accounting will provide stability during this very necessary evolution for mobile platforms and stationary equipment and also to monitor the environmental impact of fossil fueled equipment. And finally, even if they are dependent on nuclear energy or electrical service the monitor, control and recording system of the invention will be able to report to society all the gathered data necessary to appraise and evaluate these use and impact costs.

On each individual piece of equipment, the secured (PFN) is linked to the invention's peripheral sensor system and processes pertinent data on each individual host machinery and transmits it to local, nationwide and worldwide computer processing and mass data storage devices for the environment, for traffic data, for law enforcement, etc., where it is evaluated in real time and processed according to predetermined software programs at all the above-mentioned levels.

For example, if it was an environmental data link evaluating the impacts of new energy sources any trial and error negative impacts on the environment and or any chosen commercial direction could be determined quickly to reduce the cost to everyone. The entire invention will allow; the public, commercial energy systems and resource suppliers other commercial service suppliers and government a new device and system to fairly revenue and be costed accurately and account for all use and impact of the worlds resources, materials and a society's infrastructure.

The invention's control system is needed and is being brought out and commercialized in a timely and responsible fashion so as not to rock the economic structure of the world as driven by fossil fuels. But to marry with these present systems and allow for timely world, national, commercial and public change with stability in all the economic markets and the public and private companies that will be affected.

The final aspect to keep in mind with this invention's impact is an awareness for all humanity to realize that a changing economic base can be an expanding economy and in this case change does not have to spell scarcity and disparity to any individual or business in existence now and/or into the future. However, humanity's intellect and growth has always performed optimally when coupled with flexibility in any socio-economic change, which is directly proportional to it's survival. And it is crucial that every individual be as responsible as possible in these changes and the use of all these interfaced technologies. And not just be driven by self interests, but remain always cognizant to those whom their actions will impact. However, this is quite impossible to achieve if they are not aware of their impact and not in communication with others and all their machines to reduce any synergistic affects world wide. This is the major function of the invention for society. To keep social awareness involved with private interest, at an individual level, while providing a basis for a fair exchange and knowledge.

The direction for economic growth and or individual financial success should be one that improves the quality of all life and preserves economic stability, and by any means does not disadvantage or disrespect others or the environment. This requires accountability for everything humanity does or does not do as a whole and or individually. With accountability insured by real accurate and up to date knowledge, society in mass can be very efficient in all the decisions regarding how to do all it's business together with it's technology and life. But it is extremely important that this be accomplished with less economic disruption and deceptive behavior, which has plagued humanity in the past as a necessary evil to give some base order to our societies in the way we account exchange provisions between individuals. Presently, the world only has receivable values and is unaware of the cost values as a group or individually in many cases. It is important to have all the data so all individuals can appreciate the world's spread sheet and understand bottom line issues that affect everyone.

There needs to be good communicative working relationships between all parties so that business can give good and necessary services, while governments can oversee and support a healthy commercial environment, and insure a fair and healthy interaction or interchange between the public and the business community, as well as, all branches of government itself. The present invention's purpose and design is to address these fears and dispels phobias for the individual in a socially, culturally, and economically sound and responsible manner, so all of humanity can function well publicly, governmentally, environmentally, economically and/or commercially, provided the individuals are all responsible and stay “Critically Aware”.

“We the People”, the public, are all of these things and can continue, through the invention, to be empowered in the same manner as constitutionally guaranteed with the most up-to-date data and interactive communication system owned in part, individually, and publicly, as well as, supported commercially. This will enable us to open the correct opportunities for the individual and society through the ability to make efficient, intelligent, social, environmental, technical decisions that are sound commercial choices.

The major answer is fairness and for it to work presently it must be accountable. The invention achieves this goal on a planetary level by combining communication technology, computer technology and all industrial technologies into a monitoring and control system of communicating equipment with its societies. It accomplishes this from first data acquisition with the invention's “primary focal nodes”, virtually on every piece of equipment. The primary nodes process and record all types of data that impact the environment and/or have socio-economic importance. Then all forms of commercial, private and publicly owned communication devices are used to transfer and or copy data to (gateways) for computer networks, where it is processed and recorded in mass management and storage systems, and if so deemed proper at national levels, retransmitted to the world wide web where it is presented to the public as world and national web pages. Local web pages, and state web pages, are prepared at their levels through the area of data acquisition and approved through security protocols before they are posted on the WWW in their respective pages. Ultimately all knowledge could be freely available, however, presently, the inventions recognizes the need for national state security systems and provides for editing protocols for any national security agencies intervention before presenting it worldwide. Ideally, knowledge and individual development will replace real fears with the proper social mechanisms to grow trust.

The web pages are tied together in a traditional web mosaic technology to allow the individual to surf and view all data as is used by governments and commercial interests and respond directly to issues at all the levels of interest and evolvement. This data would have many informative tools to explain terminology objectively in one section. And in another portion of each page it would feature a point of view section, where government officials would state their individual positions on issues or raw data interpretations, the same for industry, and the same for research and educational organizations (by individual) and the same for the general public. This portion of the invention that provides feedback is the Machine Messaging Network (MMN) and it's interface with the WWW completes the accountability function for all societies and individuals.

This invention is designed to enfranchise the individual into all local, state, national, world issues and give a real voice to the individual as policy is being determined. The invention is also designed to enhance the development of the individual to continue to improve the quality of human existence on this planet.

Through this invention's complete system, society can slow the blind random, sometimes deceptive and more often ignorant commercial attempts to develop economy or control it or any specific industry in an effort to gain market share and present a public image. Many times these are false pursuits and merely to create economy—which, granted could be necessary and serve a timely economic purpose—thus making them worthy in and of itself). But, in so many cases these efforts, that are based on false or superficial data, and better deserve the term scam, i.e., many present pseudo-science projects, research groups and organizations involved with environmental protection. So, more importantly, the invention can give industries and governments real data, as well as in real time, provide any investors which will help insure and guide technical development through financial incentives to use resources wisely, to meet real informed and known needs, while being truthful to the public and suppling real and needed desired products and services. The invention can reduce any need to provide a false economy by providing more real innovations and opportunities. And this provision of real and valuable service for the growth of the economy can remove the “soft money” of today and stop the buying of results by funding and granting research with money that has private interest origins as well as funding our representatives with similar political commercial goals. This “soft money” will be used to buy public opinion or it will find a less costly and more appropriate way to do business in a really free enterprise system that integrates everyone. The result at the very least is a reduction in generating waste and misuse, or lack of use, of all our resources. The invention can help to create a society intelligently, empowered with accurate data and awareness that could be coordinated efficiently in real time with purposeful directions for enterprises that can fulfill economic needs. The fact that these decisions would meet with greater public awareness that are geared to improve human life will guarantee more popular support and commercial acceptance to these market directions and their products for personal purchase and for public investments, which becomes a healthy, efficient and natural way the world and its populous desires to conduct business.

Through this invention, all of society can work together to make changes technically (while fully understanding all the impacts of these changes, i.e., on commercial interests, governments and personal individuals). Everyone's point of view should be addressed and accounted for in a deliberative process as much as possible and as efficiently as possible.

World banking organizations, brokerage houses, various financial institutions and stock markets around the world can use the invention to help their investors market plan and strategy as to trends and socio-economic goals and environmental considerations to intelligently invest in new and needed markets through knowledge and skill to continue to grow the economy in a healthy manner. In this way, people can still vote financially and individually and the public companies will be lobbying the public more directly and our government representatives less as time goes on, which can help to reduce the present day election use of all the soft money.

The present invention begins to place monetary value in worthy directions and uses our economic tool to serve society, as well as the individual, more efficiently. It provides a modality for the individual to be known and respected in a secure manner.

It also gives the individual personal understanding that we are all responsible partners that can make a difference, while profiting in a healthy combined coexistence with our science and technology, in respect to our society, economy and environment. The invention and this social process make it possible to more adequately give worth to the monetary value of wealth and it can continue this service with humanity through any necessary changes of our economic tool continuously being tailored by humanity's more emotionally developed descendants to best meet their needs in the future.

The invention can monitor and insure that any agreed upon policy terms made in conference agreements between nations, and between commercial interests, are adhered to in the most definitive ways. This could be a crucial assistance to many unorganized nations, who presently fall pray to corruption and crime that steals and markets away a nation's life essentials and resources for growth, while bullying and exploiting its populous. And it can also be used to help provide the necessary education and tools to achieve a better survival rate. The invention could aid greatly in nation building and to develop trust between all parties in an agreement to accurately inventory and account for provisions their movement and dispersement and monitor all these movements for any sanctioned world police force, that needed to interview in an area, where there was no or unacceptable self autonomy and plagued with savage and barbaric behavior that needed to be interrupted. By being able to give order and a organizational structure that could accountably in sure fairness time could be bought to quell anger and inform world opinion to best deal with any tyranny that was destroying a nation and its people internally.

The invention's interactive capability can be also used to develop a deliberative process with society's elected representatives (Madisonian Democracy). The representatives will be able to use the web page feedback to make well-informed, but most importantly, representative decisions in a timely and expedient manner, regarding equipment/industrial/public/private use geographically and worldwide, along with representing the populous on contemporary issues presented on the same web page, or compiled into a E-mail format for the representative to review quickly (described in the mass media and web page section).

The invention could continue to evolve by incorporating more well-informed individuals' instant participation through the computers interactive medias, e.g, new Web TV's Internet and other developing inexpensive communication networks to a point where a society or all societies would decide to operate their secure issues monitoring and voting web as the means by which they govern themselves and make decisions, especially on local issues. This would be a departure from the traditional Madisonian Democracy of representation to a more deliberative process for Democracy, incorporating all individuals. However, voting access through the invention would have to be insured, with confidential, secure personal identification numbers (PINs), coded to fingerprint conformation scanners (no name record after original approval). The fingerprint scanner would be attached to a pulse detector to insure a live voter. In addition, the present invention also provides a detailed description of the national and world uses. The present invention is coupled to the described data base systems of management and storage through commercial servers called “gateways”. The invention will in real-time gather data from operating machines and equipment, and make available for analysis processing and accounting of this critical data which has been requested by any world community organizations and has been sanctioned for release by the specific individual nations, for the purpose of forming issues for the world populous to review and decide on.

It is important to keep in mind that this invention is a versatile, composite set of innovative interfaces for existing products, devices, components, and net work technologies that span the globe to provide responsible and accountable remote control, in a progressive customized manner, that can be offered in the present, and is designed to stay current in the future. This is a unique function that the invention satisfies to be considered in a separate and unique category all its own.

And in this process to develop responsible remote control from basic machine messaging to full robotics, many unique interfaced innovative products have been created and developed and are also described and commercially detailed for development in this application and the other two filings.

The primary goal has been to provide innovative technical and commercial options for humanities industries to cost effectively provide the most accountable remote control to this new emerging technology of machine messaging by responsibly looking to the future, and to marry the invention to a free enterprise economy, guided by a free Democratic society which can govern all its technologies through a responsible, accountable and informative modality.

Once again, these systems and devices, for the most part, exist independently now in technologies in unrelated industries, and the specifics as to their coupling and interfacing is described in detail in this application. It is the unique combination of these devices and systems, including the hardware, firmware and software, to complete this needed human/machine network link of interacting monitoring and control components and systems that comprise the invention.

Both the individual and the public, “We the people”, have to accept our responsibility for our freedom and with a free enterprise economy and insure that, the economy values with responsibility and respect the individual's rights of freedom, and in this case privacy.

### BEST MODE FOR CARRYING OUT THE INVENTION

This is the billing box function extended from the black and stop boxes of the previous patent application referenced above, incorporated herein by reference, which was first employed and described with the initial technical devices to work with any interactive highway system/smart car development to make accountable the vehicle and drivers actions to society, while receiving payment for use of equipment and all resulting impacts and ramifications.

This application's best mode of carrying out the invention incorporates, the earlier stop box, black box and this present billing box as an all inclusive secured Primary Focal Node (PFN) that is ultimately part of every piece of humanities equipment. It also completely details the third embodiment of the first application which was an off-board control and monitoring system that received reports from the secure and recordable on-board remote control systems (PFN).

The first patent application detailed the private use of the smaller operated remote control system or network through standard commercial paging and cell phones system providers whether they were personal, private or commercially owned. They could be operated by a single phone call or a control center computer terminal node or gateway (commercial) to monitor and send machine messaging to locate and perform remote control functions.

It is the purpose of this application to focus on the networking of this first commercial control system as well as to network other similar technologies either onboard the host machine being monitored or into the larger off board control systems. The invention is designed specifically to protect and secure these functions. It also is designed to double as a platform to interface and organize all these separate devices and or their functions. This secured protected interfacing will be for communication systems, any utilized locating systems, control systems and total record and or data storage systems. And this is done to create a good working environment for all of these components. To protect them from rough service damage, deliberate tampering, theft, and to create as credible as possible a secure accounting device and system to appraise any user, or use cost for every piece of equipment in the world. This is intended for individuals governments, public or social groups, and or any commercial enterprises. It is intended to monitor and appraise any use of equipment.

To complete this accounting process all monitoring, communications and controlling systems that are involved in machine messaging presently will be networked together in one modality just like the World Wide Web (WWW) and also with the World Wide Web. This control system network of machine messaging (MMN) will play a direct part in providing up to date data to public government web pages to fulfill a fair accounting to the public. Many governments are presently providing web pages for public interaction already at the local, state and national levels.

In explaining the best mode to carry out the invention, all the hardware, firm ware and software possibilities for the on board (PFN) will be described and the off board monitoring, control and accounting systems will be described in the (MMN) and the (MMN\WWW) interfaces. The (MMN) is explained as to how it records and reports data to local, state and national law enforcement through the Justice Department's FBI Programs of mass data management and storage. Their systems for the Uniform Crime Report (UCR) and the National Incident Based Reporting system (NIBRS) the EPA's State Environmental and Hazardous Materials Departments and National Enforcement Investigations Center (NICE) These two protocols are used to show how to create many commercial interface service products to complete the invention's highway safety and law enforcement program (Spider Eyes) and (Green Eyes) program, which is the environmental watch dog program.

The accompanying billing box function has the ability to give real-time controls to any billing and payment process and it is designed to be a secure and efficient process. It will make it possible to pay with a credit or smart card system almost anywhere that the phone swipe system is located either on land lines or mobile applications.

These first described in, out, and off board hardware devices and software support systems will be the hardware containment, link-up of communication and software accounting systems for commercial server companies, and legal authorities to access and account for the complete system operations, remote service work, and guidance, while recording and reporting this data and charges for the environmental, socio-economic, and energy use impact. Environmental and energy use impact includes the wear and tear on roads and specifying the vehicles who are responsible for that wear and tear, while also identifying the geographic sections of highway involved, and also valuing any driver and equipment operational liability for insurance costing and evaluating, as well as reporting, recording accounting and controlling the legal operation of vehicles to complete the black box function as already described herein and in the previous applications listed above and incorporated herein by reference.

The invention was also deliberately conceived and designed to fulfill this purpose for all the new energy systems and powertrains that have no good or any material products that can be commercialized to operate machines (e.g., a gallon of gasoline) and/or any control machine use to match payment received. The invention can fill this void for society socio-economically and environmentally. This kind of monitoring will be needed to maintain accountability, stability and to bring about the changes for the commercialization of these new energy technologies. The invention can serve as a mobile gas station to receive moneys for these new technologies while assessing their impacts fairly and accurately in real time matching receivables to real use. Hopefully, fossil fuel suppliers will have insight and be flexible by embracing the invention these new technologies and plan to invest in these new technologies as they have for the exploitation of oil for the last century.

Hardware, Firmware, and Software Systems for the Invention's (Interface)—(Primary “Focal Node”) (PFN)

The physical properties and structure of the inventions primary focal node interface or secure box will be designed with the intent to be versatile for change but to universalize the structures to as few as possible configurations for all purposes. And especially for the automobile and transportation industry. It must be remembered that even though this application is accompanied with very specific drawings and descriptions that these in no way minimize limit or restrict the claims for any shielded protected or secluded interface in a host piece of machinery for the purposes stated in this application or any of the related filings.

The physical structure in most cases will have laminated walls with the first surface a 3/16″ or less thick plates of abrasive resistant steel (AR plate) or steel of greater hardness. The center section will be a composite of Aerogel Space Tile, “Solid smoke” or “Geo bond”, and the final layer for the interior surface of the box is of ⅛ inch steel to the same AR Plate standards as the first plate.”

AeroGel” or “Solid Smoke” is made of silica, alumina and carbon as well as other materials. And is like having a solid piece of vacuum in this center area and this is why it does not transmit radiant heat. It was developed through NASA research to replace the space tiles on the shuttle to protect against the high heats generated on reentry through the earths atmosphere. Presently it is being marketed for the construction of refrigerators catalytic converters and furnaces. This products can insulate up to a 100 times better than the original space tiles. Geo bond is another product that is made from gypsum and other aggregate and silicates. These are but only two of the acceptable thermal insulating products on the market today and their mere mentioning here, is in no way intended to limit the inventions options on insulating products or systems.

For the automotive industry the invention has basically three shapes; it is prototyping but in no way is this to be considered a limitation on the designs possible and configurations needed either in the automobile industry or any other industry. There is a cube configuration that measures 12.5″ wide×12.5″ deep by 9′ high or longer for almost all regular sedans. This box replaces any need for a glove box and in many cases will also house the audio systems. A second design is a horizontal system that is 18-20″ long×12.5″ deep and 6″ thick internal. This system will be used in small vans or in center consol, or ceiling configurations. And the third one is the add on box system for commercial use which will not be a storage system for personal devices and its size will be governed by what products and services a company might want, e.g., a cab company or a truck fleet tracking program. But all will sooner or later carry equipment that are required to operate it legally, e.g., communication device a sensor array and record and report function and a G.P.S. as well as an automated shut down for the vehicle. The front of the cube will provide lockable access panels that can also be opened electrically and will close in some incidences from sensing inertia via inertia sensor or fluid sensors in stable reservoirs.

Once again these designs will be customized by the manufacturers and made aesthetic but ultimately they will have to meet a standard and will be tested to provide an acceptable protection for these vital devices and functions. There will be a government standard as there is for firewalls and the shapes and sizes will be standardized so many of manufactures can supply electrical accessories an peripherals. All mandated legal devices will be secured with a permanent access panel that only authorized persons can open and it will be an offense to tamper with any of this equipment or the area they are kept in. The size of this compartment can presently be greatly reduced. Manufacturers will integrate these products as they have been explained in this application, but this prototype was designed to allow individuals to add there own laptops and other loved accessories and many people in the future will look for this capability in an automobile rather than be put off by it. People have always been concerned for their valuables and having a mobile firebox and safe box will have as much appeal and so will the electronic, storage interface function. This is one major property of the invention's design and purpose is to provide a modular interface exchange with flexible customized compartments or areas to universally accommodate existing products. This was done to first provide a standard and a place to interface or to accommodate Commercial Off The Shelf (C.O.T.S.) products and personal accessories. And then to provide flexible retrofitting for future consolidated and integrated systems and their components. Basically, the customized versatility has been designed into the secure protective containment to increase the appeal for this kind of interface and to create a point to organize these merging technologies and to control and regulate them properly for society.

And, therefore, this invention's interface (PFN) device claims the right and capability to connect up with any diagnostic port or electrical connection (either hardwired or through infrared comports or any visual sensor arrays referred to in earlier applications (including fiber optics)) and use any software available or invented herein (i.e., OEM, or after market and/or C.O.T.S., and the like) to most easily accommodate or access any host piece of equipment's electrical and diagnostic system and individual devices or sensors either OEM or installed accessories either physically or remotely activated by and or controlled through this interface. Further, the invention claims the capability to install its own priority sensors, devices and software to either augment any existing host accessories or increase the capabilities of any diagnostic or analytical systems desired for any accounting application for services or products to be offered commercially and/or be described within this invention.

This versatility will allow all the individual communication, electronic, and automotive product manufactures to become involved and design specific shelves, trays, cassettes, cartridges, and or IC cards, etc. for the custom constructed modular compartments to feature their array of products and/or components.

Automobile manufactures will save space in the dash board area by storing some of their sensitive electronic components or those susceptible to auto theft OEM devices, i.e., CPUs/PC expensive audio and video components, etc. that will benefit by a secure, stable and easy to access for replacement compartments. And the box will actually replace the need for any traditional glove box as it can easily be used to provide a safer storage for personal property and legal documents (registration, etc.—possibly obsolete with electronic serial number and registration (ESNAR) stored on board).

The box will provide many modular options for the consumer and the manufacturers to customize. This holds initial automotive costs down for the base vehicle price and allows manufactures, dealers and aftermarkets to sell to the public to provide affordable upgrades and accessories for more comfort, ease and luxury as well as needed services. With this modular component secure system interface one can store all valuables and electronics and use them as well in a concise, organized and safe manner. Either modular trays cartridges, or I.C. component cards, etc. that can be removed and placed in a brief case or satchel and carried off for personal use elsewhere. These types of products, trays, cartridges that give structure to contain and connect products with electrical or electronical connections for interfacing them with other products of the invention and the host machine are products of the invention.

Modular Component Interface Products

Another configuration could take the form and still function as a small carrying case (like an entire brief case or woman's purse) which would hold a persons desired electronic device array (a mobile office, etc.). This entire case would have a connector (USB) probably on the case or an IR communication port so that it would either jack right into the vehicle secure box or optically communicate with the interface system either where a space was provided for it internally or connected to the connection array bus or (USB) on the front of the secure compartment. And this way the owner could use the interfaced case, charge its components or individual devices and, if so desired, protect it in transit or when s\he was out of his\her car.

There are many manufacturers creating mobile offices out of brief cases that have cell phones, modems, laptops and G.P.S. system for the business man to use on the road, but not any that interface data with the vehicle. With this capability the customer could run their own diagnostics on the car mechanically. This would be customer owned CDs that can run on the spot complete shop diagnostics to give an owner complete electronic up to date report on his vehicle (either OEM supplied or another whole automotive after market for electronics and software (another cottage industry). More consumer options are that these software programs could be downloaded from Internet web site for a fee. The vehicle's Electronic Serial Number, Vehicle Identification Number (ESNVIN) would be entered when purged from the web and only one registration would be possible on the disk or on any down load encrypted. then the vehicles program would have to give its ESNVIN# before the program would run. Also these (PFN) interfacing plug and play personal carrying cases are another product of the invention.

Ideally these personally carried component systems would be stored and used in the protection of the invention's secure containment system because of the high cost of the devices. Some existing briefcase products do have chargers but they are not interfaced with the automobile's TTl, analogue or digital logic control system. This is a great benefit to the consumer with this personally owned and operated vehicle diagnostics system and interface. S/he immediately has accountability for any actions taken in the repair of their vehicle and they can have direct contact with any service provider, who can look at the same data give advice and prices or dispute another service providers diagnosis and pricing.

The invention can record, report and even print data through the many combinations of interfacing the varied C.O.T.S. devices and products available. So any interfacing or connecting of personal owned equipment to diagnose, view augment, record and or report whether secured or not when used by the general public for any and all vehicles, machines and or equipment are products of the invention when sold commercially for this purpose

Another good purpose for the invention's interface would allow two systems to synchronize their settings (e.g., clock timing and G.P.S. coordinates) with the vehicle having it's own G.P.S. chip set system and the mobile office brief case having a G.P.S. system or a hand-held unit one could set a “Trail” marker exactly where they left their vehicle and the hand held unit would guide them back.

The interface box will have a bus of connections that connect all the trays, shelves and or modular compartment areas. These trays etc, will offer some or all of the interface communication links listed below. There will also, be an external array of connections place for convenience in the vehicles cabin so that one can connect any desired additional devices in the cabin that might not require security or protection. This array of connections will be greatly reduce with the advent of the IEEE.(USB) or latest 1394 communication links, however, there is a great deal more hardware connections, light and sound as well as firmware and software to be accounted for. There will also be either another connector array or IEEE 1394 or USB “protected” connector outside the vehicle not just for convenience, but for a law enforcement officer to quickly ascertain any pertinent legal data stored in the protected data area with protected software protocols on the vehicle that must be satisfied by a legitimate legal request (described in innovative devices section).

This is a list of all the industries C.O.T.S. devices, their firmware (burned in software), and their hardware connections by manufacturer name. And also, their part descriptions that will be interfaced and incorporated thru the invention, which will connect them and protect them physically in order to preserve them in an optimum working condition in the best and most secure environment providable. This will help give them credibility, validity and accuracy for the accounting and control services they will perform for the public's safety and understanding. This allows all machine, materials and resource use to be monitored, data stored, reported and remotely controlled to provide the proper level of service and product to match the monetary receivables, e.g., for finance firms, leasing companies government agencies, etc. It also, allows for the same remote control and record keeping to insure legal and environmental compliance.

There may be some overlap in the listing of some of the specific interfaces and connections because of the vast amount of past proprietary developments in all the different industries and their devices, i.e., pagers one way and two way, cell phones and cell phone modems for analogue and digital, Satellite communications and G.P.S. specific system requirements, radio transmitting and receiving equipment, infrared, lasers and or optical sensors and other communication technologies, i.e., fiber optics etc., standard electronics, audio (voice), video, and regular hardware connections, as well as, all the massive standard and proprietary automotive interfaces and connectors and including a host of, other industries that are involved and also have proprietary coupling technology to be considered. So it will be difficult to prevent some repetition and duplication as this is an effort to be inclusive and demonstrate how unique the invention is in its purpose to interface all these diverse areas and devices.

It initially serves to universally integrate all these devices and systems in a C.O.T.S. module design for the public to learn and work with as well as be, at ease with. This is a major goal of the invention to make technology more user friendly for humanity, which will increase commercial demand and promote better understanding and proper use of the technologies. So this listing of parts devices and products of such a magnitude and detail is very necessary to adequately demonstrate to all of the equipment manufactures, governing agencies, the general public, and especially all those, who are skilled in all the related arts just how feasible the invention really is. Also, to introduce the inventions versatility to integrate and organize machine control and to show how useful this can be for society today and serve as a precursor to deal with future technologies on into the next millennium.

So this conglomerate list with descriptions of separate parts and devices interfaced is intended to show the real need for this unique universal secure interface system and it's purpose to make them accountable. It accomplishes this by offering a platform to utilize all these technologies together including the past (backward technologies), the present, and on through into the future (forward technologies). It is done though the invention and all it's innovations being specifically designed to become a logical primary “focal node” (PFN) as the interface control center and the primary point of accountability to synthesize data to a record and report it (communicate it) much like the PC's do with the world wide web (WWW).

However, in many cases this will be wireless to a “gateway” commercial server or provider, who will be regulated and licenced as a commercial, governmental, or public or private provider or server. They will have special protocols they must adhere to and they will be liable for security and privacy as the WWW “Gate way providers are presently for certain information, and much like running a radio station. The Federal Communications Commission (FCC), among many other government agencies, will have input and regulation control. Some of the other basic agencies are FBI's Uniform Crime Reporting system (UCR) specifically the FBI's National Incident Based Reporting System (NIBRS), EPA's National Enforcement Investigation Center, and Federal Highway Administration and Department of Transportation (DOT).

From this point the off board accounting and control system (MMN) monitors all relevant data, and processes it (initially sent by the primary focal nodes software program (vehicle secure interface). The off board processing system in one modality is a mass data management network using the same software as (WWW) (mosaic software) and presently (Hypertext Markup Language (HTML) This is detailed more in the Off board mass data Systems for the 1100 series and 1200 series (Spider Eyes and Greeneye programs) of the invention and will be forthcoming in this application.

Returning to the primary “focal node”, the invention uses this secure box interface on every machine to guide development from these more versatile modular products initially and then on to the best consolidate integrated circuitry to be secure based as hardware on each type of equipment configuration (and not just for automotive applications). This process allows for rapid functionality presently in the initial C.O.T.S. combinations and it provides for efficient condensing of size and space into ever smaller and more capable integrated secured systems, which also deserve and benefit from a safe and secure environment in their accountable service through the primary focal node (PFN) or the inventions secure box interface systems.

Many of these integrated consolidating circuits will be mapped out in this application, but the purpose for this C.O.T.S. interfacing will always remain a great necessity. And not just for retrofitting, but to allow the public with all these products (past, present and future) to have a modality to create their own daisy link interfaces to customize combinations for their own mobile work and leisure electronic equipment array or station, and also to provide it a safe and secure environment. The C.O.T.S. capacity to interface will allow all manufactures to couple all sorts of present devices and future unrelated devices in a inexpensive manner to asses there feasibility and frame there composite hardware designs, which will reduce proto typing cost for all equipment.

Telecommunication and Radio Frequency Interfaces—Pagers

The first patent was very extensive in the C.O.T.S. application of the standard pager showing how to use pager activation and access data through hard wire connections, sensing functions and or scanning the LCD display through optical readers to be non invasive of this C.O.T.S. product. As was described in the first application there has been a rapid evolution of pager technology and cellular phone technology. And both these technologies as C.O.T.S. Products have always been employed to deliver two way communication when interfaced in the inventions secure containment. But presently with both of these technology's advancements, i.e., pagers and cellphones they can deliver many more capabilities and functions to the inventions secure and accountable interface. With this in mind the invention first utilizes these new standard C.O.T.S. products to inexpensively complete more tasks by offering basic remote control in a secure responsible and accountable fashion that can meet all the basic public safety needs inexpensively through either pagers and their protocols or cell phones and their protocols or even utilize both simultaneously to perform different functions at the same time.

On the topic of interfacing and interconnecting, all the inventions devices, one of the latest pager developments, which is in keeping with the first patents non-invasive data acquisition embodiments has been given another simplistic avenue to couple devices through the tremendous gains in voice recognition technology and voice pager massage systems. This new technology has many manufactures in both the cell phone and pager industries just to name a few. Advanced Recognition Technologies Inc. (ART) Israel, International Business Machines (IBM) USA Lernout and Hauspie Speech Products NV. Dragon Systems Inc. Sensory Inc., Which supplies Uniden America Corp., who is the largest cell phone makers with speech technology from Sensory, and Intellivoice Communication. Advanced Recognition Technology has developed very good algorithms for accurate speech recognition by adopting them from the hand writing algorithms in the past and has converted them for speech to create a stream of digital data for many portable phone manufactures. They have Motorola as a cell phone customer and also Samsung and appliance maker Lucky Gold Star, who have done well marketing their cellular voice products in Israel and Korea. On the palmtops that have windows applications Philips Electronics and Sharp Electronic is utilizing ART SMART™ writer software by speaking short commands to their tiny machines, where keyboards are so small. For that matter there is a great deal of computers and software manufacture that have voice recognition software and they to will be mentioned and described as to the interfacing that will be possible.

However, the first ingredient to insure accuracy between machines for a voice communication interface is to create a sound proof environment so the interface between these smart C.O.T.S. products will have a controlled environment designed to allow them to accurately address each other specifically and transfer data in relation to their functions and the host machines needs and operation.

This could be done in the original computer/printer interface relationship with a “master” relationship for the controller or computer and all the other peripheral accessories as slaves. (Either the inventions controllers or computers, and or the host machine manufactures controller or computers and or the personal owners computer. They could be networked together or separate, but the master command for any sensitive data storage protocols will be burned in firmware in the secure containment as part of the data storage lock up and secured from changing any data content or commands, until freed up copied or erased by the proper authorities or physically removed and replaced by the same).

There are many commercially available products today both for pagers, pager component devices and cellphones and cellphone component devices that can easily be developed and innovated to serve in a vocal interface with no hardwires. Or as a quieter possibility and more uninterrupted and secure communication between machines, an interface design could feature more standard electrical connections, i.e., possibly even audio and or other little wires that could carry the audio signal which can be decoded for its digital value in each device or any compatible comport connections needed.

Either way this system would be outfitted to any voice producing and recognition technology that could be used in the invention. If the devices so equipped are stored in the inventions secured and protected containment section their interaction can be recorded with any number of audio recording and storage systems utilized by the invention which could be a part of the accountability programs for any and all the devices or products and or system failures. With a microphone in the closed compartment of the invention and recording the machines conversation to the record storage system, which is set up in normal operation to rewrite itself on a 20 minute loop; unless an incident protocol gives the command to store a specific recording, all the devices in the box will be accounted for at the time of an event or accident and can be properly assessed in the appropriate legal settings. With this operational data stored on the host machine and with it time and date referenced to coin side with any other operational data stored; this audio interaction recording will serve all that must review it better when they here it in the verbal language they speak. This allows more individuals to participate in any necessary judgment process without a lot of technical know how.

Multi-language capability and automatic translator functions would be easy to construct as the voice systems vocabulary should be structured for a set group of universal commands and alpha-numerical data similar to the limited English vocabulary universally used for international pilots. To identify the units that are interacting they can be named or numbered and a protocol for this mass conversation would have to be structured and sanctioned by the proper authorities. But most conveniently would be the ability to just add one other device to the invention and not be required to wire it in if the CP or CPU was voice capable and had voice recognition and so did the peripheral being added. Just set it in and with the appropriate software in the PC just ask it to install the new peripheral and the two could talk it out through interface through an install protocol.

Imagine the dialogue it would be like Mr. Roger's neighborhood. The person installing would say “Mr. Computer permit me to introduce Mr. G.P.S. (A) and then the computer would install the sound (A) in it's program and the G.P.S. would start its dialogue up by saying its own name (A) to be recognized. The computer will be ready to recognize voice numbers and the word latitude and longitude and time coordinates and any NMEA jargon. From here on out, it would process it through its Application programming Interface (API) and deal with the data in accordance to programed stack protocols for mapping, etc. In fact, the electronic voices could be given a standard pitch and dialect to make interaction more accurate and the learning of the voice patterns unnecessary.

The voice recognition technology offered by Motorola has an exclusive dealership for it's pager product. The dealer is Oi electric voice pager. The pager runs on AA batteries and can be easily inserted into the invention and use the battery peg system to energize it. (Batt. Peg can be used to give continual power to all devices in the trays or supplied by traditional AD/DC power connector jacks). The Oi pager uses Lernout & Hauspie's voice compression technology to store and replay messages. This same technology could be incorporated into a G.P.S. chip set or C.O.T.S. hand held receiver and be preprogramed to in the G.P.S. circuit to say the earth coordinates verbally when asked verbally by the inflection voice Oi Pager. And the Oi pager would send this less than 20/sec data to a receiving computer that provides the pager service offboard the inflection voice system for interpretation and tracking. The computer could have a voice recognition program and show the coordinate on the screen and pass them on to law enforcement, etc., or this could be done digitally and simultaneously and/or digitally solely, and only apply voice in a review process. This use of voice commands could actually be used efficiently and quite inexpensively between all the devices compartmentalized and similarly equipped and programmed to interact with certain and specific dialogues of protocol. In this case the tracking of a vehicle could be accomplished with just these two pieces of equipment. With a speaker/mic turned on to the cabin from the invention's compartment the operator or occupants could quite literally listen and verbally respond if they so desired to interact with all the machines and devices so linked. One immediate advantage here is a lay person can create the interface with the properly voice and processor equipped devices in seconds by just setting volume and inserting these to be C.O.T.S. devices into the compartment. The other good thing is s/he can also identify which components are malfunctioning by watching which ones are unresponsive or mute.

However, in industry and especially those like transportation there must be safeguards of operation which will have to be put into place so that if a machine or vehicle is in a critical situation the compartment can not be opened to any sensitive areas and the master controller system will be able to discern the proper protocol and its software or firm ware will maintain control and the proper environment for an integral interface. There also will be a computer request of the operator to repeat a (take command word) as the driver starts driving in the form of a verbal request from the systems master computer. And all but a law enforcement situation the driver would be able to deactivate or activate any and all functions that were programed in the car.

Some other of the Motorola C.O.T.S. products of interest that can make use out of the invention's environment and unique data record storage, universal interfacing, and be utilized inexpensively for simple remote control and for event accountability are the ReFlex 25, 50 and inflection data pager protocols, which can receive and return data. ReFlex 25 at 4- and 7 bit binary short messages with outbound signaling speed of 1.6, 3.2, or 6.4 kbps in three 25-kHz carriers in 50-kHz channel and receiving signaling speed of 800, 1600, 6400, or 9600 bps, and the Re Flex 50 also has a two way application of 4- and 7-bit binary short messages with a out bound signal as high as 25.6 kbps and receiving signal at 9600. And the Inflection Data which is a high speed two way data supporting pager protocol as many as seven channels subchannels each as fast as 16 kbps; 50-khz channel capacity as fast as 112 kbps its application is two way 4- and 7-bit, numeric and data out bound signaling speed 4-8-12- or 16 kbps/subchannel and receiving at 800, 1600, or 6400, or 9600 bps

All these C.O.T.S. pager protocols are arriving on the market as different paging devices and pager products and all of which can be interfaced with in the invention and enhanced by its unique properties and qualities.

People Pointer or Pet Locator Device

This innovative product like most all the products is an independent product interfaced in the invention and can be removed from the invention and hand carried or completely used separately, however in this case it is attached to a belt or collar and attached to an individual and or pet or some mobile object that one wishes to keep track of. It is a Motorola's ReFlex 2 way pager protocol as an ideal modality with two other components a micro processor with firmware (burned into a memory, e.g., EEPROM, so that it functions with a GPS chip set system (in this modality Philips) so that when the pager is called and given a coded message it would activate the GPS chip set and patch antenna to obtain a satellite position reading and return these coordinates back to an assigned number via a (gateway commercial pager provider) to the (WWW) and an assigned E-mail, i.e., the car or emergency support services. Actually Philips has an ideal G.P.S. and processor design chip set for this application along with the software.

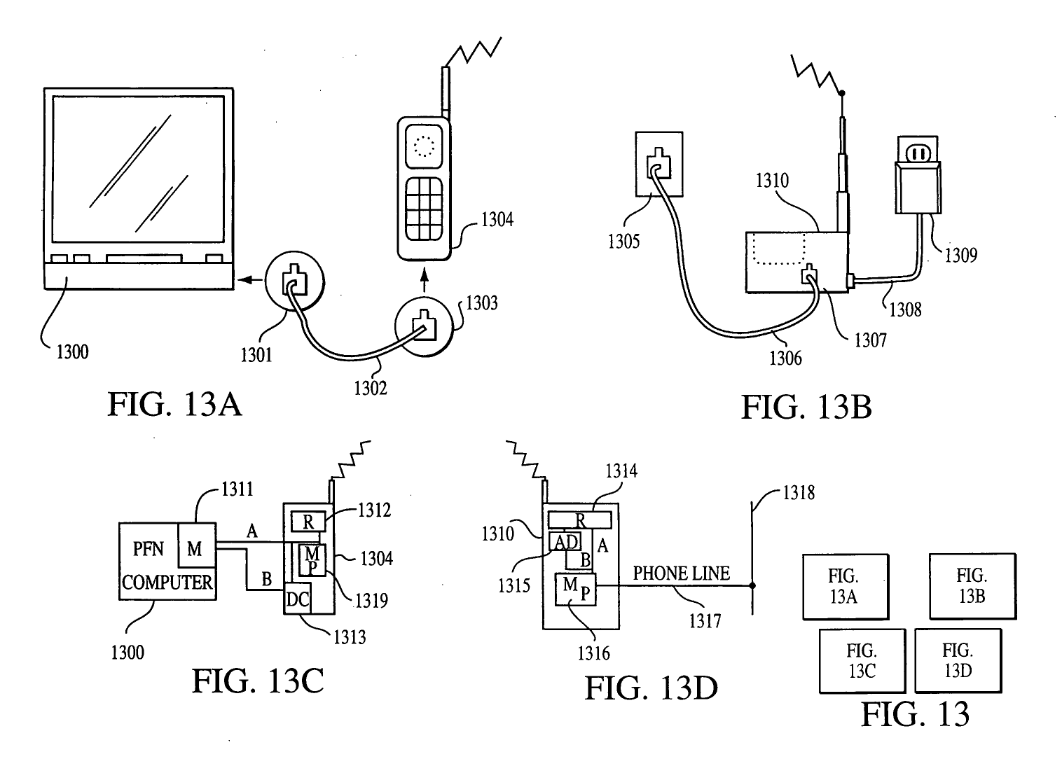

The two chips are SA 1570 and the SC 1575 which will operate on 3 volts. The 1570 is a double conversion, speed spectrum, radio receiver circuit with low cost filters and crystals that provide the communication component for the G.P.S. function. The second chip SC 1575 a 16-bit A is a base band processor and this microcontroller core can process the GPS data to provide velocity position and time outputs. The chipset is onboard a serial UART on the base band chip and is easy to connect to other devices to create integrated multi-functional systems. (Philips also and others (Ganged) for Europe and are developing two way paging for EMMIES protocol and when available this also could provide another transceiver function for personally held GPS to locate people and things. Or serve equally well as a C.O.T.S. in the box for European applications. Also, it is possible with Motorola's involvement in semiconductors that they to could develop a chip set or use someone else to complete this personal locator pager with their ReFlex pager protocols. However, this would still fall within the nature and scope of this very important innovation of the invention. (In fact, FIG. 13 shows recently developed G.P.S. chip set.)

And in another modality from the initial application there has been an alternate design and technology for a people locating device that incorporates a low noise FM signa and employs the (PFN) in every Vehicle to receive this signal in a multi band receiver and rebroadcasts it on long distance communications systems—two way Pagers—cell phones 2 way radios and it is referred to as the repeater function of the invention is also another separate by product of the invention's multiplex of communication interfaces accomplished in the (PFN). This close in repeater function is used in law enforcement, hunting products and, locating people as well.

Returning to the ReFlex pager and or two way pager protocols with GPS. Their use in the invention are also enhanced with respect to power considerations because the GPS reading would be current or not need a first cold reading. The 2-way pager GPS package would ideally be given close GPS coordinates under the cars energy before removing and or synchronized with any second onboard GPS, ideally some small chipset integrated into the inventions computer and storage compartment. If this 2-way pager GPS interface system was used continually independently it would require a greater power source or would be directed to keep a current reading to eliminate the power drains of cold readings. However, the GPS 2-way pager unit could be removed from the secure lockup and affixed to a person and they would be able to send signals back to the car via the pager service and the car would receive an E-mail via other pager receiver system or cell phone technology at which time the car would track all the trail markers sent back and record them and store them in the data storage. Also the pager commercial service could have an automated watchdog software that would track record and store and respond to emergency queries protocols. This commercial service is another commercial product of the invention (like a lifeguard system) attached to the 911 system and provided by commercial paging companies or any private monitoring companies that wanted to run either a phone node (Gateway) and or web sites to monitor for E-mail. Or the person could send it to a personal friends E-mail for them to monitor or their own E-mail. And on silent mode a parent could trigger the GPS and have it give the real-time location of their child and if it was a voice system as well they can listen on mute to appraise the situation or ask verbally.

Also, with an emergency button or the small key board available in the 2000 series Motorola ReFlex protocols the lost person could send the signal back or ask for help from a few selected sources by their own direction as they appraise their needs, police, EMTs, etc.

For pet use the signal would only be sent to the vehicle or other 2-way pager GPS or cell phone GPS system that could be hand held. This is also an easy technology for the cellphone systems to adapt to add. And finally this system could be coupled with the short range repeater systems that are detailed later which would send a local signal first for immediate use and action to locate a child near by, etc. and use any vehicle as a platform to repeat the signal to the proper authorities as a locator tool.

Motorola has another paging product from it's flex technology (FAST)—called Creatalink where it uses one-way and two-way pager protocols interfaced with a micro-processor and can perform remote control functions mainly in the automotive industry. These devices basically perform the same functions as described for the C.O.T.S. pager systems in the original stop and control box patents for this invention, when coupled to the inexpensive stamp computer in the secure containment. However, all the great variations of Creatalink would also be greatly enhanced and serve society better if they were interfaced and combined with the invention's unique interface systems and securement. The system would easily fit into a compartment of the invention as its physical measurements are 4.75 inches by 3.25 inches by 1″ and is easy to interface with many other devices.

The invention optionally uses the standard Motorola (C.O.T.S.) ReFlex 2-way pager and plans to use the Ermes style in Europe (radio products produced by Phillips for the most part when they are marketing their product) to produce its own low cost two way communications to report GPS coordinates. To first track a vehicle in the most rudimentary level with the invention's original Stamp II computer to fulfill for the least sophisticated and inexpensive remote control protocols, for tracking with GPS and law enforcement with a controlled remote shutdown as standard automotive equipment. This same paging system will be used for even more complicated remote and automated aggressive shut downs of a vehicle in real time that is designed in a sequential acceptably safer manner than any existing modality. For this entire process to stop the vehicle it can be accomplished with one coded phone page received and by the preprogrammed stamp II computer and the automated guidance, acceleration lockout, braking, and final vehicle securement, is controlled from this vehicle (PFN) computer. Ideally with law enforcement, but this system has been designed to handle an automated shut down if the vehicle is determined to be without any responsible operator control as an improved option to no control. These are the 940 series computer systems, and for these functions Motorola makes a second Creatalink product that can also work equally well in the protected (PFN) well called CreataLink™2 it has a internal and external antenna if necessary has a serial TTL interface/RJ-12 Connector/CLP Serial data protocol.

And for the integrated circuit construction to consolidate future functions in the invention Motorola sells a Flex receiver board under the name of CreataLink RX ™. Philips also sells similar products as another supplier of C.O.T.S. products and components. Any one of these systems either the components of this technology or the other manufacturer can equally function though the secure interface and this inventions technology. In the third patent application, all the remote control devices in the (PFN) and any of these communication interfaced control systems or communicacontrollers presently combined as C.O.T.S. products can perform the command functions and are all completely detailed as to how they perform on the vehicle/equipment.

For the very sophisticated remote control functions employing video or digital imaging and or sensor arrays for detecting road edge etc. The invention's secure (PFN) has 5 types of embedded types controllers it uses for different variations, supplied through Arcom Control Systems.

Motorola has a lot of its products licenced and being marketed by other commercial entities and one such company is Global Switch-All. A major product of theirs is “The Auto Protector” which is a anti-theft locator system with many of the autotheft functions that the invention completes but in a little different way. There are many other such companies on the market in the Cell phone industry and Radio frequency area and their is more each and everyday. And everyone of these products will be easy to accommodate in the secure encasement and if they are going to perform any remote control functions they should be recorded and made accountable. This is and will be the appropriate growth for remote control and full robotics of the future e.g Smart cars and interactive highways.

The technology to interface all these C.O.T.S. Motorola systems for Data transfer are covered in all three of these applications and in a number of ways. They are also described and displayed in drawings for a suggested progressive commercial products development for responsible remote control as prototypes and protocols. This is done to display the modular capability of the innovation's with COTS devices interfaced and the versatility built into making the invention compatible with all involved technologies to serve as the ideal interface for this massive technical evolution and merger. So by showing the development and the commercialization of the invention in this manner anyone skilled in these arts and even those modestly skilled including layman could achieve the necessary interfaces to make all the prototypes involving these above-mentioned Motorola and other C.O.T.S. developed products a reality.

Ermes and Flex Paging Application in the Invention

A little more description on the COTS paging products world wide that the invention interfaces.

The new paging applications that are responsible for this latest sophistication are European Radio Message system (Ermes) and FLEX which is flex stack Application Programming Interface (API). Flex is a product of Motorola and the basis for ReFlex the two way paging technology used in the United States and Asia, It has decided advantages over the Ermes applications that saves battery power and makes it easier to achieve two way paging. These are related to the frequencies used and the number of signals used to set up error correcting protocols. For this reason Ermes is forced to stay active longer and can not rest the battery as much or it risks missing messages. The Ermes systems have been developing the 2 way paging capacity with them soon to be available through (Ganged). However presently the flex stack of Motorola and the varied protocols available with more in the future. Motorola is quite proprietary with its decoder firm ware managed by their stacker, however both paging applications Ermes and flex can be interfaced into remote control functions through the inventions interface and both are increased in value by the inventions systems and protection.

Cell Phones

Cell phone systems have a number of companies directly producing modems that convert the cell phone into a data link for Laptops, palmtops programmable controllers Etc. For the lap and palm tops they come with 2 in 1 PCMCIA (PC card)s to be able to use your laptop or palmtop like a desk top in a mobile situation through analogue telecom lines at 14.400 or 33.600 or through a digital GSM cellphone up to 56k bytes/sec. These are the COTS products and systems on the market today that can be interfaced in the invention to be a secure and varied interface that is protected. The pager interface connectors will also be listed for one way and the logical development of the two way pager that are cots products and described as the original communication link and system for the stop box.

There is also other connectors that will be used in the invention that do not involve portability. In the event that the invention may be stationary and being used in other industries that will employ land based lines, regular modems and or some other communication system to either remotely control, record and or report machine use from this secured environment.

The company Option International, is one of many companies offering interfaces and cable connectors to interface laptops and PC″s with peripherals so these supply companies will not generally be listed, however, most all relevant parts and interface systems will be referenced here.

These modems work through the digital GSM cellular systems for the most part but presently it might be necessary to have two phone numbers to presently handle data and voice separately due to the inadequacies of the fixed line exchanges/switches so the cell phone in this modality will have one number to better direct and handle data at 9600 baud, data at 2400 baud and fax at 9600. However, with all phone systems constantly improving their hardware, and capacity in digital technology this situation will be remedied which will reduce the need for two numbers on one cell phone.

And there are many cell phone manufactures like:

Nokia 2110, 2110i, 8110, 3110, 6080--

Panasonic G350.g400, g450, g500--

Ericsson 388, 337, 318, 688, 628, 768, 788

Sony CM-D 100, CM-D 200, CM-DX 1000

NEC G9

AEG TP 9050

AT&T 3240, 3245,

just to name a few that have modems basically made by Compaq, Hays Option, and 3Com that have cable connectors to interface with Lap tops and PC's. These same connector are set up on all the inventions computers and controllers to allow data links to remote locations and are stored in the (PRN), which is where any lap tops and palm tops could be housed and operated from as well.

Other Cell Phone Systems

3COM-USR Megahertz, 3COM-USR, ADC Kentrox, Bay Networks-Spec G10, Belkin Components, Cisco Systems, Motorola ISG,

Xircom. And the cable connections they place on the ends of the cables are:

Motorola, Pioneer, JVC, Nokia Telephone Radio SHKXJ/CC 4336/5560, XJ/CC/EM 4288/4336, STARTAC CELLPHONE, Ericcson, EM models 5560X and RS232, TC MP-DB9F, TC MP-CISCO 2500 SERIES, TC MP-DB25F DB25P-V.35F CBL, 7834-44PIN-V.35 SYNC PASS.

These are just a few of the commercial off the shelf products that will be incorporated into the invention and are only named to demonstrate that basically all cell phone products will be outfitted to easily interface with portable computers and the average person will be able to install and interface these products in the secure interface with relative ease. Ideally with insight all the varied manufactureres will be pleased to design their product lines in arrays and with other desired products for the public's easy combination. In doing so they will enjoy a greater market for any specific product by more completely utilizing all it's capabilities.

It is important to show how these cell phones will become extremely useful in the future by describing how the latest in cellular digital technology is providing all the band width and multiple frequency flexibility to accommodate real time video and or digital imaging for the invention to have this another of it's report back functions to be view and stored as dat if necessary. This can also be accomplished through the transfer of data storage mediums physically to compare files for accuracy and tampering if need be.

The latest Cell phone technology Code Division Multiple Access (CMA) will enhance the video and graphics capability from the (PRN) if used as the communication link. This can help for any program needs to send a video image from the vehicle as part of real time data being given priority to be filed, e.g., for police applications (UCR) (NIBRS) as part of the inventions (spider eyes Program) and for the receiving of graphics, photos or video e.g. mug shots. The spider eyes program is explained in the third application especially dealing with all the electronic controls and peripherals. However it basically describes how on each and every vehicles' out board video system can be used to provide recorded video and or digital still or snap shots for traffic accidents and or crime incidents either automatically activated or by a remote control command. It also provides for several recovery methods for this information to be recorded and reported on board and off board if the software program parameters warrants such action.

Now with this latest (CMA) technology this becomes far easier to accomplish in real time. Another great advantage to (CMA) communications link in the invention is the gateway computer net work services that will be available through this technology and system. By using the (C.O.T.S.) product Sony D-WAVE Cosm Communicator interfaced in the (PRN). (CMA) base stations communicate geographic location information can be received to update traffic situations, also access to the yellow pages, maps and driving directions, Sony is developing a miniature accessory presently that turns the phone into a powerful digital camera (for Snap Shot options)—Detailed in the Third application for the Spider eyes program.

What is unique is that this system will be able to compress the pictures and store them in a cyber album, time and date the location automatically and accompany it with audio or voice. And the images can be view on personal web pages and down loaded to a PC.

However, this invention also uses another product of Sony's the “memory stick” and in most cases this D-WAVE CELLPHONE with digital camera devices interfaced or a form of this D-WAVE protocol would be used to send these images to the on board protected storage stick if it was deemed important but not worthy of an immediate transmission. Sony has a lot of plans for this new technology and it is an ideal fit for the invention and any of its mobile uses, e.g., their web browser will have a new Internet technique called “personal scrap book”, which allows a person to select content from familiar sources, also WebSPF™ allows for one to reliably and quickly connect to any website with out HTML defects and an immediate disconnect, which without these qualities could be debilitating in a mobile application. This prototype can be used typically as a modem for any onboard easy interface with the computer systems and or personal laptops and will function with ISP servers as well. And will be interfaced as a COM Link and support base for video peripherals in most of the more sophisticated computers used by the invention.

Another important advantage to this unit is it's self contained 65,535-color active matrix screen 320×200 pixel. The prototype handset communicator is ideal for the compartments in the invention because it is only 4.25″ long 2.5″ wide and less than 1.25′ thick. Of course a interface connector tray would have to be configured to supply, a battery charge, any necessary interface connector array, any possible voice or infrared data transfer desired, and any external antenna considerations if necessary from the multi antenna buss in the inventions (PRN). However, there is designed polysulfone heat shield covered ports in inaccessible area of every secure (PFN) to allow for these contained product's standard antennas to function inside the box with no threat of damage from fire (Polysulphone is a high heat water proof thermal plastic and a product of Amoco Oil). It can handle direct heat up to 370 F). The interface trays (possibly made from same material) will also provide away to appreciate the LCD screen if not utilizing some other larger display on board either in other products (personal laptops etc.) or part of the OEM host machine (Hologram wind shield displays or other LCD displays for the instrument panel (IP) or video technologies, flat screen digital, etc.) or one of the Inventions own displays.

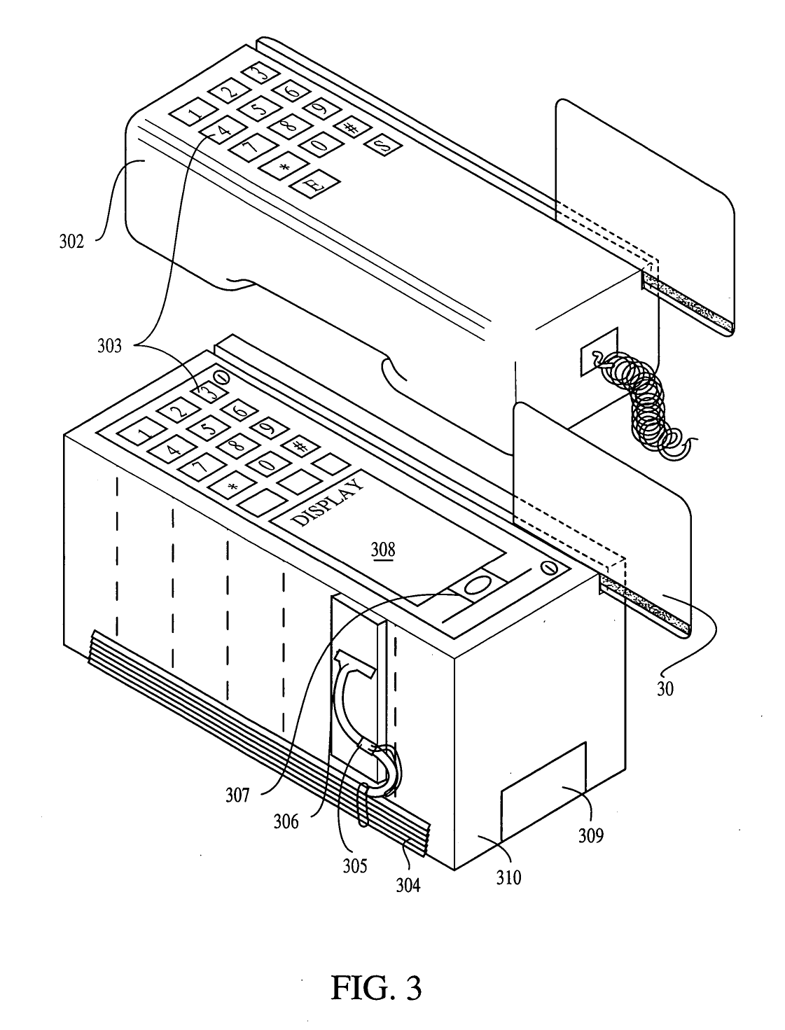

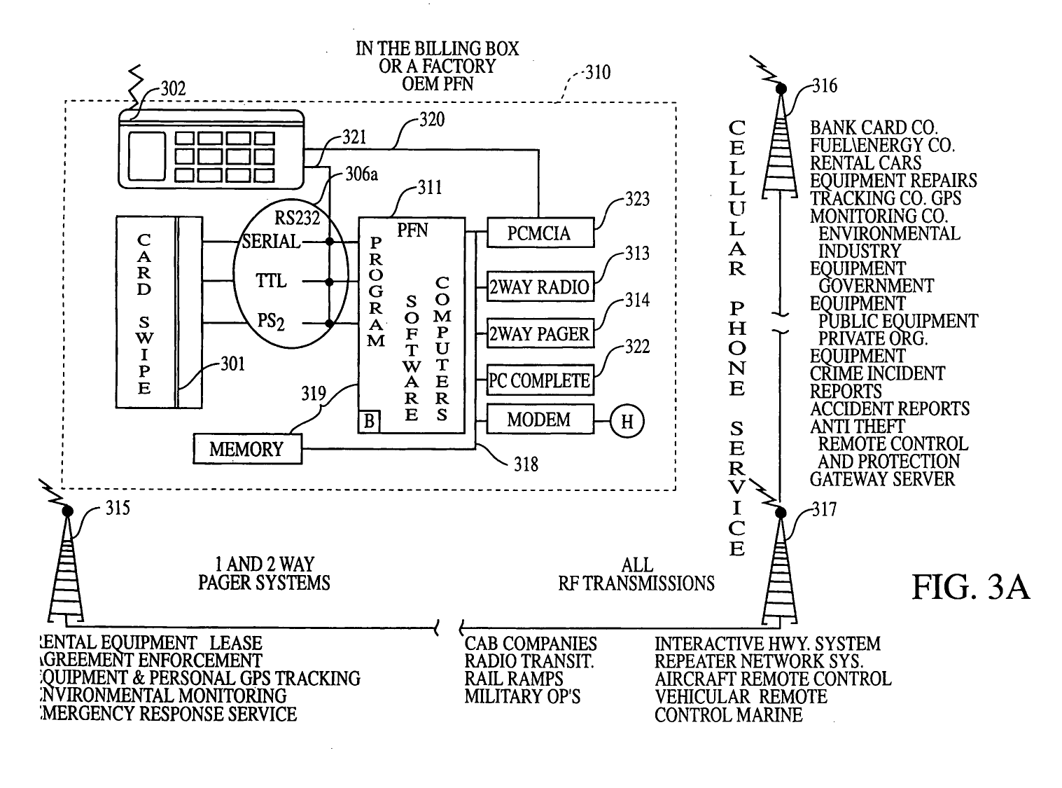

This is an the ideal technology protocol to interface the inventions card swipe phone or installable bill box system, which is depicted in FIGS. 3 and 3a. The entire unit can be reduced in size and increased in functions to provide secure data transfers of bank card driver licenses, Etc information to charge and check credit for cabs, busses, Etc, as well as, confirm a driver licence and photo on file for the police or for the acceptance of a credit charge. The Sony system is one of many that are going to have to be able to give location data for cell phones in the near future, but it's (CMA) D-WAVE Protocol has all the right properties to work really well in the invention.

Another present cell phone system that is easy and ideal to install for the laptop is “Complete PC Card”™. It is a cellular system and a landline and modem PC card. But most importantly, it can also be supported in the inventions computer systems with a PCMICA Type III form factor socket and windows software program form 3.1 up. The “Complete PC card”™ has it's own antenna and is a cell phone, modem and can hook up to the nationwide seamless cellular system. It has a transfer rate is 14400 Baud. It is a C.O.T.S. product and already FCC approved. This system will be part of any integrated consolidation for a dedicated cell phone technology to handle remote control through the inventions computer and will be stored in the legally protected area. It is the best present system for the inventions communication link and the one chosen for the prototypes. It can also be connected to land base lines with the standard RJ11 phone connector. It does not require any cables and it has no compatibility problems.

Househeld Cordless Phones—Unique Interface System

For some time now the cordless phone has been on the market and been used to give freedom to the user from being attached to a telephone hard wire line. In many commercial applications and industrial settings it is impossible hazardous or extremely difficult as well as costly to run a hard wire phone line to a machine or piece of equipment in which one might want to have the ability to send data for some programming need. They also might not want to use either a pager or cell system for cost reasons and or the distance might not be that far.

For this application the C.O.T.S. usage of a regular cordless phone outfitted with a standard female modular phone Jack that is wired into the out put circuit of the number pad encoder for the number pad tone converter and the common line for the ear piece will allow a portable lap top, the inventions, mini computer or larger computer system to dial out and transfer data to off board phone linked computer systems. the limits here as always is bandwidth and speed, however the prototype as developed for this purpose to be used as another C.O.T.S. communication product in the invention, but it will also serve to create a phone link for lap top and desk Top PC's as a quick and easy way to hook up to the web and send or receive faxes\E-mail. This only requires a very short regular two lead phone wire with the standard modular ends to be plugged into on one end the specially installed regular phone jack a j11 on the cordless phone, and on the other end the computer standard modem which is wired in as described above and turned on just prior to sending the command to dial from the computer.

It would not be too difficult to even have the laptop turn on the transceiver in the hand held cordless phone by sending the appropriate signal from the switch circuit that controls the On of phone function, however, it is really not needed and not a great challenge for anyone, who has owned both a computer and a regular cordless phone for any length of time. There also can be some difficulty in high speed data transfer for digital signals and will require slower speeds and in some cases or data compression and decompression hardware. However, most PC's seek the fastest speed they can communicate automatically.

Even if this device is used independently of the secure containment systems it falls under the unique C.O.T.S. interface innovations and part of the communication links for the control center in parts and devices series 1000, but should be considered as a separate innovation as well.

Land Lines, Modems, Connections for Computer Peripherals Direct Cable Connect (DCC) Ends

These are hardware connectors for the most part which will be serviced by #14 wire of cable modem design unless otherwise provider for in the compartment or trays and or required by some custom specifications.

There are a great deal of manufactures that produce peripheral connections and these proprietary connections will be configured to allow the universal interchange and quick connection of all these separate devices to be used in any secure box interface. The manufacturers producing these connectors are named below as well as the cell phone peripheral connections THRU, SER ADPT DB9F/DB25M, RS232 STRAIGHT THRU DB25M/M, IBM GOLD DB9F DB25M, PC/XT HAYES MODEM DB25F/M, RS232 SER DB25M/M, IBM PC/AT TO HAYES MODEM, RS232 SER DB25 M/M 6F, PC/XT TO HAYES 50PK AT HAYES, MON SER DBM DB9 THUMB SCREW, 8 LEAD OCTAL WITH 8 MALE DB25 MODEM CON, 8 LEAD OCT WITH/8 FEMALE DB25 TERM CONN, RJ45 TO DB25 MOD AAPT, MICRO TAC CELLPHONE, DB26M V.35F, 6DB25M V.35F 25PIN DB25, RJ11 F/CEM33BT/CEM-33BC/CM-33, RJ11 28.8 CM28 PSCEM28BT PSCEM28BC, RJ11 33.6 CM33 CEM33BC CEM33BT, ETH 10BT/100TX F/CE3B CBE CEM56, ETH 10B2 F/CE2 CE3 CEM2 CEM33, TR UTP F/CT CT2, TR UTP F/CTM, TR BALUM UTP/STP/F/CTM, TR STP F/CT CT2, F/CEM28 CM28, F/CM33U CM56, GLOBAL MODEM F/CTM, PHANTOM POWER F/PE3 PT3, ETH 10/100/B2.

Once again, these are a few of the connectors that have been used in the past for the computer interface with communication devices for pagers, cell phones, radios and land line phone modem connections. This short list is in no way intended to represent all of the interfaces and connections the invention uses or will use in the future. But merely to show the inventions compatibility to all COTS products. One system of interfacing for all these older systems will be the peg board system much like an electrical engineer's or experimenter's bread board, which will offer female jack holes in parallel rows And all the specific cots devices will have their specialized connector on one end connecting cable and on the other end will be male plug which is able to be inserted into this general multi-peg board buss set up for (Serial, parallel SCSI and or any of the newer interface connections like the IEEE 1394). The peg board bus is shielded all the way around in plastic covered insulated foil to reduce electrical noise. Infrared communication interfacing and coupling for data transfer is another way to interface devices in the invention with out a direct cable connector type system or the traditional (DCC) computer connections. However, this system has its limitations as well, e.g., it is not a good system presently to run two applications simultaneously. The problem is that the present algorithm used to run the application when disconnect from a first application will inadvertently and simultaneously disconnect from any other infrared application running. However, infrared technology is fast becoming another easy way to interface devices and will serve well presently for single applications as used with other multiple interface data transfer systems (DCC) (Voice) and even fiber optics.

One innovative design for the infrared interfaces is to have their optical windows on a flexible electrical cable cord and have the windows out fitted in a velcrove band that would have its mating tape on the C.O.T.S. Product IR window for quick, proper and stable attachment of the two windows for an optimal union energized from the main controller. There is in another modality and design a convex semi-circular chamber node or glass ball node covered in velcrove, which provides a number of uncoverable attachable port holes to couple a number of Ir optical cable end windows to form a multi-port fiber optical cable juncture on this optical node. In a second modality this same glass node or reflective prism could be connecting fiber optic cables or flexible glass or plastic rods with specially prepared ends to accept and transfer the data stream optically so long as it did not bend the infrared light and corrupt the data stream. These ends would also be attached with velcrove to allow the user to quickly install and interface the devices no matter where their Ir ports were located. There are many attaching devices and using any different system should not constitute any uniqueness on this protected and flexible interface for IR interfaces as described above.

IEEE 1394, Intel'S Unibus (USB) and Apples “Fire Wall” Technology

Ideally these are the (DCC) connection developments that make the Commercial Off The Shelf C.O.T.S. product modality interfacing for the inventions secure (PFN) most practical and an inevitable reality in some form. And also aid in the second embodiment of the secure (PFN) by making additional couplings of future C.O.T.S. SEPARATE PRODUCTS easy to couple for data transfer with IC Printed circuit boards. The future concise and consolidated IC boards will also have edge connectors, e.g., 30 and 72 pin Simm's sockets for peripheral in card form and the invention will have ribbon conversion male connectors from these types of sockets to many other necessary connector types to provide a more universal interchange with in the (PFN). The secure (PFN) has a real commercial purpose as a secure lock up interface to provide a good environment to accomplish these interfaces and protect them from theft and unwanted tampering. The IEEE 1393 protocol is quickly emerging as the standard to all its predecessors even those that have been combined to create it, like GEOport, USB connector styles and SCSI. Even though these designs can support data transmission for video and graphic, they are limited in speed and can in most cases service one host computer, however, they can be utilized within the invention.

The invention will be configured and detailed in the 1000 series parts to accommodate and work with these shortcomings as well as all the types of connectors and interfaces previously mentioned as backward technologies because of it's wide array of combinations and levels of operation, and to deliberately develop a universal interface system for all peripherals and combinations to better serve the Machine Messaging Network (MMN).

However, designs where ever possible will incorporate the IEEE 1394 because they provide the best service with size considerations for the physical connections and they provide for 63 connected devices and computers networked being of great importance in the (PFN) secure box system as is apparent to any one skilled in the art. And ultimately they will be more universally used as an electronics coupler through out all industries to compete interface tasks, e.g., communications digital imaging cameras, etc., automotive applications, GPS systems, and as a way to add on memory and or data storage or daisy chain all kinds of devices or to connect to supply and retrieve data.

NMEA—GPS Systems and Their Interfaces

Note: This ability to link up with and interface PCS with other devices such as onboard GPSs like “Delorme” C.O.T.S. Product “Tripmate” which can connect through the mouse or key board ports (PS2, Etc) and run it's own digital accompanying software, or any other GPS system that can provide location coordinates electronically for other digital software products, i.e., Rand McNally products and other geographic mapping software programs that can recognize earth coordinates (latitude & longitude, received as an electronic and/or digital signal, or any software conversions and/or already in-house invention described interfaces, as well as utilize standard address information. These systems can position the vehicle and map it in the PC display which will allow the operator to locate and guide himself individually and faster without having to use any outside support software service or servers, which will free up any network system software or commercial servers for those who need it. These products have been developed to chart the best driving path and give on the road instruction verbally and in written directions and in map diagrams

An onboard automated operational software program could triage services and prioritize them to be handled by onboard software; either PC driven or by advanced versions of the billing box computer/processor and designed to maximize and consolidate the services desired to meet any of these needs either by onboard devices or offboard servers and their devices, e.g., software and networks that could be decided by an individual's decision as to any monitoring system service cost vs individual hardware/software cost and/or personal privacy of movement concerns with respect to these variations.

In the processor section the more advanced computers are PC104 module configurations and in this cases The “OEM 4000” DGPS credit card size receiver will provide, the high performance differential GPS embedded applications in the world wide standard R(B)DS and RTCM SC104 formats. Depending on the differential correction service the GPS position accuracy can attain 1 meter. This product will interface with RS 232 or TTL very simply providing integration of GPS systems of use in many applications, e.g., geodesic research, forest applications, marine positioning and car systems. Ir connects through a 6 pin connector and requires +5VDC. While this has been designed to be used in the inventions own devices this credit card size GPS is one modality to give GPS to Laptops and Palm Tops which is described as another product of the invention.

All these portable and mobile (PFN) interfaced systems would increase the speed and efficiency of all the on board and off board systems as this individual hardware and software ownership become the norm: Through these inexpensive and natural improvements manufacturing costs will be lowered and consolidated, and miniaturization will be achieved and more optimal hardware and software device augmentations will be forthcoming. All of these combinations variations and changes still all fall under the nature and scope of this invention when utilized for these stated purposes and developed in the manner described and or utilized herein.

Also in the pager pointer or person locator device the use of the Philips GPS chip sets SA 1570 and SC 1575 have been discussed as good Chips to be integrated with the Motorola's ReFlex pager protocols 25 and 50. The Phillips' chip set could like wise be easily combined with the inventions system computers and either run on board software or access a CD write disk or MO drives or any other storage device.

This is another product development of the invention the integration of GPS into a mobile computer system, e.g., laptop computers or especially palm tops with PC cards and or memory sticks to deliver data storage or updates, and/or provide the digital map archive files. This is in keeping and a progression of development from the interfacing personal electronic array of carrying cases to consolidated portable personal products that can be used with and away from any (PFN), e.g., car, in fact, the next progressive product is this combine Mini computers GPS and either a cellular phone and or pager system technology through integrating all the circuits to provide one personal portable (PFN) To diagnosis, Locate, record and report on other pieces of equipment that have a malfunction on their (PFN) or need repair or just as a consolidated personal computing and communicator station with a host of products and peripherals to connect to it (e.g., cameras videos, TVs) to create a personal entertainment center solely for personal convenience. Head phones, microphone and voice recognition technology and their can be privacy and or hands free control over this device. These products all exist as C.O.T.S. products and they can easily be built into one integrated product by anyone skilled in the art with all the components listed in this application and are stated a innovative natural evolutions of this invention's. technology. Also with the new described Sony D-Wave protocols-location can be obtained though this phone technology another space saving attribute.

Once again this is a list of a great deal of the hand held C.O.T.S. GPS Products that will be used in the (PFN) but in no means does this list limit the use of other unmentioned devices and products:

Magellan GPS 2000XL, Pioneer

Garmin GPS12

Egal, Explorer.

All these products have data interfaces of National Marine Electronics Association (NMEA) 0180, 0182 0183v1.52.0 and differential capable RTCM-104v They are also designed with cigarette lighter adapters so any voltage consideration can be provided in the containment interface from the variable power supply.

The invention has been designed to give order to the process of vehicular messaging, remote control and complete robotics. With this in mind it is important to remember that a lot of new products, services and companies have ballooned onto the market with everything from autotheft deterrent and prevention devices to the interactive highway systems of the future. And basically because of the great strives in telecommunications Satellite positioning, solid state computer product and their software all being employed more readily than ever imagined on mobile platforms. This is another major reason the invention creates the secure accountable containment primary focal node (PFN) for all these in industries, companies and government agencies to have a structured environment to set up standards, acceptable modalities, practices and regulations for this present menagerie of technical and commercial mergers.

With this in mind, these are some of the present tracking, anti-theft companies and remote control systems on the market that would be a welcome addition and be enhanced in the secure box interface. This list is once again in no way considered compete as to all those products and companies that would be served well or serve well in the invention:

AVL Information Systems Inc AVLIS9 (R) VIS104HD™

AUTOTRACK USING NAVASTAR GPS systems

GPSS in logistics.

GM's product OnStar with EDS, Prince, Highwaymasters, and Johnsons Controls.

Recently GM Delphi Delco, Lockheed.

If full robotics systems or even partial remote control devices are deployed their is a host of insurance and civil questions that need to be answered and one of the most important is how do we assign accountability and liability for the driver actions and the automated vehicle operations. This is the third reason for the secure accountable (PFN). It will be a necessity for the interactive highways and the smart car development to be accepted by our society institutions insurance companies and our legal system.

Primary Focal Node CPU Hardware 940-1050 Series Processors\Controllers\Computers

STAMP II. The 940 series computer has been thoroughly described in the previous patent application and is an excellent in expensive system to be coupled with a myriad of devices and communication equipment. However in some of the heavy duty remote control applications and robotic's full computers are required and full data storage devices are also required for accountability.

The invention uses, for example, 5 different inexpensive computers presently they are the Target 188EB a PC/104 embedded processor board, The target 386EX a high speed embedded processor, 486SX micro controller, 386SX/486SXLC2 processor board and a high performance AIM104-386-33 single board PC. The reason for the many varied computer controller boards is to accommodate all the varied functions of the invention's peripherals, e.g., running big industrial equipment to operating small solenoid valves in simple blind remote controls. Their are many other computers that could be used in the invention, however these 5 will be able to complete most all the (PFN) functions to report to any size control system or additional (PFN) it needs to net work with (e.g., large factories' equipment applications).

These last 5 computers can complete and support any computer operation and have modular cards to increase their functions and capacity or to vary and accommodate any desired programmable control functions. (These small single-height Euro cards measure 1000 mm (H) by 160 mm (I) which will fit nicely in any permanent protected area with the protected data storage equipment. These mini computers can support key board and mouse operation, 4 and 8 megabyte of ram and some have more. There is also additional on board data storage systems, for personal and public permanent record storage. These systems and devices will be detailed in the following section. It is possible that the pentium and/or pentium pro processors might be used for improved video with the faster speeds up to 200+ MHz internal clock speed at a later date.

As has been maintained through out this application and the other two related applications, this (PFN) is a versatile storage control center performing the stop box, black box and billing box functions which have been isolated out and described to better provide easier understanding, development and commercialization of the invention. But, ideally the secure (PFN) is designed to provide safe storage for all mobile electronics personally owned e.g Lap tops, organizers cell phones, etc., and any of the host equipments control circuitry, e.g., programmable controller, controller modules, system control modules as well as any memory storage for trouble codes linked or separate that might be served well by being consolidated and or interfaced in the secure protective environment of the invention and part of any Primary Focal Node (PFN). It is the intention to develop the invention's secure electronic interface as a standard set of structured devices in some form on ever piece of equipment to complete the (PFN) task in the future.

The Original Equipment Manufacturers (OEM), e.g., for car manufactures, e.g, GM, FORD CHRYSLER/DAHMER, Nissan, Volvo, etc., will come up with some specific utilization of any (PFN) for their host equipments computer system and modules needing, and/or deserving this type of interface and or interface protection, either consolidated in one place or as a linked set of either protected or unprotected devices. So the PFN interface will be able to interface electronically with any number of automotive multi-pin connectors that it has to transfer data TTL, digital or analogue either inboard a (PFN) structure or in some separate linked network and or daisy chain configuration to obtain any operational information on the vehicles performance and operation as well as control its electronic equipment. In the development of the invention the automotive manufactures, government agencies and insurance companies will be sought out to best commercialize the invention to meet their specific needs as well as, to be universally standardized for more accountability and familiarization in legal settings and public understanding. This will increase market value for all these new technical devices.

The normal vehicles peripherals will be monitored, e.g., OEM computer or one of the inventions computers and or any additional innovative peripherals either products of this technology or other manufactures will also be interfaced utilized for their special properties and or monitored in their performance and if of a critical operational failure to the host equipments proper operation recorded and if necessary reported back to the off board monitor and control system the Machine Messaging Network (MMN) and or on to the web pages on the (WWW) to create the (MMNWWW) interface. This probably should not post personal information or specific vehicle ID info, e.g., Electronic Serial Number Vehicle Identification Number (ESNVIN), but could.

The invention combines the communication devices electronic serial number and the manufacturer's vehicle number so the exact combination of equipment sending information is identified and also the exact location of the transmission (GPS) Personal profile can be sent as part of this header with the Lic. Tag No. and/or driver's licence, as scanned in through the card swipe, or fingerprint analysis if publicly determined policy or some judicial conditions for an individual's driving privilege. All this information would be listed in the state mass data computer to be run through a compare list and dealt with accordingly.

This process also provides for any initial privately purchased program for fleet management and the regular citizen owner and or operator to be notified in real time on the IP instrument panel and for the shop of his/her choice to be notified at an earlier level than a critical notice to the state highway mass data systems. The operator or their shop would have preprogramed in the software of the (PFN) in anyone of the capable controlling and communication systems previously mentioned another address, e.g., phone number, that is the data for review as the driver is notified in real time. If this is a persistent problem that violates the public's laws, e.g., brake problems or CO pollution the preprogrammed monitoring controller will search its compare list for frequency and dial up the proper authorities as well as notify the shop of the transmission. Ultimately and ideally this software will be part of any vehicle OEM computer and secured and protected in this manner.

Question: Why is this needed?

1) No more need to waste the citizens' time for vehicle inspections.
2) No more need for air pollution inspections
3) Identifies problem vehicle types and product failures.
4) Identifies unsafe geographic areas air pollution, accidents, equipment failures due to deteriorated roads.
5) It allows for the industries to identify good designs by the lack of trouble codes sent in to the state computers.
   This is determined because all vehicles will have a periodic self-diagnostic and report in at least on any renewal of state registration.
6) This data will cost very little for the state to collect and it will provide the most accurate data necessary to provide public safety.
7) This accumulated data would be passed on to the National Department of Transportation and Highway Safety to assess the country's infrastructure and the personal equipment in use and all the impacts.
8) The public can view their highway system and the condition of the vehicles on it and decide how they best would like their representatives to vote.
9) The same process would be done for the air pollution or release of hazardous materials division and reported to the state or local hazardous materials for immediate attention and passed up the ladder to national data basses and on to the public for them to decide how they wanted to live.
   Automotive Area—Controller Area Networks—(CAN) or (PCM's)

Powertrain Control Modules inside the (PFN). Ideally the automobile's control systems and as many of the its IC modules as possible should be housed and enjoy a safe and secure (PFN) containment and would benefit by a protected interface. Most of all the eletronical experimental work has been done with GM vehicles and parts, so therefore the technical hardware interfacing explained in any detail here will be related to GM. However any and all vehicles either backward technologies or the most up to date and future technologies can be interfaced in the inventions (PFN's). One other important note to remember is that this interface discussion is centered on the automotive and trucking industry. And that other industries (PFN's) will be more thoroughly detailed in the third electrical devices patent application. The invention's processors and peripherals will be controlling and dealing with motor controllers, etc. and higher current levels of AC current.

The GM powertrain controller will have its connector and pin configuration socket represented in the drawings with all the other industries sockets as adaptive connections for the modular trays to be designed for and jointly bussed together. There are many other connectors presently and the manufactures will develop there most ideal way to tray them or compartmentalize them in there specific configurations. In fact, universal busses are going to simplify this process in the near future anyway, which will be completely described after this discussion on how the PFN will access the standard automobile sensors of present and all the accessories.

In the United States most all the auto manufactures use the SAE J1850 as a Mid speed (class B) standard bus. but it is aimed at non real time communication and basically used for diagnostics. Philips Semiconductors, makes a product for this application their AU5780 which is a J1850 transceiver and it or any of these other J1850 buses could be used in the early (PFN's) To transfer any stored trouble codes in the Powertrain Control Module (PCM), Etc. in a digital binary code with what ever software conversions or augmentations that might prove best for the inventions computer system to send it via whatever onboard communication equipment it is to be routed through, e.g., Rf. signal, pagers cell phones, for a report back to service and environmental monitors or assistance personnel, and to meet the system requirements for the network nodes, e.g., ASCI, etc.

The reason this is not specifically stated is because the (PFN) will always have many configurations for many systems even though things will always be more universalized. This is to keep The (PFN) current with the involved technologies. Automobile electrical systems and communications systems are still merging at an incredible pace and for this reason any interface that links the two has to be as flexible in its physical structure and electrical connections as well as universal and simple as possible. Fast approaching is the means to complete the most intricate functions with these networks interfaced with the least amount of hardware. And the invention is going to discuss these hardware connection systems it has been designed to utilize for this purpose as was done for the communication systems and the rudimentary automotive interfacing.

As mentioned earlier many advances have been made in the controller network area and Philips Semiconductors is one of the major semiconductor manufacturers in the world and is a leader in In Vehicle Networking (IVN). Philips has many products based on Controller Area Network (CAN) bus protocol. Some are standard-setting receivers and deliver high ElectroMagnetic Compatibility (EMC) with low radiation levels for automotive applications. They have both single wire CAN compliant Transceivers AU5790 and the earlier AU5780 and 2 wire fault tolerant transceivers PCA82C252, TJA1053, a 2 wire high speed CAN transceiver PCA82C250. PCA82C251 highspeed CAN transceiver and a SJA1000 Protocol controller.

Ultimately all interfacing will be easier though Telematics networking and the best system in all fields is the IEEE1394 bus. This is true for the electronics industries, communications and the automotive industry. Automotive connectors, and interfaces with controller area net works (CANs) will be greatly enhanced and simplified as well as be able to be stored more efficiently. The IEEE1393 will offer a high bandwidth, high speed communication services for real time data transfer, which are all great qualities to make the best most comprehensive, cost effective, efficient, flexibly versatile (PFN) to meet all commercial, public and individual needs and public safety concerns. This system can also handle audio/visual reporting in real-time extremely well for a (CAN) system. And, for the low and mid-range speed data transfers, the Universal serial bus is excellent and all of these are discussed in their seperate sections. Finally the Digital data Bus-Optical (D2B-0) is also another promising telematics bus. It uses a fiber optics system. Also the USB-IRDA.

Emergency Power Inside the (PFN)

In the first application the secure containment was provided an emergency storage battery and one way charging system to insure power to critical operations if the host vehicle was to lose power. The same consideration for the present (PFN) variations will be the case. It is conceivable that one could structure a (PFN) with out this emergency power feature by only creating an interface of these two industries to report data or remotely control the host vehicle and not have any emergency power supply or battery backup, but even if this were the case it would still fall within the nature and scope of the invention if it were to be participatory in any (MMN) and or interface with the (WWW)

However because of the many configurations that the invention's PFN can manifest only the components of the inventions charging systems and batteries will be detailed in this application. The first application details circuity for the basic deign and details the qualities and properties, This discussion will focus the main parts only and not the simple electrical components or connections

Most of the inventions computers or controllers work on current from 5VDC to 12VDC. This power is provided from a regulated battery a Panasonic LCR12V2.2P and the smaller Panasonic LCR6V2.2p which when put in series with a draw switch/charge switch can directly power up laptops and when the level of charge to the laptop battery equalizes with the two Panasonic batteries it will sustain a longer operating time in this parallel configuration with the Lap top battery. Another option here is provided by an on board inverter and the laptop transformer and rectigier. It can charge the 18 DC of the two batteries in series. And when not energizing the computers transformer rectifier it can be used by the inventions prototypes to provide 120 volts AC. The one chosen for the prototypes is the PROwatt 250/12 AC/DC inverter. When not in use to power a lap top this inverter is powerful enough to energize small portable heaters, small coffee makers and microwaves, heating blankets even a bread maker for emergencies and camping.

Because of the ease of having this power available and that it can operate lap tops in a normal wiring configuration as well as charge these back up batteries the PFN has been designed to have a 110-120 VAC plug in the front of the PFN for the additional accessories. Also a special water proof socket with properly shielded cable could supply power to an aesthetic plug socket on the exterior to energize small house utility requirements in an emergency, e.g., a few lights, electric hotplate, very small fridge, etc. This circuit is displayed in the drawings but their are many other variations. And also the third application details many of these variations in the peripheral circuitry for the electrical devices on board the host vehicles.

Either taped off the two batteries the 12 volt or the 6 volt and regulated to many varied DC voltage requirements between 1.5 DC all the way to 18VDC. Also multi bussing will be provided for two or more devices that have the same current requirements by the battery-powered supply systems MAX 714/715/716. The other modality for varied power levels is to tap off of series NiCad or Lithium Battery systems for less demanding (PFN's) and recharge them with MAXIM NiCd/NiMH battery Fast-Charge Controllers. Specifically the MAX712 and the 713.

And finally as a accessory peripheral for the (PFN) to always have an external charging source. A solar cell array will be placed into the top surfaces of a vehicle in a aesthetic configuration and the (PFN) will be provided a current sensing system that will wake up a pre-programmed EEPROM and microprocessor and it will automatically call out and give its last GPS coordinates, or initiate a hot reading to keep suppling hot GPS coordinates. This is activated if the car is stolen or in an accident or by a person activating the emergency communication mode for an SOS call or 911. The firmware or software will also turn on a receiver so that if the SOS hail is received a call can be given back to the stranded motorist that help is on the way. If the system was triggered by a theft prevention system this return message would not be sent by the emergency services or the commercial monitoring node. If the person was in an area where they were not being received they could over ride the SOS or 911 hail or beacon and use the power to charge a dead battery or provide electrical service for substance priorities.

Primary Focal Nodes (PFN) Data Storage Hardware

There are many compatible hard drives that could be added to the on board computer products picked thus far to beef up the ram. However, most of the computers planed for in the vehicular or mobile setting (PFN) are embedded systems and will have, for example, 8 megabytes in their small euro board configurations already, which is more than enough memory to hold most on the standard programming. It is only the additional programming like court directions for the provisional driver and the permanent record and or data storage of the provisional driver that need to be recorded. The amount of this data storage is greatly reduced by the provisional software parameters imparted originally from the removable storage disc, stick or magnetic tape systems that are all possible C.O.T.S. products available. This data storage will be ROM and writeable but not rewritable. It will be impossible to write over or remove any entries already existing. The reason for this is to provide evidentiary data for judicial proceedings. On the horizon and in the future some the smart cards will have greater data capability and their is no telling the capabilities of the new DNA computer technology as far as storage.

The storage space saving protocol will be initiated by, e.g., the court disk software instructions controlling the recording process to take place only when the driving parameters are deemed violated. At which time they are time and dated and given location coordinates stamped along with what ever is determined as monitorable necessary data input, e.g., vehicle speed, inside cabin video, of the operator, breathalyser readings as well as a request for fingerprint scan, any short range highway info-transmissions as to speed postings, lights run, etc., and on and on.

As already discussed earlier there will be at least two data storage areas on board ultimately on all standard (PFN) secure systems. One will have the highest priority and coverage and have many legal regulations governing its access and data stored, e.g., for the automotive industry. It will carry all the electronic serial numbers and pertinent data from the manufacture of the vehicle, its active odometer reading, a registration record of all the owners, scanned in service synopsis data (a specially designed protocol to universalize service reports) and in chronological order a total record of any incident that an approved public safety protocol deemed a necessity to document collect data and record. Some of these programs are: automated uniform report protocols for; Crimes (UCR's) Criminal incidents captured recordings in real time, vehicle service work orders and work completed reports, standardized judicial programs to asses reckless driving, substance abuse, aggressive driving, pensive driving, watch dog driving analyzing programs for suggested driver improvements

Watch dog programs for young driver restrictions for geographic areas and or time frames, and or speed or erratic acceleration or any of the aggressive behaviors, older driver or impaired driver assist programs. All these programs would be structured to not only to record with all pertinent data retrieval systems, but to report to a home computer, to law enforcement, or request for emergency services.

All the systems for the hardware firmware and software either on the vehicle or off board exist today and only needs to be structured and utilized in the inventions described manner for remote control and accountability. As massive as this undertaking is the timing is perfect for it to be achieved by the industries, the government and the public. And it will be cost effective because all of the desired products as well as this technologies innovations and functions are wanted and happening in our present commercial markets and they are the building blocks of this invention. This organization, control and total accountability is the right and responsible way for the world to continue all its technical development.

Sony's “Memory Stick™”

This product and some magnetic Disk products are going to be utilized for sure in the (PFN)s therefore they will be detailed specifically while all others that can interface in the (PFN) by anyone skilled in the art will only be listed, but are still considered to fall within the nature and scope of the invention

This next product is another Sony product and it is a tremendous asset to the invention. First it is smaller than a stick of chewing gum and its storage capacity is 5 times greater than that of a standard 3.5 inch floppy disk. It is available in 4 MB and 8 Mb storage sizes and with a PC adapter makes it easy to connect as a C.O.T.S. product. PC card adapter (MSAC-PC1) slide into an ATA type II PC card slot in Cameras or peripherals and also in to lap top computers if only the transfer of data is desired. However the connecting surfaces can be duplicated to provide a socket for plug in and removal versatility as a resident storage device for any serial data transfer with on board systems

The stick was designed to be used with small digital audio/video electronics products, e.g., digital cameras handy cams, ect., and with the 8 MB memory stick up to 160 digital images can be saved on one memory stick. It is highly reliable which is important for legal use. It will be useable with newer technologies because of its original serial protocol and it is being designed in the future to incorporate digital copyright protection which will be great for legal applications. It has a 10-pin connector, and for the 8 MB stick and PC card interface.

Sony also has another product called the link. It is a digital interface that meets the latest IEEE interface 1394 specifications. This provides high speed and easy interfacing for audio and digital products to be linked to computers in a single small cable which will allow for space saving data transfer and control for all the peripherals, e.g., cameras remotely directed from any on board computers. Through the link multiple formats are possible to simultaneously transmit digital video, digital audio, DID, DSS and special command controls to operate AV equipment remotely. This high speed data link can operate at speeds of 100, 200, or 400 Mbps (MCGA bits per sec). However, the slowest connected component speed will dictate the system operation speed. What is nice about this combination of components is that they will easily fulfill the C.O.T.S. Interfacing for this data storage or peripheral operation because they all have a compatible matrix.

For Onboard Permanent Data Storage

At present the permanent storage system will also be a Sony product which is a magneto optical disk drive (MO) disk drive. This disk is coated with a special coating that is magnified at a very high temperature. Approximately art 300 degrees. It is extremely reliable and low cost for MCGA byte of storage. This technology is not easily effected by other magnetic fields and it requires 300 degrees to write to the disk, which is provided by a laser. If desired it can be written over many millions of times unlike the traditional CD rom or CD-R. The MO drive is versatile in it's recording capability it can be a rewritable device or a once only record which is probably how it will perform its judicial functions. It also uses a disc cartridge that can be exchanged. This is also a desired feature for evidence the magneto optical disk drives can be used with most all platforms and operating systems. It is an excellent storage device for Audio/video, document imaging, graphics, CAD/CAM, medical imaging, digital video, multimedia Accounting, banking and legal records.

This storage system could make any of the inventions (PFN) a vehicle computer system that could complete any need imaginable. The whole drive is only 5.25 inches high and can be easily compartmentalized in the (PFN). However this unit is being considered as a permanent storage system and not for rewrite. Sony provides write once media which is WORM media part # CWO-2600 2.6 GB their are 3 other WORM write once media but this provides the largest data storage. The Sony product number for the MO drive is RMO-S594/DWPS.

There is also other Drives CD-R's and Hard Drives that could be employed easily in the (PFN) and any mentioned products are purely preferential and not limiting.

Primary Focal Nodes (PFN) and Software Protocals

The software will be explained as all the functions that will be performed by the on board devices and off board devices and systems including the data transfers. The specific programming will be designed and created by for all the specific devices but the functions they will command will be described presently.

In one modality by having timely performance checks that can be run through onboard hardware initiated by onboard and/or offboard software through comlinks, that control sensing devices which are able to communicate this data back to monitoring support systems that can augment it with up-to-date software and diagnostic data/devices either directly or by networking with other servers. The host vehicle will be able to assimilate this and its own gathered data from in and outboard sensor devices to record and report on its own road worthiness, while issuing warnings and/or repair orders to the driver and local mechanic as well as telecommunicate this data to the proper authorities or commercial servers.

This will also include a report on its impact on the environment and loss of vital and/or toxic substances. Presently, the automobiles have sensors for judging fuel mixture and exhaust components which are still primitive, however, this data would serve to start this process as it is already being used in the manufacturer's engine control circuits/software and trouble code process which will serve as the point of origin.

With more sophisticated sensors and advances in the microprocessors (pentium by Intel, sensor arrays and/or spectrographic sensor arrays and light sensors) the present invention may be provided data by interfacing with these devices, which can provide distinct electronic signatures of molecular structures to the preprogrammed mini computer and/or processor so it can identify specific chemical compounds. This will give the secure Stop/Black/Billing box, (PFN) the ability to recognize the hydrocarbons, nitrous oxides, carbon monoxide and other significant toxic chemicals and heavy metals which are the by products of our fossil fuel energy consumption. These standard devices exist today and will have to be a part of tomorrow's vehicles for any internal combustion engine.

Of course, as other energy supplies are incorporated into and/or along with, our evolving power train systems they to would have to be analyzed, and have standards set as to their acceptable impact and appraised and cost for that impact and material resource use. This data gathered by this ever flexible and evolving billing box (PFN) would be forwarded from either any commercial servers and/or monitoring firms to government agencies, and/or these government agencies could have their own phone nodes. That could be contacted directly either by the preprogrammed software onboard in the secure billing box system (PFN), or by a software interface with the mini computer (or stamp II and/or more advanced substitute computer) that was preprogrammed to send a standard dialed number to a simplified cell phone dialer or fax modem or onboard cellphone transceiver, and also send a code to this phone link system to transmit and dial the number. The minicomputer would then open an interface with the host vehicles programmable controller unit and the fax modem onboard with the offboard servers hardware/software sending signals to trigger latches or initiate software to have the host vehicles send preprogrammed data that is to be provided per servers requests. This data would be placed into an understandable and ultimately universal format to be designed and agreed upon by industry and the IEEE and any necessary government agencies. Until this was done the invention would serve to convert it in much the same way that computers today convert text file for different word processors. However the initial goal will to be create a cooperative setting to best accommodate all the manufactures configurations, and seek to standardize.

Ideally this would all be housed in the secure and legally protected area as described for the Stopbox/Black box/Billing box inventions. But, it is still with in the nature and scope of invention, that due to the varied amounts of different equipment and configurations that these interfaces are all that is needed to fulfill the nature and scope of this invention, and that in time, these systems and devices would be consolidated and secured in the above ways as has been described through out these applications.

This data received from the secure billing box would be compared to specific and acceptable levels of operations. This criteria already exist today as mandated by the US government through EPA standards for the automotive industry, however, this invention will create the need to augment and improve the acceptable parameters for these fossil fuel users and newer energy systems and drive trains to be analyzed through legitimate science health and government agencies as well as industry testing for all equipment.

Presently, we have anti-lock brakes that can tell when one tire is locking up and it controls or limits the braking on that wheel through a small IC circuit by small AC generators situated to sense movement on a disk attached to the wheel, and sense speed for each wheel by the current it generates (in newer application these are digital or TTL sensed and read signals).

In accordance with one embodiment of the invention, the invention monitors this braking data and has a program either in a manufacturer controller/computer, or in the invention with an analytical software program that could denote subtle changes in repeated brake applications under consistent circumstances that would trigger a warning notice to the driver to check tire tread/pressure as well as specific wheel braking problems.

These warnings of course would be recorded and as the onboard program in the box recognizes this condition, worsening it would be reported by the Bill box computer (PFN) which would create a communicative interface with any cellphone technology being employed and notify any predetermined mechanical service and the proper authorities simultaneously, if necessary, also an onboard and outboard set of descriptive lights would be illuminated (the inventions Info-Bar Product) to inform all other operators with in sight of this possible equipment failure and emergency situation, e.g., an information bar or notification bar on a back bumper or rear window. And of course, sensors for the brake fluid levels would also be incorporated in this same system and set of programs.

This information bar is another product that is designed to help communication on the crowded highways to better help people to be more social. Though a voice recognition program, or small key board, or selected preprogram messages package, a diver would be able to create or select a message he wanted to send a driver behind him, it is conceivable to have these info bars placed on the side or even written back wards so a driver in front could read a message. These would employ a C.O.T.S. product known as a scroll bar or similar device designed to work on 12vdc and a soft ware disk or running program to write the messages in to the buffer or a voice recognition program with an algorithm to convert the voice to a digital format and on to the scroll bars micro processor for the lighted message display. (Note this device should be designed not to write expletives or derogatory phrases to reduce road rage and the chance for some one to shoot your lights out. The system will be designed to stay below the rear window brake light height and be on either side for retro fitting or in newer cars incorporated in to this brake light. This info bar has been created and will be used by the invention to give warnings to outside drivers in any emergency and or remote control protocol. However this device has real aftermarket value presently.

With the technical advancements continually becoming cost effective for all electronics, e.g., sensors of all types, video capture equipment and especially digital camera systems, having a computer camera in the wheel wells for monitoring the condition of the tire in real time motion with these new computer chip cameras, can be made practical and reality for use today. These devices will be used in the interactive highways and smart cars as some prototype video cams are employed at Berkeley/MIT. in present day experimental vehicle. However, one modality of the invention's design is to aim these cameras so that the camera can capture road edge/surface and view the wheel thus making monitoring a reduced hardware cost immediately and more practical. This would be done by the bill box computer (PFN) or any smart car computer prioritizing created software to analyze these specific activities, and if necessary, in order to direct the cameras servo motors or mini solenoids to affect camera angle. These external video systems would also be used with the community “spider eyes” program (1100 and 1200 series devices for capturing and storing any incidents, e.g., highway accidents and or crime incidents to be passed on in real time or at some later date. These video peripherals are detailed in the third patent which details all onboard electrically controlled devices for automation and remote control.

Of course, any data determined by onboard software to indicate an operational hazard would be sent from the invention to the driver as a warning or notice for his or her acceptance which would be logged and reported to all necessary devices and parties on board and off board, e.g., PFN storage systems, surrounding drivers, Government traffic, and/or environmental agencies that were operating any interactive highways, remote control or robotics systems and/or any mechanical monitoring service connection or national program the driver is enrolled in or commercially participating with for insured road service.

This could be accomplished by the invention's ability to activate the cell phone technologies as a link and/or Rf. signal that would either first contact a specific local provider or a commercial communication server node or a predetermine network service provider node (e.g., an OnStar program) and/or a direct node that all the minicomputers will be preprogrammed to call under a specified set of circumstances, e.g., #77 or a government run emergency service number this could even open a verbal dialogue with any of these support servers to help aid an operator in distress and remotely augment uses and functions on the host piece of equipment. This last option is part of the local state and national monitoring and control system that will involve interactive highway systems with short and long range communication equipment for, environmental, traffic and law enforcement computers with data management software provided and maned by all thee levels of government.

This personnel and mass data storage and a communicative network will mass pertinent data on to the state mass data management system, their watch dog personnel and mass data storage and then on to any national management, and their watch dog personnel and mass storage data bases. Of course their will be priorities parameters established for any passing on of data and specific criterion governing the form that data is stored either in the (PFN) or any of the levels of this monitoring and control system network (1000-1200 series system) which will be owned by the public and operated by government and commercial personnel. In the mass storage section of this application the systems hard ware and existing software will be further explained as to how this can be accomplished presently and developed into the future. Most of the mass data structuring exist today in private commercial computer data bases and in government data bases.

The invention claims as proprietary specified services and charges comparative tools. Accompanying these mechanical/warning reports, a consumer could request a report of suggested cost for any such repairs that would be made available and printed for the driver and mechanic shop simultaneously as an additional service. The driver could also ask for more service options or have this covered through pre-purchased service agreements with the monitoring service or their OEMs, and then handled by their support mechanic services or subcontractors in the immediate area (e.g., like an HMO program for cars).

With the ability for the operator to interface PCS through the invention, it would be possible for the manufacture or after marketers to supply software in any form, e.g., disc or diskettes, or through any corn link and/or port to help the operator, local mechanic or any consumer or server to run their own diagnostic flow chart system, and have an integrity check on any stated repairs needed or any work order mandates by any governing authorities responsible for assessing highway and/or environmental safety in real time as well as, mechanical service suppliers and these related costs.

Ultimately with the (MMN) interfaced with the (WWW) and creating an interactive set of web sites that can aid a troubled motorist with all kinds of service and advice and consumer protection. So when all these web sites are set up they must register with the (NIC) and all state and national governing business licencing agencies and report all their fee for service calls to be compared to (PFN) service retained data stored to account for these services through the invention and for any resale of the vehicle and also to disclaim any bogus phone provider charges for the individual owner.

The monitoring GPS public system might be ideal for monitoring drunk or restricted drivers personal control of a vehicle at any given time, with onboard recording/reporting. This could be a municipality product forced to be purchased by the questionable operator as a condition of their driving privilege, or even a pre-accepted prorating insurance pricing tool for certain drivers and/or driving conditions, e.g., work only restrictions, Day time driving only, a habitual speeder, and the like.

The present invention may be used to monitor that person and report back to insurance and legal authorities and could employ the ticket on the spot automated feature of the Black and billing box, as well as stop and control this drivers actions in real time. In these specific restrictive monitor applications, the new finger print ID in the steering wheel or small ID transmitter bracelet, or a special ID and/or credit card swipe card with or without pin number, would be employed along with any audio/video recording/reporting systems that can be activated on the vehicle through the invention to identify the driver and initiate any agreed upon and/or legally mandated pre-programmed software systems stored onboard or part of any communicative network.

Retro Fit (PFN) Billing Box Product

The system depicted in FIG. 3 is an ideal retrofit billing box (PFN) designed to be purchased and supplied software to monitor conditional drivers and account for their presence AND ACTIONS TO THE COURTS AND INSURANCE COMPANIES. This same system can perform a phone to credit card acceptance service which would work extremely well for taxis and busses and mass transportation applications to allow the rider to pay on a credit card and for the companies to check the validity in real time; also a fee could be collected for the use of this service as a condition of licence or use.

For use in the court system or for insurance companies, use a specific driver software program format would be constructed and would be downloaded with any pre-recorded court directions instructions and conditions of driving which could be activated by software and then search a particular individual vehicle system and locate any of these specific devices and functions that might be available or must be onboard as a condition of one's driving privilege, and then activate them specifically by the authorities's (now) onboard directions or any remote control of them by server node and law enforcement, as well as give direct communications to the specific questionable operators.

Other devices to be interfaced with this invention are breath sensors or analyzers that would be attached to any of these secure stop and control (PFN) systems for further monitoring of a questionable driver, as well as incorporated in vehicles for standard drivers which could ask the driver to self test and initiate a controlled slow down to stop and secure the vehicle in a stationary position. These on the vehicle systems are detailed and forthcoming in the third patent filing.

Persistent attempts to defeat the system will be judged by law enforcement as whether it is a driver behavioral situation or machine error and the proper data will be retrieved from the vehicle and support (MMN) source providers and presented to the proper authorities if necessary while all the proper service and emergency personnel will dispatched all in real-time. Simultaneously, the present invention will store a private record and notify preprogrammed server numbers and authorities mass data management of this real time incident. So there is two ways records are stored and these files can be merger compared and consolidated by an approved public policy modality.

This system will need to have specified legal parameters for acceptable levels of a particular chemical substance which can be addressed to the public in general, and to the individual specifically which will be determined by government municipalities, qualified medical, and insurance companies and the individuals own physical characteristics which might mandate the amount of operator control and necessary monitoring they will be allowed and thereby automatically licensed for.

Of course these systems could be adjusted by any preprogrammed legal messages in the same manner as already described earlier, and/or augmented locally in real-time for any changed operational conditions, as per the conditions sensed for the driver with relation to their vehicle and environment and their legally licensed privilege to operate and control that vehicle. This allows for more freedom to aid our impaired individuals not just a method to allow drunks their private transportation but with this automation that will protect society comes greater freedoms for all individuals (impaired and or unimpaired (self inflicted or a condition of life) to function in this ever increasing and complex machine world. Once again Rights, Freedom, and Responsibility will outline the software functions and the invention is only the tool (PFN) and the system by which society provides for its public safety and individual freedoms in an efficient and hopefully in a fair and just manner.

Through this automated control design system to help the impaired of this world, we can empower that individual with as much freedom and privilege as they possess at any particular time by controlling and recognizing their impaired states and conditionalizing their individual control and negative impact, no matter whether it is a new driver, older driver, acutely ill driver, chronically ill driver or a deceptively ill driver. Through this analytical monitoring, the present invention may make the driver and the proper authorities aware of an operator's impairment due to social, emotional or a purely physical impairments, and affect the correct and supportive response that may be deemed appropriate, and all in real-time.

With the priority on total public safety through prescribed levels of monitoring and control with recorded/reported incidence functions through the invention's onboard interfaced devices and systems, and presently here described and designed offboard interfaced systems, this network (MMN) completes a total interaction for humanity and its machines. This brings the objective auto tutor to the individual operator by bringing his actions to his own attention, as well as to any and all appropriate others in the appropriate manner.

There should also be driver notification of these brief operational conditions/warnings so the driver will be asked to accept, and thereby be given a real-time meaning to the legal phrase that “ignorance of the law is no excuse”. This (PFN) by receiving interactive highway transmissions (probably universalized set frequency) on the multiban scanning receiver also interfaced in the containment would incorporate a continued monitor on the speed limits, and allow warning sound or alerts to remind the driver and/or augment and adjust speed control devices, e.g., cruise control, special fuel valves, and many other devices detailed in the third patent application. Only if the appropriate distances were perceived and or the driver did not over ride this process by squeezing a pass or panic button (to allow for the driver to speed greater than the speed limit dictated by the robotic highway systems. This behavior while allowable would be monitored and analyzed for appropriate circumstantial operational parameters through a soft ware compare list which was also responsive to any transmissions received by the automated highway request for assistance program monitoring individual vehicle progress on the system through shot range RF communications housed in the (PFN).

There also will be provided programs to identify too much aggressive driving by recognizing tail gating by proximity sensors, out board camera systems, and the number of times they are activated by unsafe speeding, as well as sudden jerking and swerving detected by level sensors that sense fluctuations in any tranquil fluid state in the fluid systems reserves, or by mercury activated contacts that activate on pitch and yaw of the vehicle, and or any inertia sensors provided by the OEM. as well as individual monitoring of the diver's, body heat elevated voice levels, expletives and or key phases at the proper db level to indicate driver agitation with a traffic environment (through any onboard voice recognition technology and software parameters provided for this purpose).

The program is beneficially and optionally interfaced through the invention to any other available accessories that sense erratic vehicle chassis movement and is designed to warn the operator through the electrical system Instrument panel enunciator or on Board LCD displays. Once the base systems software recognizes a problem and alerts the driver to his behavior, the invention (PFN) will next determine if it needs to augment an aggressive driver program in real-time from onboard data files or off board commercial servers (insurance company data transfer nodes and public safety providers (law Enforcement nodes or monitoring highway safety system nodes). This sets ups an automated triage of response actions to alert and create a communication link for monitoring and responding to defuse and deactivate the operator's negative impact on the public's safety in real time. These modalities are previously described and further detailed in the third following application.

Insurance Service Product

The insurance companies will be able to accurately asses all the areas they insure and make sure that they are costing the appropriate companies, government infrastructure and system and the individual pubic in the most accurate way and with the most up to date real time individual policy rates. The insurance research institute can identify costly equipment quickly and provide consumer alerts in a rapid fashion (this will save money for everyone).

Standard bio-behavioral telemetry sensors may be used to monitor the occupants and the operator for many body functions, e.g., heart rate, blood pressure, Body temperature, audio screams or verbal expletives, or even video of the driver ripping the head liner out of his car in frustration.

Note: All these sensor devices mentioned are considered more thoroughly in the 1000 series parts of the third on board and out board electrical devices patent application, And therefore in many cases only referenced in this second application as device embodiments that are controlled or interfaced with The (PFN) to report too; for record keeping, as well as, to give feed back for the (PFN) software to perform automated function's on the host vehicle or trans mitt back through the control system (MMN).

The parameters for blood alcohol already exit in most states and could be augmented through research to incorporate any and all substances that can impair diver operation. The invention would be able to recognize these physical properties in people through breath analysis, molecular analysis of perspiration, changes through galvanic sensors, thermal sensors that unobtrusively can accurately sample skin surface for these chemical compounds and there synthesized by products and thermal changes, and assign a specific and distinct electronic signal. Or the processor would recognize changes in conductivity variations e.g. some thermal sensors. And all the standard sensors that could create an electrical signal for body temperature and pulse monitors to report on heart rate and finally even blood pressure sensors

These devices would be driven by preprogrammed software that is looking for specific physical characteristics for a particular individual's body and/or general characteristic that are known to be established characteristics for everyone in life or a particular state e.g., a drunk losing consciousness, and the like. The purpose of this, of course, is to help those, who are ill or impaired and might need more close monitoring when they are using any of their privilege to operate equipment, e.g., heart patient, diabetic person, who has seizures. Once again this would not generally be used to punish any individual. The present invention would be employed just to support the ability of a driver to operate with the correct levels of monitoring and automated control to ensure everyone's safety and the individual's timely care, while preserving their individual freedom as much as possible.

The invention will be individually user friendly as an auto tutor to allow the individual to first appraise his or her actions and augment their own activities, until the invention's software identifies a preprogrammed level of unacceptable parameters that denote a public danger. And it is here when an individual seems to have some difficulties that they are reviewed first and given help and finally restricted and/or punished for their unacceptable behavior with equipment if warranted.

These processes and functions could be performed by any vehicle computer system and processed by any software at any level in a (PFN), and as these systems advance and can recognize vehicle movement with respect to environment and can affect any kind of automated control, e.g., remotely or onboard systems to safely operate any piece of equipment within acceptable, safe guidelines their utilization in this fashion should be considered part of this invention and fall within the nature and scope of this invention.

For reasons of personal privacy and legal considerations, these devices and software (PFN) should be secured in the manner that has been described for all these inventions, e.g., stopbox, blackbox, billing box. This invention and its uses will require the public and public policy makers to develop legal guidelines to constitutionally guarantee that its use is not abused by any governing body and/or commercial interest, and that it is always operated with the individuals approval where this is necessitated by law, or in a manner that clearly is required for public safety. Also, with these inventions in mind there will be a sensor array design as part of the steering device that allows the operator to control the vehicle while being monitored for vital signs and awareness, pulse and pressure through a finger device.

The present invention also supports any software systems that monitor an operator in any way as previously described, and/or coupled together through any of the invention's computer interfaces, and driven by any appropriate software to combine and utilize these earlier stated devices with state of the art sensors, such as IBM's papillary fluctuation sensor, the standard beep sleeper alert with a short range transmitter to the (PFN) which receives a head nod signal, and the same for a wireless elastic armband blood pressure cup that has a CO₂ cartridge or compressed air canister and electronic 2 way valve with a microprocessor energized with a AA battery that is preprogrammed to pressurize and depressurize the band and send a short range radio signal to the (PFN) to either display the reading or to trigger software to control the vehicle and call for help, ect. The C.O.T.S. product “The nose”, used for atmospheric cabin analysis, can sniff and identify 2000 times greater than the humans noses all the way to the molecular level and provide a distinct electronic digital signal for identifying substances and compounds for the (PRN) computer's software to process. And of course any of the already mentioned standard drug testing devices, and/or audio/visual devices or any device that can sense consistent head angle and/or alertness, coupled with any software that can compile any data retrieved either digitally, through any computer language, or any type of electronic signal that correlates to human movement for which either software or preprogrammed controllers can recognize as a possible compromised driver.

The invention will then either take control completely of the vehicle after warning the driver, or put it into the shut down mode and alert the authorities, or even in the legally authorized application lock the doors as programmed, turn on the dome light, and drive an offender back to jail. In the event that it is a medical emergency, the invention will optionally take control of the vehicle and safely stop it or direct it to the appropriate health support facility, while alerting, recording, reporting and/or ticketing the driver if applicable.

As the secure stop control/black/billing box (PFN) and sensor systems the become the industry standard, a questionable driver may be monitored in any vehicle, and his identity would condition his driving privileges in that vehicle, as well as record his performance and report to any authorities or service providers on his activities. The present invention will also help in properly affixing insurance costs and law enforcement measures.

Of course, the same kinds of programs could be structured for the pensive driver, and this would also include an outside operator appraisal response which could record other surrounding drivers, their responses, and the environment. In addition, vehicle speed and movement as well as any call-in information from surrounding vehicles, either by direct or indirect communication links, e.g., a low noise RF FM device with limited range that uses the host vehicle power and this invention's processes and comlinks as a automated message switching repeater station.

This repeater station is in every vehicle and equipment's (PFN) receiving any short-range transmission which it processes and then sends this signal or message via the cell phone for immediate 911 attention and vehicle recording. The software in the (PFN) will record all pertinent and current data when it dials out a 911 distress call. Because the invention recognized early that the integrated highway systems could use short range low noise FM transmissions to deliver messaging to the vehicles there has been plans to incorporate a multi channel transceiver for this purpose. Prior to these designs an earlier product design was experimented with by the inventor called the TOT SPOT, The Hunt Well, The Pet Path finder, and the Friend Finder. As is obvious by there names they were people locating devices or locating device for a lost pet. They were also simplistic in design and not very reliable. The system was two small CB transceivers originally CB channel 14. one of the transmitters was outfitted with a micro processor with the simple SOS burnt in as a latch on the micro processor, which when it received this signal immediately keyed up the microphone circuit on the transceiver. This allowed the receiver portion of the originating unit to pick up the keyed up transmission and by watching a signal strength meter an individual could turn in a circle and locate the direction of the unit with the keyed up mic. This worked very well for a bout a half mile.

This system was also designed to key up the microphone circuit if a water sensor detected water, e. g., a child fell into water it would send a signal out. And other designs were to allow a group of hunters to turn on all other hunters in the are transmitters before shooting while watching a directional gauge to see if anyone was in the line of fire. This crude device has always had possibilities, but is really much more valuable by the advent of the inventions (PFN) and better radio technologies available today. Many frequencies could work well but this is a question for a number of government agencies and the FCC to structure as a standard and regulation for this product development.

NOTE: This is not the same product mentioned earlier the people pointer, however it is also a personal locating device. The people pointer is a pager and GPS technology that could be water proof and outfitted with the same water sensors or similar.

This Rf transmitter system will rely on a second coded signal that will after a short look around by a concerned parent with their locator watch or belt clip unit; send this coded signal to activate the emergency 911 beacon signal, which will be recognized by any (PFN) equipped piece of equipment within reception distance of the keyed up coded signal unit. All receiving vehicles will instantaneously call into a 911 computer specially set up to center focus all the calls and dispatch emergency services there immediately

More sophisticated units could also have GPS chip sets and send earth coordinates as well. These units could be purchased and the service could be a non-charitable minimum for all cellphone customers as a base government tax. In fact, there are many more 911 protocols that should be considered non chargeable to the private customer, e.g., highway emergencies ect. and this is already the cases with cellphone users able to report troubled motorist for free by pressing *77 or *71 in some states.

For the highway systems some of these short range frequencies should be dedicated specifically for these purposes as well as for these short range transmissions for other 911 protocols to be relayed or repeated. And specific laws have to be set for society to respect and not abuse or unnecessarily over tax these very crucial public safety systems. And This is also part of the 1100 “Spider Eyes system” for Law enforcement and the (MMN).

So in summary these short distinct signals are interpreted for an appropriate emergency response and through this invention's (PFN) computer initiates a call into emergency services while also giving GPS Data or triangulated focus to locate lost children and or could be use to track non violent offenders as a condition of their release in society.

Some other possibilities for the communication link may take the form of a multi-band smart transceiving scanner (with a controller) that would rapidly use different tuning crystals and bands separating program responses and save computer size and capacity cost and complicated software these would all be pre-programmed and prescribed protocols from the FCC and other agencies. This would allow for many of different RF equipment to access this RF transceiver and help in identifying and locating people and things, e.g., another emergency response protocol other than location coordinates would be to activate outboard cameras and audio systems on all responding (PFN) vehicles/equipment to better track an emergency signal visually appraise it in real time without dispatching server/provider personnel either unnecessarily or inappropriately.

Electronic Accountability for Equipment/Vehicle Components

The present invention creates efficiency and reduces public cost which will always have to be the goal of any basic service. Ultimately for public safety some agreed upon version of this equipment will be required. And to the provide the proper controls each vehicle registered will have an electronic serial number and vehicle identification number (ESN/VIN) followed by all other peripheral devices interfaced by their serial numbers unless another ESN is involved. This will always appear in any header print screen or hard copy record for official record stored. Also listed are any and all state registrations and tag numbers form the most recent backwards. Some of the most crucial data will be bar coded on the external port communication port for a double check for any official queries. And just recently an Identification chip designed in Europe is being used by some manufactures so that even parts can be scanned to see if they are stolen. This system if employed more widely could provide with the inventions system an integrity check for a totally vehicle in minutes.

These numbers exist today and are used in the separate industries and the state governments also have their set of numbers. An every product manufactured is serial numbered. So all that is really necessary for this most needed control system is to have this information as part of any install program when a product is interfaced and when the vehicles system is queried with a legitimate request it will tell all the components on board and all that have been on board and their date of install and the date of first recognized absence during a reboot of the system. Also any trouble codes stored as for their on board performance. This will put a serious crimp in stolen parts market. In fact, stolen parts reported will be entered and any data transfers that recognize and stolen serial number in a compare list process will id the vehicle using the device and alert a flag for law enforcement to pursue.

After Market Bill Box

This add on device was designed to be a retrofit to be used for court restricted drivers and also as a pay for use billing box for renting time and electronically customized services and for receiving payment from reading a magnetic credit card for the use or service of a piece of equipment or service provided by a piece of equipment like a ride in a cab, bus or limo. This is depicted in FIG. 3 and was submitted in this first provisional and described in the first filing for the related applications

Along with the varied monitoring sensors, the invention would have a credit card swipe device along with the earlier version number pad so that an operator can access and could purchase remote system services and pay for any tax charges or any alternative energy charges through the credit card swipe. This swipe and key pad credit card device, like the one in use in the stores today, in one modality would be combined with a standard cell phones and it's keypad and have a swipe groove right down the side of the hand held receive and mouth piece instrument to ease the operator's ability to become current with any charges due.

Of course less expensive part time cell phone technologies could be employed, as well as only pager related systems that have one and or two way communication, which would inform the billing box of an expired credit card and also tell the box it must only except payment through a specific authorized card and record it, or it would limit or deactivate the use or uses in a safe manner. The present invention will be offered to the loan, rental, Cabs, limousines, busses, and leasing companies and further described in the commercial use area of this application also discussed in the earlier stop box application described incorporated herein by reference, as to control the use of equipment to equal the payment received. This is a unique claim to this invention, and it has always been designed for this in mind from the inception.

These are the credit card swipe systems that will be used for these two credit card billing devices and a list of products that could easily be interfaced in any of the (PFN) systems to create this function for future vehicles not requiring a retrofitted box. The first C.O.T.S. parts that will be used in the billing box system for commercial retrofitting are all from Uniform Industrial Corporation and these magnetic strip card readers are all in the ACETEK Series, they read magnetic strip conform to ISO 7811 format, they are manual swipe, bi-directional read with TTL output, Some are RS232, they can also read dual, triple and JIS (dual) track design. They read high and low coercive force magnetic strip (300˜4000 Oe) 5˜55 inch per second swipe speed, 5VDC and they have various designs for positive access/security systems ect. They are certified CE, FCC, UL, cUL. Another system that is a space save and will see service in the (PFN) bill box in is Uniforms industrial Corporation insert Type Magnetic Card Reader MSR 140 series. It has all the same specs electronically except it operates on 9vdc all of these voltages are easily provided in the interface (PFN) or box. And one other that works directly with a key board operation is the MRS200 which has a simulate interface and can read DMV cards For police car systems or the restricted driver licence verification. Also another device is the Personal Pin pad ID number pad 290/390 series it operates on 5VDC and it has a LCD display. The swipe cards will be connected to a F2F Decoder ASIC MRD 510/520 in the cell phone handset and be routed to a special phone node for credit card approval software that can process the digital data and any encrypted security algorithms either part of the credit card companies services or a software program run by private companies to process the card through the cell phone hand set receiver. This will not be the case in the box or any PFN system because space will not be an issue and the decoder chip and hardware will be accommodated everything. However, this is only one modality and their is always miniaturization and the combing of functions by the manufacture so ultimately the card swipe will be processed completely in the hand set and there are others planned for experimental prototyping presently.

Some of the other systems that can be used are FBS Solutions, they have two models that will work. All these devices supply there own software drivers to connect them to any PC. or in this case to the Bill box (PFN) mini computers where the software files would be down loaded to

Also as has been the practice in describing all of the inventions components and categories it is important to address the evolution gained in the magnetic Card industry. Presently the Smart cards on the market are becoming much more affordable with their micro cache's and they can carry much more data. Ideally the invention would like to use either Lockheed's advance fingerprint recognition system and or IBM's finger print scan system and have this as verifiable licences data to be scanned and retrieved through the (PFN) card reading system as the car ignition device. this data would be compared and confirmed by a closed seat occupancy switch and an occupied finger socket, pad or thaw on the steering wheel for a positive driver placement behind the wheel at the time of ignition and driving.

THE MACHINE MESSAGING NETWORK is an input data recovery monitoring system from all the individual vehicles, equipment, and machines (PFN)'s to already existing mass data management and storage systems for public safety, on the highways, for it's management of crime in society, and, to preserve this planets environmental state to support human life.

The off board mass data systems already exist and in many cases are already networked and interfaced with each other governmentally, in the banking industry and also in the insurance industry and in many other related industries due to a lot of the present commercial mergers. The hardware and software will be described in this section to demonstrate and provide how the invention can greatly aid the information technology highways presently and to best control and organize these newly emerging Machine Messaging system's data input for the future.

The Machine Messaging Network technology combines all existing commercial control systems for remote, services, machine controls, tracking, telemetry, all monitoring, and or accounting systems that are processed through any communication medium to conform to a (process copy protocol) for government mass data management and store systems.

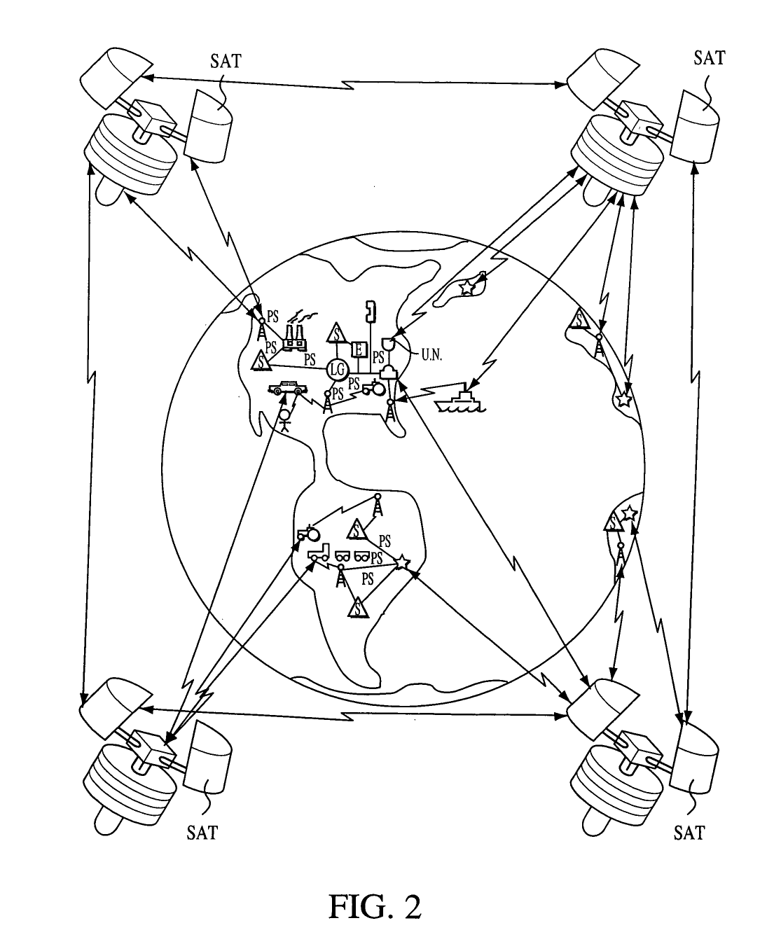

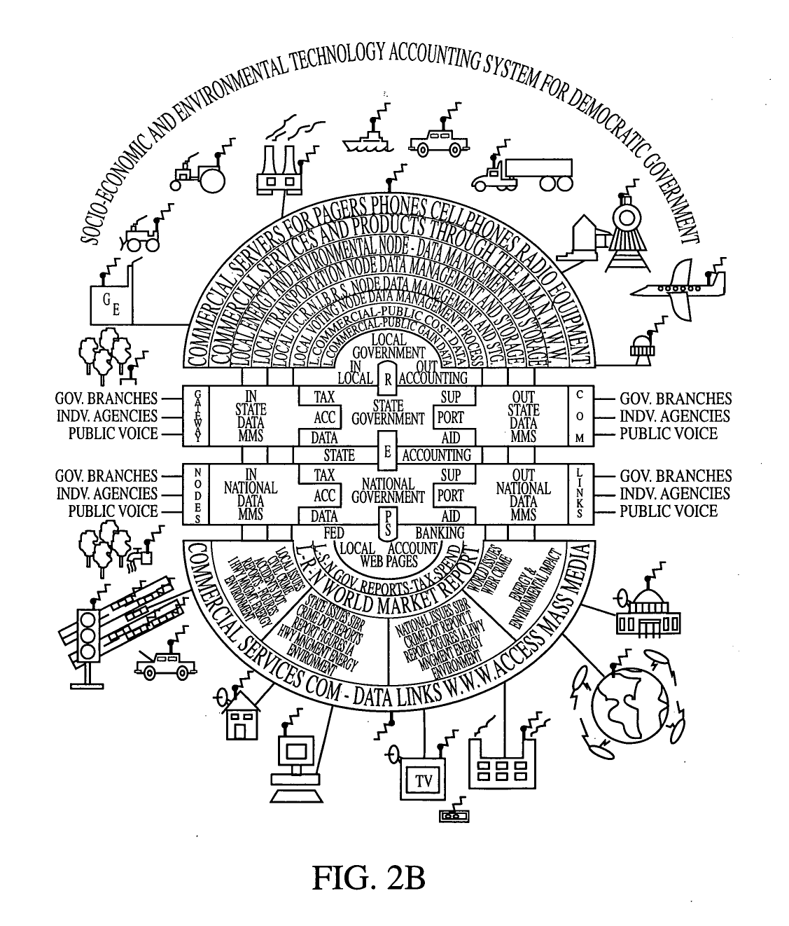

The protocols are to be structured by the governing agencies and computer systems requirements and the public service functions the agencies govern. They will be given a simple Uniform Format by which information is entered, screened, and routed for public presentation and stored for any archive purpose. This will comprise the National Data Mass Management and Storage System (NDMMSS). These Agencies listed in the accompanying U.S. Federal Government Directory as FIG. 2A is 27 pages in length and each and everyone of them can be clicked on and supports a web page on the Internet for public access.

They will supply data back as web pages for local municipalities, for the states Web page and for the National Web page. These will be Public Account Web Pages (PAWP's) which will be supported through mosaic and hypertext technologies in use on the Internet today. The specific data will be provided by the federal agencies on the Area Relevant Data Acquisition and Report (RDAR) protocol that will have as part of its architecture an National Security Review Flag (NSRF), which should be presented for any information that is absent.

The invention creates (the public account web page system (the PAWP's) products which provides the machine messaging network (the mmn) into a complete and total accountable system for society. This product is also structured to make the agencies and government officials or anyone; available for the public to interactively e-mail through the bulletin board technology that is available today on the web. This is a beginning to the electronic deliberation of issues. Also in this webpage format will be a simplistic poling record count of those for and against for every framed decision in which policy is being decided by the public elected officials as well as a comment column for the bulletin board. Ultimately this system will have voting software that will only allow one response to be entered per issue by a person through their personal encrypted vote pin number and all other entries will be disregarded or flagged for multiple attempts to violate a voting procedure. However this will serve to give feedback at present to the representatives as well as keep the citizenry appraised of private interest activity possibly corrupting the public trust.

To continue, the agencies will present any data related to their activities that is relevant to the above mentioned Web Pages. This data will appear as clearly stated Issues of area Public Interest (IPI's). They will appear as Public Safety Issues. Upper case are the categories

Transportation; Roadways, Railways, Air Travel, Sea

There would be immediate listing for substance leaked on to the roadway and requesting local hazmat teams to respond, Accidents would be recorded and their severity would be assessed showing the location and time for easy public understanding of the problem areas needing improved designs, All pollution recordings as to the number of vehicles by the category in violation of acceptable parameters. For in-state, out-of-state and on what interstates.

Environmental data on elements chemicals and compounds present for air, water and any soil sampling. Crime incident reports, featuring location, and earth coordinates, date and time and any real-time recovered data, (pfn) videos or snap shots, audio recordings along with listing police, and request for public assistance information.

Note: this system would have an expedient format for local law enforcement to use any captured data for immediate presentation to the public and it would have a security protocol like the national security review program that would flag data as unpresentable for police investigation purposes and this flag statement should also appear on the public web page. Police Protected Data (PPD) Flag,

The information presented on the web and gathered from the (PFN)'s is going in many directions once it is received by any land line telephone node Gateway system whether these be publicly owned or commercial operations. The government designed protocols will be industry standards, and operational requirements and regulations for licencing to own and or operate a node for the MMN. Because this process takes time the crucial services for public safety will be coordinated first. Systems that already exist at the local level will set up their local nodes as to the government guideline for data acquisition that already exist today. And this will be completely detailed from local to the national level for law enforcement presently. A similar process can be an on going process from the present and on into the future.

The invention's (MMNWWW) will take advantage of local police systems that are using the web already to work and the public and are also part of the United States Justice Department's (FBI) National Incident Based Reporting System the (NIBRS)

One such local police force is San Antonio Police Department and their patrol Division. They have made strong efforts to do community policing and to involve the community in policing itself, which is great for the police and the community. They have developed six decentralized sub stations to work close with the community and they provide a department web page that provides crime data and maps and the current UCR Uniform Crime Reports for the FBI reports so that everyone can participate in appraising and accounting for the crime statistics. Each sub-station for current crime incidents posts a list of area violent crimes, burglaries, vehicle thefts, etc. in a blocked column listing giving the district number, the case number offense, the date whether a gun was used at the time, street, and could just as easily list map coordinates. This data while presented for public review is generated through the National Incident Based Reporting system deloped for and by the FBI and The Bureau of Justice Statistic (BJS) back in 1982, with and developed into the standard by which all crimes are reported to the national crime statistics mass data computers. The (NIBRS) is generated as a by product of state and local incident based reporting (with this government structure software design). However, it is designed to suit individual municipality needs. There already exists a protocol to extract only specific data form the (IBR) state programs and pre pare them on magnetic tape in a specific format for the FBI record.

This national incident based reporting system is well establish and has a progressive chain from the local departments to either directly transfer data to the national mass data base if the department can provide the data within acceptable national parameter and or state protocols that will insure that the national data base receives it in the proper format. At any point along this process the proper data can be transferred to the appropriate web page.

This incident based reporting system will be adjusted to retrieve the most inclusive and current data and direct it and or divert it to the appropriate agencies to prepare this data for everyone examination. And at the local level where it originates off the gateways will be immediately accessed by police request and posted in real time for the public and police to interact with in the quickest safest solution to any and all public safety issues. This is the 1100-1200 Spiders Eye and Green Eye program Social Products created from the (MMMWWW) union. As mentioned earlier all government agencies have their own networks and more and more are they being networked at many interactive levels. The environmental data would be processed throughout the state environmental programs and there hazmat programs and on to agencies like the Transportation Environmental Resource Center (TERC)—And the Office of Enforcement and Compliance Assurance (OECA), which is the United States Evironmental Protection Agency's EPA's Division that handles the nations programs and, initiatives, policy and guidance, regulation and statutes, citizens involvement, government partners, industry an government environmental justice, Federal facilities and activities, international data systems and models. They also handle training, what's new and news, feed back, and they have offices regionally and of course they provide a web page which can be the beginning a hyper link from the Web account page and the regional operations can provide their data. The EPA also has it's own law enforcement division called National Enforcement Investigation Center (NEIC), located in Denver, Colo.

It is the office for and is responsible for Criminal Enforcement, forensics and Training The (OCEFT) supports the environmental enforcement community through expertise in field activities, engineering evaluations, forensic labortory activities, information management, computer forensics, technical analysis, training, and in courtroom presentation of evidence. Clearly the government structure is in place to set the guide lines for this real time recovery of environmental data sent From the (PFN's) to their Gateway communication nodes and on to the EPA's landine phone connections regionally and nationally as well as assimilate all the state collected data manage it in their standard programs and mass store it. And with out question in this process the regional and state EPA agencies can provide this structured data for presentation on the State and Local Accountability Web Pages.

These regional offices and the national office would have land line phone connections or could be hooked up for high speed satellite data transfer so long as any necessary security flags were in place or the messages were encrypted. Especially if there was data from military vehicles was monitored for the Pentagon or (DOD), They could transmit this data in special encrypted codes with algorithms that are impossible to decipher without the appropriate software. The are actually commercial product of this caliber.

Many government agencies are involved in mass data and so is industry and banking. And presently The National Air and Space Administration NASA has planned it's seventh Goddard Conference on Mass Storage Systems and Technologies to address the scale of data collections, presently and into the future. Data storage is quickly going from terabytes to peta bytes with the number of objects going from millions to billions. And the integration of archival storage systems into data bases and digital libraries is already under way. NASA and the IEEE are addressing the issues around integrating these archives into information management systems. Not just government, but commercial computer systems are likewise facing the same mass data storage and management challenges. So the systems are here and are being designed to meet these management and storage demands and all the technologies are merging to be able to create a MMN from normally evolved product developments so this is the time to install the invention with its (PFN) and the (MMN) with it's web page products on the (WWW)

Anytime the (primary focal node) provides data to the machine messaging network for any public data recovery this is a product of the invention. Anytime any other monitor and control system sends data to the machine messaging net work for any public data recovery this is a product of the invention. Anytime the data recovered form the (PFN) is provided to the public—this is a product of the invention. Anytime the (PFN) data recovered product is used by the publics agencies and or government—this constitutes another product of the invention. Anytime any PFN data is used to bill for the use of equipment/vehicle or machine this is a product of the invention. Anytime the (PFN) recovered data is used to perform or provide service to a piece of equipment this is a product of the invention. Anytime the (PFN) is in use to remotely control a piece of equipment—this is a product of the invention. Anytime the (PFN) provides data for international purposes this is a product of the invention. Anytime the MMNWWW is used for any purpose this is a product of the invention.

Returning to data management and data storage for a discussion of the Gate way nodes of medium and large data storage systems that will be doing the everyday providing of services to the (PFN)s. Once again Sony has developed some very promising compact mass data systems and a moment will be taken to investigate how this systems and others could fill the intermediate gap between the government mass storage systems and also provide service to the (PFN)s as gateway nodes, e.g., insurance companies, fossil fuel companies preparing for their futures bank card companies auto manufacture their dealerships, independent service providers, small local government and their agencies etc.

In the future there is going to be a Myriad of these commercial suppliers for the owners of (PFN)s which will be every one and almost every thing to chose from. And especially when the alternate energy systems are marketed and they can provide energy for virtually all work, either mobile application or stationary needs for private and public use. And without the dangers of flammability environmental contamination high the presence of high powered electrical transmission lines or gas lines or gas and oil storage tanks or dangerous nuclear energy, ect.

Energy Control Product

As mentioned earlier this is a product design use for the invention to provide an economic tool for these new energy technologies and powertrain products and to maintain balance in this process and this means economically and environmentally. So these commercial servers will have in their software programs the governmentally appropriate protocols and must have them to obtain a licence to do the business of data acquisition at all through the (PFN) or any comparable systems that will fall under government stipulations. The government will either provide the soft ware packets at an affordable price or for free. This is to help generate an economic expansion. The soft ware will have tracking architecture displayed in the header to show it's electronic pathway to make it accountable monetarily and for credibility.

The more sophisticated the (PFN) Gateway node companies are, the more services they will provide, and the more off board data storage they can offer their customers as well as save the public systems money. For these reasons these servers should be given tax breaks for updating and increasing their management and storage capacity. Many pager Cellphone Charge Card dependant business are natural growth companies for the new industry to provide services through the PFN and the MMMWWW.

There will also have to be a licencing structure and an ID address provided to these (PFN) serviced providers, companies similar to the process done for the World Wide Web, and in most all cases these companies will also have to be address for the WWW as a gateway provider as well.

Sony has mass data storage type robotics systems called Peta sites, These systems are good because they can be added to with space saving technology that can be suited to an individual gateways needs. It is comprised of four components. The Basic Console loads and unloads the tapes it has a data capacity of 0.6 TB/15 csssets power consumption is 3,000 VA, it's dimensions are 35⅛ 80.⅜ 53⅓″ and it weigh 859 lb. The Drive Console writes, reads, and stores tape capacity 4.8 TB/115. Casset's has half the power consumption of the basic console about the same weight and twice as big.

The Casset Console is about the same size as the drive console has a data capacity of 7.5 tera bytes/180 cassets DIR drives and weighs about 600 lb Junction Consoles for the automated or robotic tape loading and unloading has 0.6 TB15 cassets same size as the basic console and weighs 925 lbs. And the system is scaleable, it has innovative robotics, and it uses infrared communications, controls a unique mailbox system, and the tape scanning system is a barcode type, and the system ca self diagnose and trouble shoot itself.

This is a powerful little mass storage system and Sony has put together a peta site for CNN to video Archive 18 years of video segments some 700,000 video segments, To do this project Sony teamed up with EDS to create this media vault.

One point to make presently is that the National Transportation system Highway Safety Administration and all the State DOT agencies would also be linked together and provide Local, State, and Federal Web Account Page issues in the same manner, In fact any and all Agencies listed in the 27 pages of FIG. 2a will be capable of providing issues to the Web Account Pages.

Now to return to the invention programs that will be put into use through these computer systems on and off board the (PFN) host equipment and the structural concerns of the agencies that will help structure and regulate policy. Presently the FBI has stepped up it's training and is training many of the world's police in their investigative procedures. Which also makes the invention timely to gain world wide use and standards. And this could be an ideal time to coordinate and organize a world wide crime incident and reporting system.

System Functions

The 1100-1200 series spider eyes program for law enforcement and government use police-spider eyes-report back public web crime or incident-report-record-pub web.

The police will have a wide array of innovative devices to chose and aid them in their job. And all created from the invention's ability to interface all types of communications, data storage and interface with remote control devices on the vehicle.

These innovative police tools are part of the inventions 1100 series innovations and the “Spider eyes” program referred to in the 3rd provisional patent applications with the use of video recording crime or traffic accidents and or event recording, which was also described and discussed in the first patent preceding this one. The officers first device would be a scanning device at could retrieve and store data and compare it with stored data or data retrieved for a comparison purpose. This single device or function of another of the inventions innovative devices the combo gun would be able to retrieve from any vehicle the VIN-ESNR number, date and time of reading, and any software held data, on vehicle ownership road worthiness, and any illegal operations (excluding personal storage files) in the secured storage areas. This can be accomplished by connecting to the hard wiring to the cars external communication port array or a (USB) or even obtain this data wirelessly as explained below.

The officer could first view and then capture this information and run it through a software compare list that is either a pre-loaded local and national (UCR's) and (NIBRS) pertinent data files from his Role call briefing at the beginning of his shift. Or it could be data obtain in real time through contact via an isolated and protected short range Rf signal from his cruiser where it is received and retransmitted (Repeated) by long range two way radio or Cellphone or a 2 way pager transmission equipment through any number of interfaces and equipment as covered in this application for the invention. Ideally the interfaces would be housed in the secure box system. The hand held unit will have a couple different configurations including hard wire connections and wireless technologies, but all will have in them (a micro processor, EEPROM buffer and or Sony mini digital “memory sticks” or a comparable technology. If hard wired connections are used the officer will place the hand held unit on his peripheral communication link (USB) or some universal set of connectors array and down load it to s/his larger data storage unit in the cruiser (8 gbte or better). These USB's and outside and inside the cabin connection arrays will also help when servicing any and all vehicles and will help to certify the repairs on the unit for the customers later reference through their own computers on board. Another communication port technology is infrared. And the infrared technology will make this interface for on the spot data acquisition extremely easy for the user as well as any wireless communication technologies if so desired or as a necessary back up. All of these C.O.T.S. products, systems and technologies that the invention interfaces with will be discussed at length in this application.

However many Police Departments use wireless shirt microphones that allow their more powerful vehicle transmitter to (Repeat) their voice signal to their dispatch or department office or headquarters.

Retransmission or Repeater Interface

These same systems will be enhanced and innovated to send and receive compressed digital data with the proper communication codes to direct the type of response use (voice or data) Emergency services will be on 2 separate frequencies. This should be used for the police, security and emergency response application to allow for simultaneous communication of voice and data. (even for physical vital signs for EMT's). This is presently accomplished with cell technologies in some fire and ambulance departments, however the repeater interface is another option and probably safer for those patients with electronic pacemakers and automated medication dosing devices, ect. And it is less of an interference and influence on other sensitive electronic medical equipment.

Of course, police and emergency response personnel will be on special dedicated FCC (USA) frequencies for all short and long range transmissions. This way an officer can be in direct contact with his department office with his audio signal and simultaneously be directly connected to the departments FBI Uniform Crime Report (UCR) Data base through the land line phone node of the departments computer that acts like a Gateway to the FBI computer net work of crime data basis which includes the FBI's National Incident-Based Reporting system (NIBRS) which will provide direct answers in real time for officers' queries. And provide a modality to record on the spot reports as things happening.

This will be accomplished technically with software in the cruisers computer secure box and or interface that is designed to meet the FBI standards and requirements for (NIBRS) report filing. The officer will be able to give a vocal report in real time through voice recognition technologies. His/her incident report will be recorded evaluated and held in the cruiser's buffer and or hard drive and also directly burned on to a permanent data storage device. This is done to keep as pristine as possible first record.

The officer's report is simultaneously sent to the departments gateway computer and it's mass data management and storage (a peta storage for magnetic tape or cartridges which meets the FBI's (NIBRS) requirements (in most sizable departments (100 officers or more) probably already exists. And for smaller departments data storage will be sanctioned by state data bases to meet federal standards and passed on in the proper protocol or returned for editing to the originating department and officer.

At any gateway computer or one with the proper software compare lists any report can be evaluated to determine if it meets with the Justice Department standard or the FBI requirements for (UCR and NIBRS). If so it is passed on to the state data base for evaluation (for non member department's or ones who do not have the size or the equipment) and then on for record keeping if desired and on to the national FBI crime data base computers in-Berkley-WVA. This is the first leg of the control system for the accounting of public crime. The second leg is the simultaneous accurate real-time reporting to the public, the political representatives, any and all necessary government agencies and any and all commercial interests.

And this is accomplished by using this invention's control system embodiment the Machine Messaging Network (MMN). Ultimately every nation in the world will have a (MMN) system that will openly share as much data as it receives through its agencies mass data management system as described hear for law enforcement. This would involve environmental data, land water air and resources. At any rate what ever data is to be shared openly will appear on the World Wide Web (WWW) as a local web page, a state web page, national web page, and also a world wide web report page as earlier described. All in the world will be able to view and respond to it with E-mail. And the great access for all to be on line can be achieved through the lowing cost to gain web access through TV Cable and other low cost mediums.

One goal of the control system is to empower all the people with real data and communication with each other so they are not victimized by the media's representation of what is pseudo-determined facts by pseudo qualified editorial and/or professional opinions of the real facts and data for any private interest. At the very least this should help develop some responsibility for their extremely financially rewarding use of our public air ways and our laws governing free speech and our extremely generous use of government property in land and our technology as we the informed pubic have afford them in the past. All of us need to be able to give our input to the issues that affect life here on the hydrosphere. And the web page will be detailed on how it will easily provide the facts in a simple precise manner and allow the public to seek out the opinions necessary for them to form an opinion and respond by E-mail directly to their representatives at the very least.

1100-1200 Series Green Eye Program; 1100-1200 Series Spider Eyes

Initially in the (PRN) runs self evaluation program from established test standards to determine if their is a worthy warning flag to alert the driver, record the pertinent data, and determine if further action is necessary. If so the report function to the (MNWWW) is notified for a response and the printer is activated and the operator has to acknowledge the receipt of the message. The present invention will rely on government tests for each vehicle type for their types and levels of toxic emissions to appraise their environmental impact, which will through the invention directly correlate to their compliance to the standards as the cost of a specific vehicle's operation until it is shut down and/or red tagged as unacceptable. For vehicles now in service, these parameters as environmental standards exist today. However, the invention is bringing these environmental standards of specific offenders to real-time compliance. It will also reduce the need for the state to maintain facilities to try to police these environmental violations.

This will allow the state to become a more cooperative human partner in humanity's life situations and less involved in policing humanities technology for revenue. There will also be sensors on toxic fluid chemicals levels in every vehicle and loss here can be dealt in the same manner. However, warnings will be issued and driver's must acknowledge receipt and timely repairs and service/authorities must sign off which would negate and/or reduce any monetary penalty. This is to catch the habitual offender who continually operates a vehicle not road worthy or is environmentally harmful.

One purpose of the present invention is to free up police officers from losing valuable crime stopping time to revenue the public for traffic control and environmental safety, more time for people to police people—and let the machines police themselves.

Auto Tutor

The objective of the invention is a good and peaceful merger for all. The present invention is similar to an auto tutor: The belief here is, the accurate information that will be more readily available to all and coupled with the skills to condense this data individually and publicly, man will make the correct decisions and put aside his petty differences and selfish interest. Not at first but with awareness humanity will do this as a whole. This should be how this invention is used and its purpose.

It is through these avenues of purpose, service, and use that the invention will generate business and the ways the above mentioned servers and providers will commercialize it as fully described and claimed clearly here and now. And it is very important to understand this huge and diverse unique claim of accounting and analyzing as it pertains to the invention's entire monitoring network system. The present invention, with its monitoring and control capabilities, is a secure interactive Internet of communication for man and machine that will evolve as a world wide web with secure communications and control for all humanity's equipment.

Commercializing, Services and Use of the Invention

First the invention will actively seek out and query the Government and all it's agencies to gather information as to what equipment and systems it uses and how it gathers processes and stores it's mass data. And then seek out and join with any involved commercial and government efforts underway that are standardizing programs to join together data bases. Once again the timing is perfect. At present the computer industry is trying to readjust for the Y-2K problem. So the inventions deployment can be expedited though this process and the fact that all government agencies are networking their data bases. With coordinated efforts presently this set up for the (MMNWWW) can be accomplished in an efficient manner with joint cooperation. The inventions (MMNWWW) program will strive to coordinate it's direction and goals with these efforts, commercially and governmentally. The invention will also seek out government departments and agencies to utilize their technology transfers and technology grants in an effort to coordinate as much as possible this effort to develop the (MMNWWW) and be willing to combine it's technology with other manufactures and government agencies in as productive a manner as possible to develop this necessary network. The invention will lobby and participate as well with the governments public officials and work on the legislation for the practical uses of remote control technologies and robotics systems for the nations highways (D.O.T.)

Accompanying this application is a directory taken off the world wide web of every federal agencies web page that can be reached through clicking on that page and it is the intention of the invention to provide a hyper link to everyone of these agencies through the web account pages and specifically on issues they are involved with in a specific geographic location. And provide away for the agencies to CC this pertinent Data or down load it to the Invention's Citizens web pages.

With this data readily available on the web, the public can judge what the utilities should cost them and give their input to any rates. They can also view current billing and even pay it over the Internet personally or through personally owned automated software that appraises their billing and their financial status with over draw protections.

This is a list of pertinent Government agencies that would have special needs satisfied by the inventions (PFN):

Military—to control civilian vehicle and material movements in nation building operations that require a necessary occupancy force to mediate between two or more conflicting groups;

Environmental protection agencies, as has already been described throughout the invention;

Department of Transportation agencies to assess infrastructure needs and use, along with interactive highway interfaces and Smart Cars;

Energy Monitoring Agencies;

Revenue Agencies that assess their taxing as to the operational uses of equipment or time of use or geographic travel;

The Interstate Commerce Commission;

Any and all law enforcement agencies, e.g., for vehicle control, personal monitoring, lost person locating systems, evidence procurement, public safety, fine assessment for violations and automated insurance;

The Navy, Coast Guard, Marines, Air Force and Army as a locating device and for remote control and service;

Also the Park Service and Forest Service and U.S. Agriculture Department;

The Judicial System and related agencies to be used as evidence in courtrooms; and

N.O.A.A. eeather condition.

Programs the Invention is Designed to Enhance for Society (PFN)

Note: The billing box (PFN) innovation is to provide a real service by creating legitimate commercial business that offer accountable services to protect the individual, society and the environment as it evaluates fairly our impact and actions with our machines and on each other. Note also that the accountability factor will be based on fair and good use of equipment and resources which will correlate to, and must be augmented by pre-defined cost factors for use, so that fair pay scales for any activities can be equally applied for commercially, as well as private individuals based on the volume or activity and the machinery's operational economic coefficient impact fee which will be determined by the earlier described process, or any agreed upon legally prescribed manner for business operation, e.g., contracts.

In addition, every piece of equipment will be evaluated for its impact then monitored and controlled: e.g., cars, farm equipment, construction equipment, even home devices and stationary equipment, private and commercial.

This is a partial list of industry categories and government agencies that this invention claims as its providers/servers and users which fall within the nature and scope of the invention, when it is used for, and/or in conjunction, with these herein stated devices for these purposes, and should be considered proprietary and protected markets and customers for the invention.

The industries are: Car Rental & leasing Companies, Rental Equipment Companies, Loan & Finance Companies, Car & Equipment Manufactures, Repair Service Companies, Insurance Companies, Telecommunication Companies, i.e. pagers, cellphones Rf transceivers, Standard Land Line Phone Companies Inter Net Providers, Cable Services Providers, Public Transportation companies (i.e., railroads, subways, buses, cabs, and limos, fuel and utility companies, credit and bank card companies, any manufacturing that uses equipment and energy to run it). Privately owned and operated highway systems (toll and interactive. Boating Companies, Farming and Agriculture related companies, computer companies, computer software systems, e.g., Microsoft, and the like.

Monitor and Control System (MMN)

Most of the discussion for the monitor and control system was focused on the macro system (MMNWWW). And this is the third embodiment from the first patent application fully explained on how the entire automated machine control system operates World Wide. The smaller systems were detailed in the first formal applications and many closely related or similar technologies to the invention have developed programs commercially already that can be incorporated and should be to complete the total accountability system. Some of these companies are: GM's Onstar program, EDS 911 Software and the SIR automatic dialing for an accident etc.

The (MMNWWW) (gateway provider, commercial server) will be governed by law to how it must handle certain data received. And it will be able to access immediately any government agencies data phone in put node directly to down load information to that data systems buffer and management system (there will be a 911 priority protocol for certain data calls).

Small Commercial Business Growth and Public Savings

Once again by this constant automated vehicle monitoring the environment can be protected as well, and the municipalities can obtain revenue with respect to government standards assigned to specific vehicles impact on the environment at any specific time of its operation, while simultaneously notifying the operator of their cost and warning them of the need for attention to this problem. It is my belief that this will save consumer time and money, while preserving a revenue base that will better insure timely repairs without wasting an operator's time in some government or personally owned inspection/repair operation where apathy and conflict of interest often take place.

However, these small service operations could subscribe to be an approved and accredited business through guidelines set up with municipalities and monitoring companies (servers) and sold piecemeal work or do the work out of an entire service contract that has been sold to the operator consumer as a package deal. It is not the intention of this invention to isolate the small service operation or do-it-your-selfers. In fact, the opposite is the intent: it is to help the small service operation have the most up-to-date diagnostics available to avoid the expensive repairs of today when the wrong parts are misordered for the lack of knowledge and understanding in diagnosing the systems, devices and electronic sensors of today's vehicles.

To have more secure control over our machines while qualifying the effect on our environment and their effect on our economy as a group and/or individually, e.g., fair market economy with respect to service and repair. We need to keep our service options open while networking technical data to improve the quality and cost effectiveness of repair. This inventor envisions, for example, more independent operations, franchises networked with OEMs, and the like, as one of the primary providers to these servers and the customer.

Through expanding the availability of repair knowledge the invention can keep generating individual creativity by helping to insure some individual prosperity through expanding markets through improving smaller independent businesses capability to not only compete, but to be cost effective as well which will provide resources to be creative and strengthen the economy. Big business will always be consolidating these good and effective developments in business practices, and market share and small commercial entities will increase with new markets for public value, thus raising stock values that will draw investors. So we will create more money to buy more real products and services which will employ real people. This invention gives our world economy real data to balance this process, i.e., population and resources intelligently and fairly.

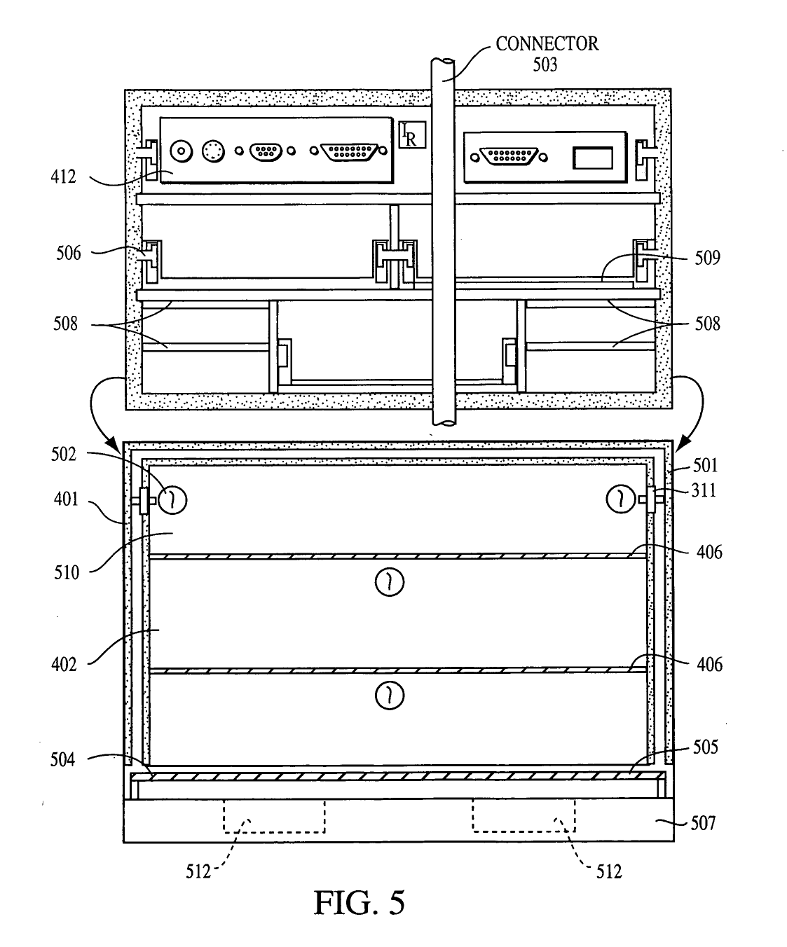

Because of the wide range of remote control and the varied products and program products available and on the market presently the invention will be presented in a pseudo-prototype evolution in FIG. 5 with the electron devices in patent III to illustrate all the different progressive level of remote and automated controls with three main considerations in mind. The CPU capacity of the (PFN), the peripherals in and on board and the communication deviceds and gateway capacity and services provided and or purchased. Many of these components and services can be moved around in the prototypes if they can be supported with these three things in mind, And these drawings should not be considered as the only combinations that the invention claims as product configurations. They are provided for better understanding of the technology and as a suggested evolution with public safety in mind for the development of these remote controls to full robotic systems, e.g., Smarts and the Interactive Highway Systems. A flowchart in this application in FIG. 7 shows the basic development of the prototypes from communications to peripherals.

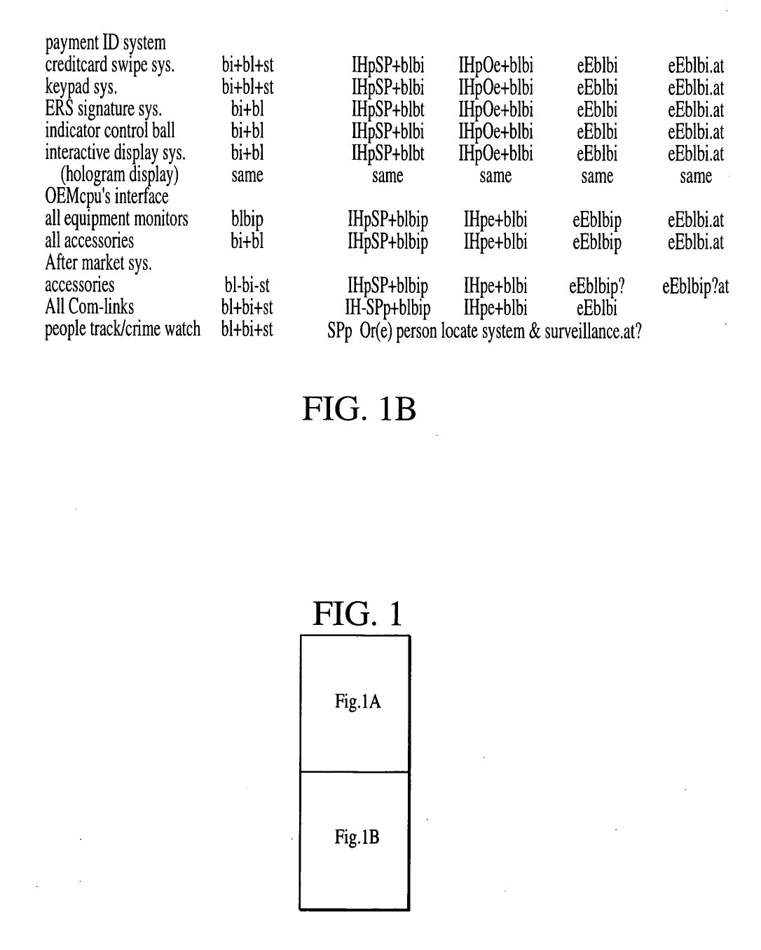

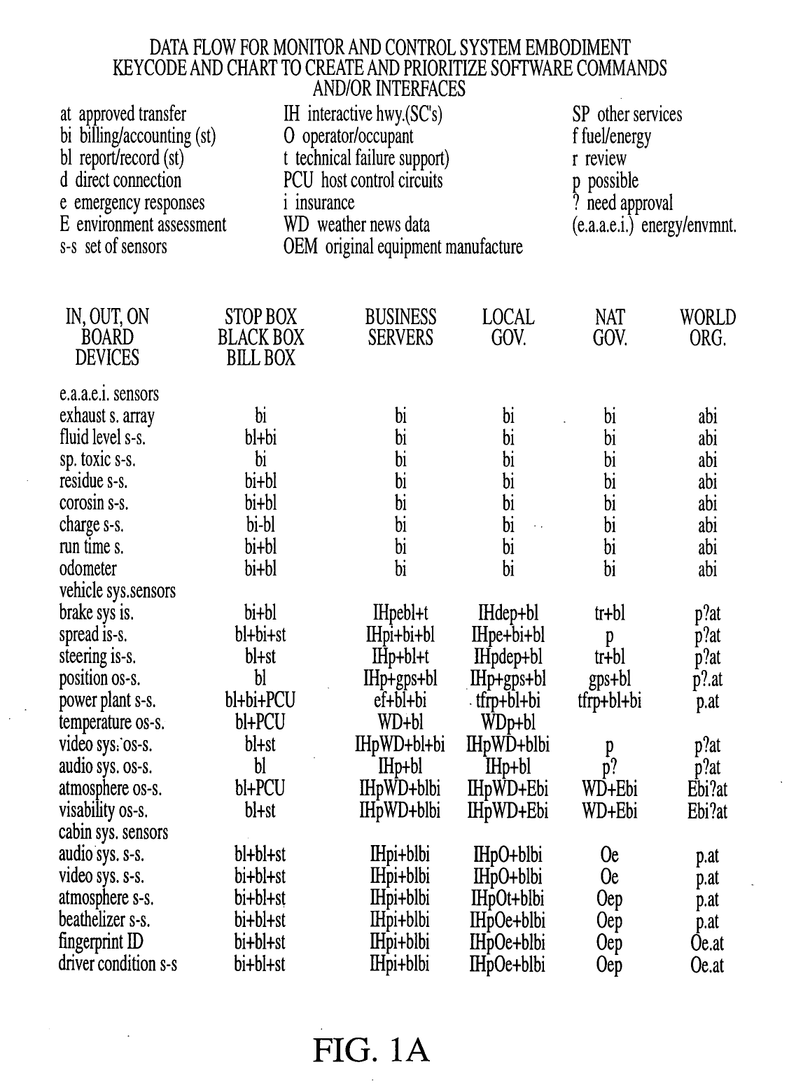

FIG. 1

This figure is a descriptive flow chart that illustrates many of the possible variations that could be employed to completely create an interactive network of servers and providers as has been ascribed to/from the stop box described in detail in the patent applications incorporated herein by reference. This system has always been described as one that could be individually owned and operated, commercially owned and operated, and/or publicly owned and/or operated. This system embodiment has always described flexibility as to size and function with the defining factors always being the devices, systems and people wishes as to the properties and qualities that comprise any particular market product or system.

So in keeping with that nature and spirit of these applications and the latest device and software innovations, FIG. 1 is a flow chart that plots and prioritizes the command and operational functions of all the hardware and software.

Throughout this application, most of the description has focussed on the hardware and firmware of the actual products or components as well as what hardware and firmware they will utilize to complete their interfacing and interacting tasks. And most of their functions, which will be performed by software commands have been verbally described rather than in the form of specific commands.

There are three reasons for this. First much of the software exists in many of the individual off board system networks and the world wide web. Second they are also constantly under change and near impossible to completely list even in all these applications. Another reason for not listing specific command strings at this time is because of the many different pieces of equipment possibilities in the PFN's interfaces. In this case many of the manufactures of the C.O.T.S. parts and products have already designed the hardware, firmware and software commands to complete the interfacing for any functions desired and these are adequately described. But most importantly the exact way these functions will be commanded in software must conform to all the regulations and laws of the land and these issues are still in a process of development and will always be augmented to provide the best legal software for the right equipment and personnel at the right time, e.g., specific court instructions for a provisional driver ect. The (PFN) is the focal no deal to perform the three basic secure and protected containment functions of; The Stop Box, e.g., to restrict unauthorized use of equipment, the Black Box to record and preserve data in an acceptable legal manner, and the billing box which provides a total accountability system for humanity economically and its physical existence on this planet.

All the technology necessary to complete these tasks have been described and detailed so that anyone in the arts could easily build and program a PFN to do any desired preprogramed functions of automated robotics and or remote control. And in many of the cases with C.O.T.S. completed products a lay person could be just as successful at these endeavors. Also, in the third application the specific electrical functions of the devices on the host vehicle are completely described and detailed with many of the software command structures. The first application also gives a version of one of the “basic” software programs used to remotely slow a car down, warn the driver and others of the action taken, stop the car and secure it in a stationary position with the dome light lit and an all the Hazard flashers blinking. The software program (already prototyped) also applies the brakes automatically if the driver or occupants try to leave the car prior to the complete shut down of the vehicle. While this software package is relatively simple it completes the stop box and some of the black box recording functions to more than demonstrates the practical reality of the invention and the feasible completion of any of it's prototypes and or technology. So figure one provides a map of directions as to how the software commands initiated in the (PFN) will be structured with respect to the devices and sensors on the host vehicle and how they will be effecting the PFN and the PFN affecting the devices, which are all interfaced with and in relationship to the control systems off board. This application describes how the invention can do all of these functions and it suggests ways for society to use the invention. But in no way does it attempt to prescribe to a democratic society how to govern or implement the inventions use. This is for each society to decide how to use the invention for learning analytical and appraisal purposes and or the imposing of any controls physically or legally.

FIG. 2

FIG. 2 is an illustration showing the world and all the possible networking of systems that will make up this complete interactive data handling communication and control system, or create the monitoring network of the present invention the (MMNWWW). FIG. 2 shows satellites that surround the world and triangles denote commercial or private servers and government providers; the servers\providers are gateway nodes in most cases to land based phone service for computer net works for the government agencies commercial service companies, and/or the WWW. (ps) means phone system hard wired; (lg) in a circle is local government; [E] in a square is the emergency response; the little man is a lost child or convict; and also depicted is a tractor, boat, plane, bull dozer, factory and a car.

The radio towers are, for example, cell phone, digital and/or pager towers, and/or RF systems and the capital of the US represents the national government and the stars are other national government around the world. The triangles are servers in other countries.

This figure is meant to present the simple view to establish the concept of a world wide monitoring system to link all forms of communication networks through the inventions PFN's to create the Machine Messaging Network the (MMN) which when it's data is presented on the WWW as informative accountable web pages completes this task. Society once again will have the means and knowledge to use this monitoring and record keeping system to control functions either indirectly or directly with remote control in real time. But this will and probably should be done with caution and consciousness.

The reason that this world monitoring and control system is feasible and not just some inventors dream is because it is based on smaller networks which are presently emerging and already perform meaningful public desired services by combining telecommunications and vehicles together. These are not at present true remote control, automated control or any real robotic set of systems for machinery. But most definitely the invention is what the future will need to make these emerging systems better for all society. It can provide for fair revenueing and assessing at the same time through accounting for material use and waste products with the operation of all humanities equipment and technology. And without any doubt the timing is correct to create this type of accountability to better help humanity to manage it's technology economically and environmentally.

FIG. 2A

FIG. 2A is a list of U.S. Government Agencies. And in fact it is actually a U.S. Federal Government Agency Directory prepared by LSU in a search engine format web page with hypertext and or mosaic or gopher software architecture so that the browser can click on any under lined department or agency and go directly to that specific departments home web page.

So obviously the agencies already exist and they are set up to enter data on to the net through their own web pages. Many of these agencies already prepare data by regions if not states and local jurisdictions or geographical boundaries. Some even provide this data presently to universities, corporations and or governments. for their research and knowledge as well as the general public. Most importantly the areas dealt with in this application as to watchdogging the environment is well saturated with governing agencies. Those dealing with the environmental, law enforcement and transportation as well as all taxing agencies and revenue mechanisms and government spending or disbursement of public funds for the local state and national levels are also available on the Web already. This makes the goal of setting up Web Account pages for local state and national very easy by maintaining a structure that will interface with the government agencies and financial markets supply it's information to this format. The purpose is to develop a public product for rapid awareness of one's physical and economical environment from the local to the national level to greater insure the wise use of technology investment and create a more politically interactive public that can voice its views economically and by public comment through electronic polling in the most efficient and clear way.

Some of the national environmental agencies that would supply data to the web account pages are on page 3 of FIG. 2A NESDIS, EIS, NCDC, NODC and the coordinating agency Office of satellite Data processing and distribution. Some more are NMFS, NOS, NWS. As well as the office of Global programs, The office of Oceanic and Meteorological Laboratory, Air resource lab, Climate Diagnostic Center, Forecast System Lab, geophysical Fluid Dynamics. Many of these would be coordinated By EPA and the data would be presented in clear accurate packets framed to current issues if appropriate, as well as, given as raw data hyper links that the individual can click back on and find the agency and person responsible for posting a specific data framed for a issue.

Along with posting data to the web page many of these agencies would be gathering data from all the PFN's through either their area local phone nodes or networked commercial servers that transferred data to their local nodes. The agencies would then share it and store it and post it on the web account pages. They would be retrieving this data was mentioned earlier from their regional phone nodes and or commercial servers that would be passing this data on to them automatically through special software structured by these agencies. It would therefore be a requirement of any commercial server or any provider that acted as a gateway to any government data management for a agency that they be running the agency approved software to be licensed operator Commercial servers e.g. cell phone service, ect.

On page 18 of the Directory listed half way down the page the Federal Department Of Transportation has all it's divisions listed and of course these too would be responsible for the gathering of Data in their traditional way as well as through the inventions (PFN) data transmissions, especially in the interactive highway systems.

However, all agencies record their activities geographically but some don't report their issues and/or activities to the local level and the public is forced to track down this information. Ideally with the local state and national public account web pages on the web, these regional agencies can post local data and issues they have collected and are working on as they prepare their data for reports to the regional or state as well as, national level. Of course there may be a need to pass some of this information through a security protocol program first and then post the data in a clear straight forward manner for the public with FAQ's.

Other areas to retrieve data from the PFN and post data to the Web account pages will be The Department of energy, and all their projects and programs starting on page 9 of this register, ultimately all agencies in their mass data management and storage programs would structure there software to support their representation on the web account pages so they can account to the public for their existence and their activities. And of course the Justice Department starting on page 15 along with all the earlier mentioned FBI programs would be an important part of the spider eyes program in reporting criminal incidences that are under investigation so that the general public can also help locally and nationally in the process to jointly police our society any policing process.

These would be posted locally as described for the San Antonio Police Department, etc. as well as supplied direct FBI regional and national Data for all 4 levels of the web account page) And of course this is a main objective in providing these web account pages to the general public. If the individual is going to be ask to share some of their rights of personal privacy for a better, safer and more informed society than it is only fair play to insure they have as much freedom and security as legally possible to all gathered information and for all gathered information.

FIG. 2B

FIG. 2B is the entire inventions control system from the Primary Focal Node on every piece of equipment to all accounting processes of public government in every agency desired to an accountable presentation of this Data to the public in general via local state and national Accountability Web pages. It is the PFN.MMN.WWW A social economic and environmental technology accounting system for Democratic Government with a responsible free enterprise system.

At the very top of the page is a group of ten icons symbolizing where the PFN's would be utilized. These few representative icons are by no means to be interpreted as the only places that PFN's will be utilized. They are intended to be used in some form on all pieces of equipment and or placed any where it is determined their needs to be monitoring for public safety after meeting any necessary legal requirements for their installation.

PFN's can have more than one purpose e.g. they can be used to bill for service or a particular service of a machine and simultaneously be gathering data on an incident or accident even controlled by off board control systems. In fact, as machine messaging continues to encroach into the vehicle and equipment world the more necessary and easy this inventions Primary Focal Node will be to achieve to govern and organize all these systems. The icons from the top left are trees with a (PFN) box to monitor the environment, weather, air pollution, etc., either sensors or video camera or any number or types of sensing devices. This box is given a squiggly line to indicate a wireless transmission. Once again these monitoring devices are in existence presently, so the invention will add communication to them if they do not have it and return their data in real time to the agencies that are to govern them and any private or commercial operators of this equipment could be given a tax rebate. The agency will then pass the data on to data management for posting, CCing and any proper storage determined by any governing software. The PFN's software will be configured to retrieve the data in an easy to handle format to simplify this process. Part of the accounting system is to be able to support this mass data acquisition system with out breaking anyone group, e.g. the individual, the governments, and or any commercial enterprises. So to be fair and because every action is electronically traceable in the message headers if anyone's vehicle or equipment is used to capture video for the publics business they are credited for the services and if a news or commercial enterprise wishes to use or tap into their systems to show, e.g., a traffic tie-up then they must pay the owner of the vehicle or not use the data gathered unless the owner complies with a request. The owner would be notified if their system was being asked to use its data link for sensors for any commercial request or the owner could call in and offer location viewing to the news agencies. This is done to accurately pay for the advancement of this extraordinarily large monitoring system.

The next icon up on the left is a generating plant and it shows a direct black line going to the commercial servers semi circle. This is a land line phone link and also a squiggly line to indicate a wireless transmission if needed as a back up or more cost effective modality, etc. The invention could list here all the standards for air quality for SO2 point source standards, particle point source standards, NOx point source standards, all the green house gas CO₂, etc. However, there are government agencies and private watchdog groups already involved in monitoring this and they have established standards which can be used as a starting point. The invention will house all the appropriate sensor arrays to detect these toxin or just the “Nose a NASA development along with a communication link to these agencies to insure real-time compliance and report any amount of violation. Much of this data already exist and can be easily prepared for the web account pages.

The next piece of equipment is a bull dozer and most of the time there is a limited amount of construction equipment but because they are forced to work in dusty environments and therefore are incredibly susceptible to clogged air systems which causes an increase in rich unused fuel being partially burned that deliver a great deal of pollutants into the air. Farm equipment as well, is inherently a dusty environment and also these pieces of equipment are in many cases working with food products and should be monitored for toxic fluid loss as well as any storage tank facilities for fuel pesticides and or concentrated fertilizers. Both construction and agriculture will be serviced in the most part by wireless-pagers with small short range fm transceivers and processors as described earlier. The Rf transceiver is for networking all monitored farm equipment to one land line, transceiver where ever possible and the pagers will be used for inexpensive longer transmissions, also this will provide for the repeater function of a short range signal to a long range transmission or telephone communication line, e.g., people locator (Child find). With every land based line so outfitted with a transceiver an emergency network could be developed making every land line part of the repeater net system coupled to all vehicle PFN's. The short range transmitter would have the same one tuning crystal the same as the tot spot system mentioned earlier this would be a specially dedicated frequency by the F.C.C.

Also other crucial Agricultural Data gathered can be sent immediately to the government agencies to monitor and advise the farming area. some GPS systems are employed by Archer Daniel Midland (ADM) for the governing of irrigation and crop monitoring from satellite systems. Along with the equipment and ground monitoring thee systems could be interfaced to return accurate crop data back to the government and to send aid and services to help a farmer or farming district in trouble due to weather or blight ect. When this was done the farmer could be given a tax break with respect to crop investment and loss. Also if the data gathered in a specific area was used for public use or commercial use the farmer could be reimbursed for the access to their electronic gathered data.

The next icon is a factory and depending on how many pieces of equipment and the proximity they are to land lines these pieces of equipment may also only have a short range radio transceiver that is in communication with a secondary node with in the company (land based line) and reports directly to a company control system in which these machines are monitored and recorded for their operations, but can also be provided instructions from plant management directly to their operators or are operated robotically without operators. This in house network system could provide a data link for service contractors and show a history of operational readings which when run through their software diagnostic programs and or those programs owned by the factory would limit the repair choices and suggest the materials needed to effect an appropriate repair. This would be a great time saver and money saver. Also personal calls could be routed to the operator without them having to leave their machine to answer them.

In the material handling industry many robotic order picking systems already exist and converting them to collect emissions data toxic fluid loss as well as gather performance data would be relatively easy. As well as, store the data either on board each PFN or (existing converted remote control systems) which would be able to store data either on board the machine or in the secondary company node or the commercial service company or any government monitoring agency or any or all of the above.

12 O'clock on the drawing there are icons for a boat and a car. The boat would have sensors on all toxic fluids and in the bilge to determine if the fluid had been passed back into the environment. Having the PFN on board would be a great way to increase safety and to know navigation location at all times. In areas where cell phones and beepers were unable to communicate either a satellite or global digital phones might serve as a replacement. And also marine band radios would be used. And in this case the radio receiver station for the coast guard would receive a data link transmission along with any voice with the boats ESN or registry and a full report as to it's mechanical condition along with any SOS broadcast automatically sent or initiated by the boat occupants.

The car icon is very well described in this whole application and is used to describe most all the PFN's properties and qualities in all the other industries.

This is also true for the trucking industry the next icon at 1 O'clock. However, just a moment will be taken to point out that the intense concern for air pollution due to the trucking industry Commonly referred to as the colors of smoke blue, black and white. These smokes could be monitored in real time as well as the charging and paying of all fuel taxes and highway tolls. This could be paid electronically without creating toll plazas and the traffic tie-ups that accompany them. merely have a standard signal sent out by the highway computer that requested every vehicle via short range transceiver to broadcast its ID ESNVIN back or to call it in on a cellular highway node system. The ESNVIN would also have a special tariff smart card number already swiped into the cars PFN which was bought earlier. this national card only pays for tolls and gas or use tax or commercial cards can be used when they are accompanied be encrypted transmission and reception for security. And, of course, for the interactive highways or any smart cars to be a reality for society they will need to process all their remote control instructions through a secure PFN that can record and account for all the robotic actions for any legal decision involving a driver accountability and an automated systems liability.

The railway trains and subways, etc. already have many monitoring systems or networks. These systems would be tied into the all inclusive network system to account for energy use and environmental impact. And they might carry these PFN systems in addition to the ones they use now as a back up or all these systems will be universalized but only be specific as to the jobs they per form. At 2.30 on the drawing there is a picture of an airplane with a radio signal from the plane and a land line signal to the tower. Here pertinent data from the plane could be logged into the MMN from the traditional FAA black box set up to down load on landings and during service or this data could be downloaded as is discussed in servicing equipment in the third application for the automobile. The tower and or airport facility is normally well endowed with environmental and weather sensing equipment and all this data would be also segmented by agency protocols and CC for the proper mass storage and also presented in the public account web pages. Also at 8 o'clock on the MMNWWW local node gate way protocol is a icon for the interactive high way and in most cases this will act as a primary local node to down load any PFN data that is standing ready for data transfer in the PFN Buffer an has been CC to it's PFN's unit storage.

There are in the upper portion of the page, eight concentric semicircles, which are layered protocols established by government standards for the data acquisition into their systems for processing. Their could easily be added more layers and most definitely will, but these eight will suffice to demonstrate how the system will process the data.

The first ring is the commercial communication server and MMN gateway via Land line systems. More and more in the future standard phone systems are going to have faster switching and for any one to operate a commercial node they must have all their phone support lines be Asymmetric Digital Subscriber Lines (ADSL). The second ring in and the first ring provides any emergency service if the PFN did not call or was not able to reach an emergency service phone node for some reason. In this case the commercial server will maintain any and all contact e.g. voice and data links till the customer is served or connected to the emergency personnel, otherwise the second ring can provide any number of services from making web connections to down loading entertainment packages for the board driver. The next three smaller circles are for energy accounting and environment, transportation and traffic, and the criminal incident reporting system.

It is important to remember in all these systems used in the MMN for the most part they are two way capable in communication and definitely all those used in the spider eyes program are two way. This means in the protocol for reporting crime all reports will be time and geographic stamped and will be reported in real time if certain software is triggered in a PFN or local law enforcement will be able to remotely activate any number of vehicles or PFN's they have recent reports from or any that are in use and giving out a signal to a local cell so that law enforcement can activate cameras and appraise an area in which they have just received an incident reported. Of course all these protocols have to be approved by the public and decide on how the billing will be assigned and credited.

The voting node allows for the public with their special pin Id to vote on the road or in the home. Originally first to respond to issues as they drive home to let their representatives know how they feel on the issues that are at hand. They can view them in their cars on LCD screens or see by hologram wind shields, and hear data delivered by voice. (Not Radio) This system would be developed to sanction a vote with a positive finger print ID and or an accompanying pin code. Also a driver could send a voice mail that coverts to a written message to address an issue on, e.g., area roads and specific conditions.

The two inner circles will be a continual running account of commercial and public cost and gains so an area can judge how well it is doing and also to determine where best to invent or create its finances and use its resources. This data would primarily be gathered over land lines and this accounting system could be used to make cases commercially to communities to lower taxes or provide support aid in a lean time or help to retrain workers in an eventual lay off. This is not the way business is done to day but it should and could provide a better way of life without stress for all in the future. Business would learn it's local community can help guarantee its survival even if it has to change the way it is doing business.

The inner center of the top semi circle is local government and all the way down through the center of the drawing is government with three pegs interlocking the local government the state government and the national government with the local account web pages that are displayed as local, state, national and international web pages. The pegs have letters in them and they spell out REPS for representative or the elected officials. With the public much more interactive with government at all three levels; all officials in all three levels of government will have to become much more interactive on all the issues and this is why reps is spelled out interlocking the levels of government as another medium by which decisions will be condensed and justified to the public. Basically the objective here is to integrate the process of individual power and responsibility for any one representative to be directly responsible to the empowerment structure held by the public individually.

At 3 O'clock in the center is the state government and below that the national government which are inter locked with the mass data management and storage network. To the left side of the system is data input for the state and the federal government. All the eight semicircles feed data that is presented to all citizens in the same manner unless security protocols have dictated a different path. The two inner circles provide in real-time the financial cost and gains and representatives and citizens can view this information and the representatives can make policy on taxing or crediting back or providing aid and the rest of the public will have the opportunity to completely see this transaction and voice there opinion in real time.

In between each section of government is an accounting process all the way to the federal banking commission. All the data is accounted for so that the financial and economical controls can be better balanced to meet the needs to provide for its society while stimulating growth.

The lower section semi circle is the delivery of data to the web account pages with government numbers on money spent and received locally, in the state, and nationally, Stock reports and financial reports on the local commercial companies, the regional companies and corporations, and the national and world stock markets.

In the bottom semicircle there are four web account pages that anyone can access from commercial servers communication data links, the world wide web or mass media. Most all of these support response back systems even cable TV with a web box, although there is still a lot of problems getting service to all citizens so access could would and should be provided at any responsive PFN that supports a video display. And in public places as well like police departments and libraries. The four web pages would list issues plainly for the public to view and respond to. And their would be a section to frame issues in which the public could start a question. Also there would be a Yeah and Nay section on issues that were up for a representative vote. Also, there would be data given on the environment, the highway systems, the recent crime and much more vital information. This would be determined by the issues and events that were current first and then anyone, who wished to have data to explore their theories, e.g., on global warming would have at their finger tips all the data and expert opinion as well as an auto tutor to learn understand and relate their informed opinion back to the rest of the world.

The figures from left to right at the bottom of the page are agriculture being remotely controlled. The highway systems being monitored and ultimately remotely controlled, The car is receiving remote service and the house being monitored and for it's energy use. The computer is a web access, the tv at 6 o'clock is mass media with a web response box. The factory can review all that is on the web as to the public opinion and government policy and the world receives all the data from every where and all the world populous can see how the planet and the other humans are faring around the world. And for this to take place all the national governments agencies must clear the data to be freely posted. Well at least they can start some of this.

FIG. 3

FIG. 3 displays two variations on the billing box accrediting system and the credit card devices and phone devices that have been innovated for these purposes. Primarily the billing box was designed to be an add on unit or aftermarket device to collect a fee for use of a vehicle, e.g. rental cars, Taxi Cabs, buses, ect. Part 301 is either a standard credit card, ID card or any other information card that one wishes to use to enter information to the billing box (PFN). However with the price of the smart cards being greatly reduced this device is not just designed for the regular magnetic strip cards as has been described earlier but is designed to stay current with the more sophisticated cards, as well as evolve to other recognition systems e.g finger print and voice and pupil identification systems. Of course the data retrieved from these magnetic cards can be recorded on board in the billing PFN as well as transmitted back to any network gate that can make the necessary land line connection to any credit check procedure and mass management storage for accounting purposes and records. And when this is done through a Billing box or PFN system it is a commercial service product of the invention.

Part 302 is the regular or standard cell phone handset that if it is in use the lower bill box could be configured with out a key pad. Part 303 is a standard key pad format that can be used to communicate with the bill box when connected and interfaced with any the invention's computer and supported with the proper interfaces and software and or firm ware. Part 304 is a multibus bar connector universal with 29 contacts so that it can support any system/device entered into the bill box. These were earlier designs. And this earlier design will probably not be used and will be replace by the multi bus system IEEE1394 or the universal bus and or IrDA interface.

Part 305 is a quick connect end on one portion that will make a pigtail to connect with any combination of electrical connectors on the other end of this second portion, e.g., computers, any electronic connections, radio or automobile, but in this case is depicted in the drawing as RS232 part number 306. The other short pigtail is part number 305, there may be 5 to 10 in quantity, that can slide easily back and forth to allow many varied positions for the different devices and the space they require. All hardwired connections could be made with Commercial Off the Shelf devices in the box or by infrared corn port connections. A segmented infrared bar can be aligned to any device's infrared window to communicate with the invention's control circuits. Also there are varied but designated power connections to supply power to any device by priority. Once again most all devices presently will be configured to IEEE1394 USB connections and have the drivers and software supplied by the manufactures to quickly install almost any desired system as easy as buying a product peripheral for a personal computer. This is one of the main reasons for the timely presentation of the invention

After the devices are installed and connected, foam pad shims are placed between the different devices to quickly secure them in a protected stationary position. The dotted lines show adjustable bin space for the user to plan their own devices. Part 307 is a mouse ball that one can use to run window type graphic programs either displayed in the unit display 308 and/or any larger display within the field of view for the driver, either LCD vacuum tubes e.g. VGA flat screen, or the new hologram wind screen in the newer cars (e.g., Pontiac Grand Prix). Part 308 is the unit display, part 309 is an emergency power pack, and part 310 is the secure bill box.

The structure of the box has been described in the best mode of carrying out the invention as to it's wall structure and insulative characteristics and will be modified and or configured in many different shapes and sizes if necessary, however an attempt to standardize all boxes in their categories will be a main consideration in the commercial development of the invention.

FIG. 3a

FIG. 3a is a interior block diagram as to how a card swipe or card swipe cell phone would be connected to one of the billing box or PFN computers and would then process the magnetic data stored on a card through the software provided by the card swipe manufacturers, as well as any credit card company proprietary security software used by the PFN computer. An electronic signal with a preprogramed dial up number to a credit card approval service company with any proprietary software to process the data in the remote location would be partially and or either held on the card or in the PFN software package depending on the type of cards and devices chosen to complete this remote billing and payment procedure, e.g., smart cards vs. regular cards, etc.

This data because, in most cases will require a radio transmission should be sent as an encrypted algorithm to protect against any criminal hackers pirating legitimate credit card information out of the airways. Most credit card strip reader manufacturers design them to meet standards and protocols such as ISO 7811, 7811/1˜6 and or comply with DMV format for driver licences. They are also all CE, FCC, UL, cUL certified. These devices were all discussed earlier in the devices that could be interfaced with the PFN's as peripherals section of this application to provide mobile remote services.

It is important to understand this mobile paying function of the billing box currently shown in FIG. 3 as a add on devices for cabs, limo's, automated rental equipment and vehicles, etc. is only the aftermarket version of the PFN's total function to provide a means to pay for equipment use and any and all services surrounding vehicle and equipment use commercially. This card swipe is another peripheral that will be on all manufacture vehicles in time as part of any PFN's to allow for a vehicle\equipment operator to pay for any use fees, uncontested tickets, or to log driver licence information, and or pay energy fees immediately, rather than having to stop the vehicle to stay current monetarily for use of the vehicle or services. They can card swipe at any time, either while taking on any energy provisions or at any convenient time in the comfort of their vehicle out of the elements while using the equipment/vehicle simultaneously.

As was mentioned earlier personal identification equipment e.g., fingerprinting, pupillary ID, voice recognition, pin number from key\number pad, ID trans mission bracelets, etc used as either additional ID conformation peripheral systems or a future primary personal ID credit device component to a remote or PFN personal credit data storage accounting system will be connected and interfaced in the same manner as illustrated in FIG. 3a. Or these systems will employ any of the interface technology shown in FIG. 7. In the case of the transmission bracelets of course the on board PFN universal RF receiver section will receive the signal and have a serial data conditioning of the signal encoder or this will be a function of the PFN computer processor and software through a special IC decoder\encoder card part of the computer hardware.

Also for security the transmitted data will be recorded in the PFN memory systems e.g., hard drives, buffers or flash memory devices or MO drives or CD write drives, etc. as well as any remote location credit data management and storage system. Accompanying the credit data and amount request will be the ESNVIN number of the sending PFN along with time date and locator coordinates for the billing, charging, ticketing and acceptance of as well as any acceptance criterion for these transactions. e.g. electronic signature or hard copies generated by on board printers etc. which are turned in with a transfer of memory at the end of a shift or use of a vehicle or service In drawing 3a 302 is a cell phone that can either be inside the billing box or outside and only electronically connected. 302 here is out fitted with a card swipe slot that can read the magnet IC strip of a credit card or a driver ID, etc. There are two electrical connection shown coming from the special cell phone 320 and 321. 320 goes to a PCMCIA modem to support data communication by a cellular phone for the PFN computer. (these actual connectors can be serial RS232 connections or IC cards configured into the PFN computer hardware mother board, euroboard or done with edge ribbon connectors etc. 321 illustrates a direct connection if the special cellular phone is already out fitted for data delivery in its circuitry and therefore would connect directly with the computers RS232 with a mere cable or utilize the new 1394 universal bus system or utilize any connection to handle TTL or the standard serial port PS2. For this multi tasking phone to both send and receive data through the cellular system and to process the digital data retrieved from the magnetic strip a function switch will send a firmware stored signal to the PFN to process and store the card swipe data in it's hard drive if on board or in it's processor buffer to be retrieved and sent via the PCMCIA modem to the cell phone and to the remote location. As stated earlier this function could be manually contrived with the button first processing and then in another position sending it as data through the cellular protocol. Or this data could be performed through soft ware commands stored on the card and PFN or even in the cell phones firmware e.g. D-WAVE phone protocol from Sony and its multitasking capability out fitted with a card swipe. 301 is a plain card swipe possibly one of the ACETEK series mentioned earlier as this invention's experimental prototype products. It connects directly to the PFN computer either serial PS2, RS232, or simple transistor to transistor logic TTL. 306a merely depicts these interface options as well as shows the special cellular phone could supply its card data in this manner in one modality. 311 is a PFN computer and is one ideally with at least a 386 processor as was described in the processor and computer section of the PFN's described earlier. 311 would also be programmed with all the necessary and proprietary software to complete these security billing procedures. In the lower left corner of 311 is a small square with the letter [B] this stands for buffer or hard drive in the PFN computer.

The number 319 has lines that go to the little square [B] on 311 and to the horizontal square to the left. The horizontal memory square is additional memory to keep a record of credit tans action most probably done with Sony memory sticks, how ever any of the memory systems described could be utilized and then erased by the proper procedures after any reasonable tie had past on questionable charge entries.

323 with a lighting symbol signifies a wireless cellular signal conditioning device for data transmission to and from PC's. [PCMCIA] in a square. 313 is a two way data modulator for any RF transmitters, receivers, or transmitters, used to down load data from the PFN or in this case the card swipe protocol to a remote location or gateway, etc. 314 is a two way Motorola reflex protocol to down load data to a remote location. (this would involve PFN software that could break up the data into 20 bit segments and transmit the data to a remote location that could reconstitute any lengthy multiple transmission into a complete secure text transmission if it is determined necessary to develop a secure algorithmic protocol for credit card data transfers. However Motorola is very protective of these transmission signal protocols already and this might prove a secure system if practically capable of handling the quantity of data in any commercial transaction.

All these different data communication pathways are being discussed presently for the use of the card swipe billing to demonstrate the connectability of all the previously described peripherals and to demonstrate to anyone skilled in the art the ease, feasibility, practicality and obvious reasonable development of this inventions interfaces to organize and control the process to combine all types of communication e.g. wireless, and land based, into a protected focal center that is capable of processing and controlling, recording reporting and billing for the use of equipment and related services in an accountable modality or protocol.

322 is a new product that adds so much to ease interfacing of cellular technology to the PFN and that is why it is mentioned here directly. It is a complete data hook up of modem transceiver and antenna with a PCMCIA III connectability to any of the PFN computers. The last square is a standard telephone data modem for computer data transfer, the little circled (H) stands for hard wired to land phone lines; and is listed hear to demonstrate that the PFN will be used with stationary equipment as well as mobile equipment and vehicles to value use and service related to use as well. 318 shows the connectability of all these data conditioning and transmission devices described above and in FIG. 7 and within this application and all related applications. 318 also shows that the memory 319 will store any crucial down loaded data to a remote location on board the PFN as well.

315 is a pager receiving station, 316 is a cellular phone receiving station, and 317 is a radio frequency station and these are all wireless to land based phone node systems, they can be gateways or they can provide wireless communication through standard ISDN phone lines to secondary commercial, private or public entities that perform gateway functions, accounting services and or monitoring and or remote control function to a vehicle\equipment or any multitude of net work services as shown for all three wireless communication modalities in drawing 3a. However, one important note to remember is that the listing of these commercial, governmental public and or private functions and services listed in FIG. 3a under each of these wireless modalities is in no way confining to a specific wireless modality. These services could function in any one of these wireless modalities and, in fact, use a multitude of them. Some of the services named here do not relate solely to the car swipe system functions either. Drawing 3 a demonstrates and drawing 7 explain how all the peripherals are to be interfaced and the functions named for the three wireless modalities serve only as a space to reiterate all these vast functions that the PFN will be capable of though all it's networked devices. This entire document and related applications detail all the peripherals and their interfaces which fall within the claims of this invention. And the mere fact that some service is not mentioned by name in this application or any of the related application does it mean that it is excluded from the claims which make up the nature and scope claim of accountability as it relates to any vehicle/equipment use, abuse, unauthorized use and or any related services provided for any use or in equating any abuse or damage of a vehicle or piece of equipment, person or property.

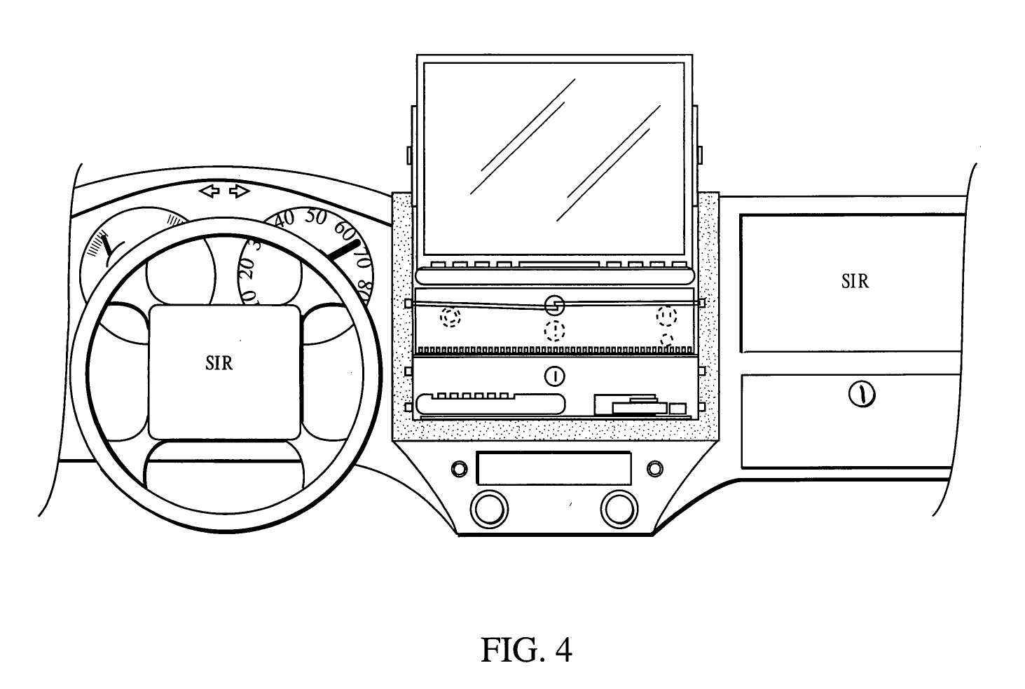

FIG. 4

Shows a picture of a dash board in a traditional sedan. Just right of the dash is the PFN and it is depicted as a box with a personal computer slid all the way out of the containment with the lid or screen display opened so that the driver could use the computer screen with a GPS system like DeLorme running to receive automated directions to an address he was unfamiliar with. Below the computer and the secure lock up center section rests a cellular phone that has its phone modem connector coupled to the heal of the phone and directly to the right is a second communication device a pager that is also coupled to an optical scanner in this case as was described in the first patent. The lock up in the center can house permanent invention computers and storage records plus GPS and any communication devices that are desired on the vehicle all the time, This lock up section is only accessible by authorized personnel in the most ideal situation and hopefully mandated by law. This section would house the PFN invention computers and in the place of an on board personal computer their would be an LCD screen that could display map graphics if need be, through the on board computer systems.

This is only one basic configuration for a PFN and the system could be rearranged in any number of ways.

Now for a more specific parts description of the individual parts numbered. The square boarder with circles inside is the walls of the PFN case. 401 is the outer metal case plate which can be up to 3/16″ thick made out of AR metal plate to resist penetration or drilling. 402 is the inner metal plate up to a ⅛ ″ thick and it is made of the same AR plate. 403 is an insulating product and their is two that are being used to construct the prototypes. One is “solid smoke” a product developed for the space shuttle and “Geobond” a gupsum product. None of these products or specifications should be considered the only way to create a secure PFN containment to fulfill any part of the nature and scope of this invention. The thickness of 403 the insulating section would not exceed ⅜″. 404 represents one kind of lock cylinder like those used in safety deposit boxes, however, not made of a soft metal like brass. From 404 can be seen two flat bars that go out past the inner plate 402 where they pass through a solenoid catch mechanism that when it is deenergized will not allow the bars to pass out of the front edge of the encasement. 404 in the center can also be opend manually with a key. once again their are many manual and or electrically automated locking devices that could be utized for this same purpose.

In FIG. 4, 404 is displaying the bottom compartments access panel swung open on a piano hinge part number 406. So the view is displaying the back of the panel so bars can be seen and that is why they are depicted as solid lines. Behind 404 lies the secured section which is represented with dotted circles because they are located in back of the bottom access panel in the open position. If the center section is the designated section to handle or store the legal storage electrical components it will not have an electric lock release or it will be disconnected to only allow for the proper authorities to remove this data or component parts. 405 is the bottom access door in the closed position and that is why the bars are depicted in dotted lines. Once again 406 is a piano hinge and is a part on each of the three sections as a point of articulation for the panel door. 407 is the standard glove box that can either be used or discontinued to allow for other rerouted accessories HVAC vent, ducting and planums or blowers motors, etc. 408 is the SIR compartment which is the sudden impact restraint or the Air bag.

With on board distance sensing for front and rear as well as even side surveillance of the environment any impending impact would be sensed and automatically with draw any opened draws in use into the containment which would allow the aesthetic skin panel/drink holding table to spring return to a closed position. If the drinks were in the table with the table in the down position all 3 access panel doors would be closed and secured. this would be accomplished by electric servo motors or vacuum motors or cylinders or diaphragm systems for speed. Also the electric cylinders could be used, e.g., “Memory metal cylinders”. At no time would the center section or a part of the center section be open to the cabin during operation as this is the protected black box storage area. Of course these configurations are flexible and the designs can very greatly, but when a permanent area is chosen it has to remain inaccessible till the proper authorized personnel supervise any reconfiguration, e.g., certified service personnel that have to enter their service identity credentials. Otherwise a customers insurance company must do the same or support clerical personnel for the police or department of motor vehicles.

410 is the pager as earlier described with a scanner on the front however any interface and connector system could be employed in the PFN. Also Motorola pager processor “Createalink could be utilized here and even as an effective processor in the center section that is closed for the ultimate secure service functions as another C.O.T.S. computer communication combination for the inventions control center. 411 is the standard cell phone with 409 depicting a connector modem, which will be wired through the trays to any on board computer to receive and transmit data to any system in the PFN or connected to it. 412 is a specialized tray connector made by or for the personal laptop computer that will provide all or any of the desired physical connections to interface the computer to the host vehicle or any other peripherals or to net work it with any other computers. The holding and securing tray will then couple to the sliding either motorized or powered by vacuum. And so the electrical connections to be functional here it will have a controlled flex cable to 503 the central buss channel or canaleta or race way where it will route wiring up and down inside the containment.

FIG. 5

FIG. 5 shows two views of the secure box for the PFN in the Dash. The top view is of the back of the box cut off so the components can be viewed. The top shelf is showing a laptop with all its varied connections that have a preformed shelf designed to supply the necessary connections directly to the laptop connectors. There also is a tube or channel part 503 running from top to bottom in the back of the case in which all the shelf connecting leads are channeled together and all the appropriate connections have been secured to the devices in their shelved trays. This same tube works as an antenna galley and channel to house the control buss of wires to the out side of the secured and protected PFN. These wires are protected in a armored flex cable like the one described in the first patent for the protected beeper.

When 503 doubles also as a antenna galley in the back of the PFN and for the full height of the containment the outer metal plate part 401 is replaced with a strip of Amoco's poly-sulfone thermal plastic ½″ thick 1 and 1\2 ″ wide strip which runs the height of the box some 9 to 10 inches long. This thermal window is provided in the back of the PFN to make it very difficult for anyone to tamper with these vital circuits and to also allow for a signal to be received when the C.O.T.S. products patch antennas are not sufficient and they have provided for an external antenna hook up. And as also mentioned earlier there is another option to provide for reception in the protected containment to receive any necessary signals through using the same poly-sulfone product and creating port holes for the necessary signals to enter into the protected containment to reach the standard C.O.T.S. antennas e.g. patch type, but also provide protection from heat and fire. And of course these port holes would be located in hard to reach areas.

The bottom box illustrated in FIG. 5 is showing the lock access panel doors with a piano hinge 406 for this sturdy structure This ⅛″ thick access door is made out of stainless steel and numbered 510 in FIG. 5. As mentioned earlier along with adding an additional way, the access doors 510 can be opened in three different ways, one with a key in two places as displayed in FIG. 5, another as described in FIG. 4 with the throw bars out to the electric solenoid catch mechanisms and there by finally opened by electric solenoid release triggered from the inside program software of the inventions on board controllers which is reliably energized by the emergency batteries inside the PFN. The two key system would also have the same solenoid lock release system.

These access doors and locks are finally covered by an upholstered and padded dash plate/drink holding table numbered 507 which is illustrated in the down and open position and appears as the end view of this dash plate/drink table. The front is molded and formed to create a uniform appearance to the dash board. This aesthetic dash front may be constructed by covering the compartment panels with cushioning and upholstery and not having the drink top dash panel.

However, 501 represents a molded rubber gasket that is grooved to accept the dash plate/drink table in the closed position. 502 is the two sided lock placement cylinders if this type of lock system is employed. And 511 depicts the electric latch plate and solenoid assembly that receives the lock bolts from the keyed cylinders. 505 is another piano swing hinge for the table/dash cover plate. 504 is a coiled spring that returns the dash plate when all the drawers and or trays are retracted. 506 is a shelf roller that can be slid into any number of slots in many places of 402 the inner wall of the box. These slots will either accept a tee ended fastener that supports these shelf casters or rollers or it will allow a compartment plate or separating partition wall to be slid down the slot. These compartment shelves or rollers can be moved or exchanged to create any number of configurations, however, the trays will be standardized to certain sizes that will be customized by the manufactures to accommodate their products. These separating plates have lock blocks that have drillings with 10/32″ screws that will thread into tapped receiving holes in 402 the inner wall. 508 in one of these partitions. 506 the rollers have a screw that can be tightened to clamp the tee device against the inner wall skin-part 402. 412 is the personal lap top in the top shelf. 509 is the trays that ride on the rollers. these trays presently are designed to either be half the size of the PFN or to go all the way across the containment. This is not the only design for the movable trays and adjustable flat compartments and should not be considered so, but this design is being prototyped presently. Any protected containment or interface that is structured to coordinate and control remote functions on a machine all fall within the nature and scope of the invention.

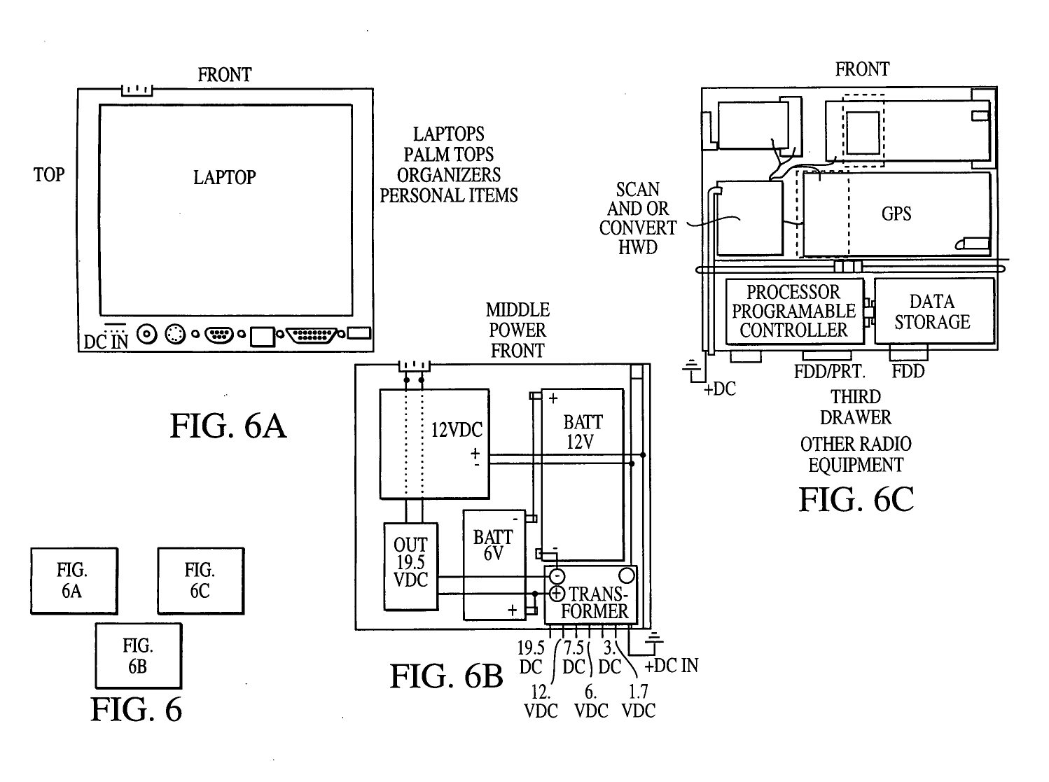

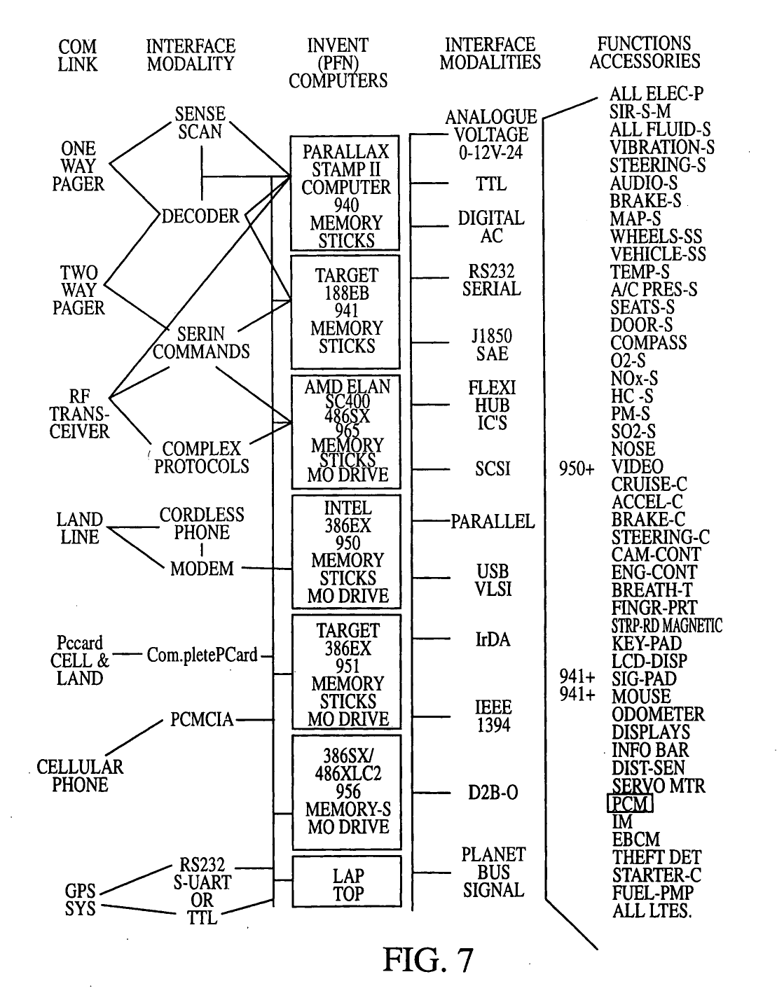

FIG. 6

Depicts 3 possible drawers configurations for a possible application of the secure box and the PFN equipment. The top draw houses the laptop computer 412, the bottom draw houses the power pack batteries 601 and 602, the transformer 613 and the inverter 603 along with power supplies that are varied power taps 617 for the C.O.T.S. products housed in the PFN. And the center drawer houses all the essentials to complete the necessary function for the PFN. It has a GPS 616, A Cell Phone 605 a Pager 609 and a small PFN computer or controller 611 and a data storage MO disk drive or memory sticks 612. With the drawers and compartments 12.5×12.5×3″ all components easily fit into the three drawers.

The top drawer 614 is showing the multiple fittings that would be molded into the tray and not visible as a end view but instead as a top or side view. In most cases the manufacture would not have to outfit a tray and probably would not do so for all the possible connections for the laptop. However they are shown here and mentioned as all being possible. Reading from left to right the first connection would be for 14.vdc as a power input for the computer and is supplied by the bottom shelf tray from part 614. On the top shelf again the next round circle to the right of the DC power connector icon the PS2 mouse or keyboard connection for an external mouse or GPS 616 connection in some cases. The next comport is a 9 pin serial port and the following one is a 9 hole additional monitor port. Then the little square is the infrared communication port, and the very next one is a parallel printer port 25 hole LPT1 port and the last one on the left is the a USB communication port and most likely the one that will be used with any peripheral hook ups in the box, however any of these connections might be used for any number of interface connections and it is possible that a laptop manufacture or secondary provider for the trays may outfit any and or all the communication ports with a service connector in the tray. Ideally the placement into the tray or cartridge that is affixed to the rollers and rolls it self or is placed on a shelf and does so. In any case the tray or cartridge for any peripheral will instantly plug up to the laptop or other device when placed and secured in it. This would replace any need for thumb screws to complete any required secured connecting unions. And would accomplish a plug and play modality for rapid deployment into a PFN's electronic array of accessories as a compliment to the full complement of the inventions electronic devices and innovations. These have been detailed earlier and their exact configuration will depend on how much the OEM of the host machine will provide in their PCM or accessories. But as was illustrated earlier the components to provide all the stated services are available through the inventions technology if need be.

The bottom shelf or power tray as designed for this prototype will have two batteries one a 12vdc part number 602 and a 6vdc part no. 601 and these two batteries are wired in series to create 18 volts, which is wired into the primary windings of the transformer 613 that provides multiple current level taps or solid state regulated chip circuits to energize all the varied C.O.T.S. products in the PFN. These prototype voltages are 1.5 vdc, 3.vdc, 6 vdc, 7.5 vdc, 12 vdc, 14.5 vdc. 18-19.5 vdc and also because in many cases people will enjoy being able to plug their computers right in 604 is provided as a transformer and rectifier or converter and tied directly to the primary coil of the transformer 613, 604 receives it's power from a 120 vac circuit that is created from the host vehicles 12 vdc supply of 6 amps and the PFN battery pack energizing an inverter of 250 watts, which also supplies 120vac to a plug prt.#617 in the front stainless steel access plate for other devices that people might need 120 volts AC. e.g. small heating blanket, coffee pot and/or hair dryer

In the second draw 607,608,617 are OCR optical character recognition scanning devices and they are wired to a micro processor so that the unique digital signal from a scanned alpha-numeric image on any and all of the devices that have LCD displays, e.g., GPS, cellphone, pager and respond to any appropriately addressed message with the proper preprogrammed response as described in the first application.

This scanning interface is only one example most all the of these COTS devices have their own interfaces to allow them to communicate with any onboard computer they are connected to, e.g., serial or TTL, etc. And any of the IC components would be all part of a circuit if it was in the secure lock up as a mandated circuit function by law. 606 is a connector for a cellular phone. and on the back of the tray are a number of different sockets for data transfer cables to the 503 wire race or cable channel that goes from top to bottom in the containment.

In the back of the middle drawer part number 615 indicate a lock partition wall in this prototype and behind this wall is where the PFN controller/computer 611 is along with its' data storage system 612

FIG. 7

Shows all the basic components of the PFN and all the options to interface them. The communication links are all listed in the left column and they are as follows: the One-way pager, two-way pager ReFlex, any number of different radio transceivers for long and short range, land line phones, special cell PCMCIA card phone, and land line modem for computers, cellular phones and GPS system. The next column the second column and the fourth column are interface modalities to link the communication devices and all the functions and accessories to the 6 types of computer interfaces that are used by the PFN and the personal lap tops that a person may wish to have on board and interface with their PFN. In this second column, there is, sensing or scanning which is described in the first patent for the one way pager. Also, decoding and encoding is a possible modality to retrieve POSAC or alpha numeric messages through either hard wiring or the above mentioned scanning system. The hard wiring serial input commands and or any digital signal commands in the case of using Motorola's ReFlex protocols would be interfaced with the PFN computer or any other desired computer. This data transferred would be converted to a format that the computers were preprogrammed and had firmware and software to process it in an explicit manner with respect to Motorola's protected protocols. Or it could be used in the most simplistic fashion just as sensed current on one of the I/O pins of a micro controller or serial input on the more complex systems computers to activate a preprogram task in response to a current or specific signal presence. If through a small microprocessor and accompanying circuit a specific signal can be recognized and be predictable through a specific phone tone dial up for the ReFlex protocols, then it would be possible to do more sophisticated functions with the coded messages. This invention will seek out a cooperative relationship with the makers of the ReFlex pager technology Motorola in order to incorporate this pager into the protected PFN's. protocols

RF transceivers for all types of radios either transceivers or just receivers that can be used in the invention either as the primary communication link to a gate way node or those used in the earlier described repeater function which would be used for short range transmission and then their message or signal would be boosted or repeated to the gate way node via the longer rang communication systems on board. These radio transmissions would interface with the computers via serial input digital signal whether they were a digital signal or passed through a ADC analogue to digital converter chip, or they might have there own complex protocols already provided by the manufactures of the radio equipment.

Remotely Control/Shut Down Vehicle and Police Control Vehicle

There are also plans to modify a standard car FM radio or receiver with a short range FM receiver which also has a micro processor to recognize an appropriate request signal received from a police cruiser via this modified car radio which is always on but in sleeper mode checking for a police request. And this police request will first turn on an indicator lite on all cars that receive the police request and simultaneously (if in a second generation of this invention will activate a short range fm trans mission either part of the standard radio or part of some other on board system which will in turn down load the ESNVIN and registration data to the police cruiser's computer for the cruiser's software to only display each signal data received once. And then the officer can determine the vehicle he wishes to remotely shut down. Provided of course all the devices are on board to do so. Also when the signal is received by the police cruiser a specific electronic or digital address for the specific vehicle transmitting their information to the cruiser is also transmitted. And then the officer can talk through the suspect vehicle radio on a isolated set of frequencies and ask the car to pull over after already having checked the registration ect. There is also a prototype planned to due the shut down or any part of this process with a laser light communication system or other short range transmissions devices as explained earlier in the best mode of carrying out the invention. and the other three related patents.

Land line hook ups will be connected to the standard modem products on the market to modulate and demodulate any signal transmitted over the land line based phone systems which are constantly improving their switching to handle more data and digital transmission.

Cordless Modem Interface Product for PFN Data Transfers

The cordless phone that is outfitted with the standard j-11 phone plug in the hand held receiver also uses the standard modem. The experimental cordless phone data transfer have been using the 900 mhz phones. Transmission has to be slow due to band width but with a compression/decompression of digital signals done in the base station of the cordless phone and in the hand held receiver this can be remedied. The most obvious solution would be to use the compression decompression digital chips used by the paging industry with reconfigured firmware burned into condition the signal for standard phone data transmissions that will be compatible with the standard modems. However this cordless phone connection has worked when connected up and transferring data at 2400 baud with no signal conditioning. It might handle higher but a chip should be put in the base station portion of the cordless phone with hand shake data to quickly state the band width limits of the cordless transfer to the contacted computer. These would be very simple modifications for a cordless phone manufacture that increases the convenience for laptop owners to check E-mail etc. without a land line socket, e.g., check E-mail from the patio, and could even be used for manufactures to check their smart chips in appliances remotely over the phone to diagnose product failures and give customer advice for parts or customer service.

Just Outfit the Module Chip Modem with a J-11 Phone Jack

The next interface discussed is a complete product that the invention plans to incorporate to interface all cellular functions to any of it's computers. It is the Complete PC card which allows for land line and cellular interfacing and this will be hardwired via a PCMCIA socket on any of the PFN computers and this is already set up for laptop's.

Of course the PCMCIA cards are available with cables to connect cell phones up for digital transfer to computers and these have been all detailed in this application and prior applications.

The GPS system will either be in a on board chipset that will send its information by request or triggered latches in TTL back to the system requesting earth coordinates thru Serial UART connections or RS232 connections.

The next column is all PFN computers from the simplest the parallax StampII, which is prototyped presently as the stopbox and record system shutdown device to the most complex that will support digital imaging and full video applications if so desired. This section also has the memory and on board storage systems. These products were already detailed earlier.

Before moving on to show the versatility of the PFN computer systems this is a small list of the peripherals that are available to support any desired functions for any industry need. The AIM104-motion-1-a motor controller the AIM104-Video-video capture board-Aim104 VGA LCD-3-Super VGA flat panel and CRT Module. The Aim 104-CAN OptoIsolated CAN interface module, the AIM 104-ser4 4 channel serial communications. And the rest will be just listed as their part module numbers without descriptions but it is important to under stand that with this modular capability on the 5 more sophisticated PFN computers that all functions and capabilities exist and are demonstrated to drive and manage any peripherals needed in any industry to fulfill the claim to monitor control report back and store data in multiple locations and for all kinds of data mediums desired by any software program. The remaining modules to augment the computer systems are: AIM104-ser4, AIM104-IN16, AIM104-1032, AIM-MULTH-IO, AIM104-RTC, AIM 104-ADC16/1N8, AIM104-VGA-CRT AIM104-DAC2/IN8, AIM104-ETHER AIM104-KEYDISP, AIM-OUT16, AIM104-PULSE. All of these modules can be interfaced directly to the computers via PC/104 interface with deep mating buss connectors. and these circuits are credit card in size.

The next interface modality column has been set up to closely relate to the host vehicle peripherals or function accessories they can best service with most any of the computers listed. For the most part on this chart everything moves from side to the center to the sides with the center computer column receiving data and issuing commands or storing or reporting data as prescribed by its software commands. Their are many variations possible with all the computers available and the interfaces available, as a general rule, for the best combinations of communications with controllers circuits and the best combinations with their interfaces to the peripherals that they can support they are across the page form each other. But their is a wide variety of all that is listed here that is compatible and will function well together and that is why figure seven is designed this way to display this versatility. These two last columns the interfaces and the functions have been detailed already here in other sections of this application and also in the other two related filings.

Note: Once again no specific readings of any environmental sensors are given in these documents or set up for software parameters triggers or latches to record or report a reading even though their are many standards that already exist today. This is a question to be answered by the authorities and decided on as to whether they want warning levels and what criteria will be in place for this protocol. They will of course be determined and be place in any PFN software to perform the monitoring and reporting function this technology has be en designed to do.

Note: With this in mind the invention is being commercialized by constantly surveying in a deliberative process all or as much of society as to the proper use and what constitutes abuse of the invention as to how this technology will be prototyped and commercialized. This survey process is for determining the public and commercial, interest and concerns as well as address any government and legal regulations and laws and help to guide the correct pathway of controls for society's equipment. This will be a process that will be on going into the future as has been described and will be applied as the invention is licensed to be commercialized.

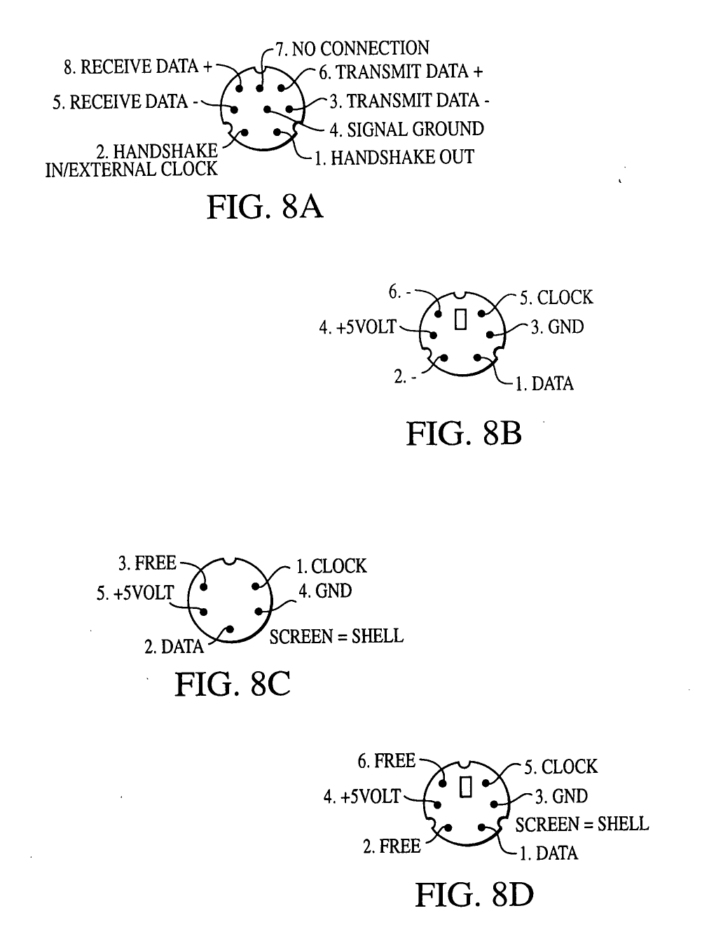

FIG. 8

This drawing shows the standard Mac 8 pin serial port in the top left hand corner and the pins are designated as to their functions. The lower left shows the PC standard digital input connector and below the illustration is a box chart with the pin numbers and the functions. In the upper right hand corner is the standard PS/2 mouse function connection and below the PS2 mouse connection is the Pin functions description chart as well. And in the lower right hand corner of FIG. 8 is a PS/2 illustrated as a Keyboard connection along with it's pin function chart.

Many peripherals such as video systems or digital cameras use either combinations of the serial port and the mouse or keyboard connections if they are not equipped with the latest USB connectors IEEE 1394. Also the key board connection is a standard way to add the card swipe systems to all PFN computers without having to hard wire and solder connections. This will be an advantage to Cab companies buying regular vehicles and just plugging in devices in a PFN that are easy to plug in to the PFN for immediate use.

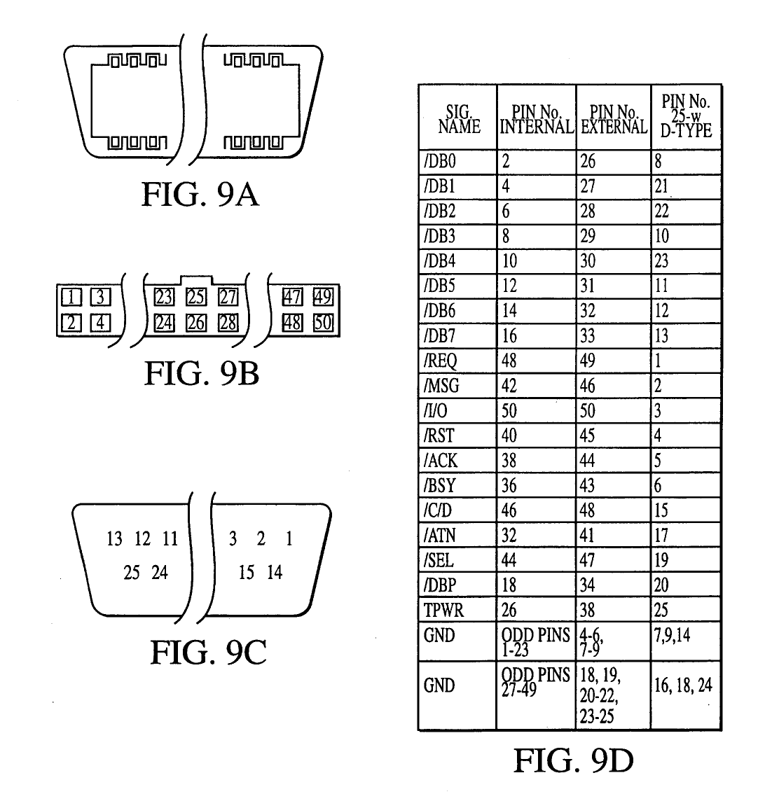

FIG. 9

FIG. 9 is a continuation of the hardware connectors that will find use in the PFN to accommodate backward technologies. This first version of the SCSI-I connector is a Groan 50 way female delta connector and it is an external connector. Because of the large amount of pin connections the connector is displayed as if the center section has been removed.

Just below the external SCSI-I connector in drawing 9 is an internal 50 way ribbon connector with two mid sections removed left and right of the center orientation notch for space saving reasons in this drawing. Any internal linking of video cards, ect. can be achieved in this fashion inside the secure PFN. However most of this would be done for experimental prototyping or add on of C.O.T.S. products or to meet backward engineering requirements as their are many types of integrated circuits and socket pin connectors for add on peripherals for internal applications PC 104 protocols ect. and euroboards as earlier discussed.

At the very bottom of the page is a PC SCSI 25 way female D connector used by Macintosh. These different connectors are displayed and chosen because of how certain prototypes are going to be linked to other C.O.T.S. products and rapidly connected. However any number of connectors could be utilized or integrated circuits could be interfaced with even solid soldered connections.

On the right side of the page the pin numbers are given in a chart for all three types of SCSI connectors displayed and their functions are labeled.

Most of the SCSI and parallel ports are needed to support the video and graphic applications of the past and therefore are displayed and are going to be used in some circumstances, However there are far better connectors and interface protocols available today.

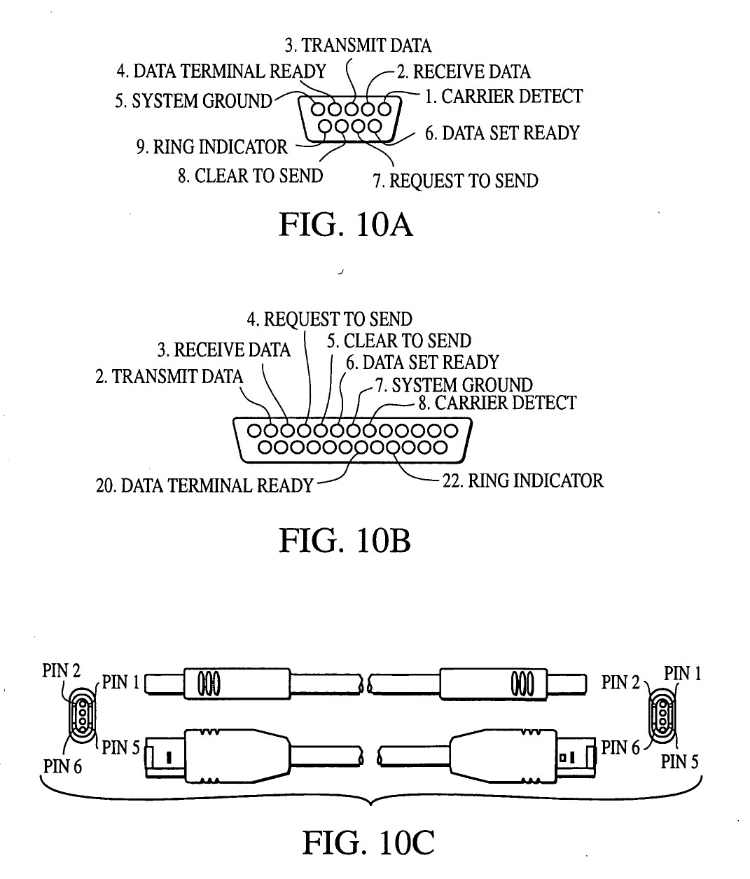

FIG. 10

This drawing covers the old and the new of the most standard computer connection/connectors for interfacing equipment. First the old serial cable 1294 connectors for 9 pin and 25 pin at the top of FIG. 10 and at the bottom the new USB IEEE1394 with it's male and female ends 1394 SMT and 1394 MM series.

The serial connectors 9 and 25 pin at the top of the page are the most standard way peripherals have been connected to a host computer and will be employed extensively in the PFN for a very long time. Most C.O.T.S. products for GPS, Cellular phones RF transmitters or receivers or any combination of the two also use these kinds of connections to interface the signals received and or converted to digital and or Binary codes through their specific provided software and prepared for e.g. windows program or Dos operating systems. Most often these interfaces have been achieved with these two serial connectors for complete and sophisticated computers and for basic controllers and even small micro controllers. Even if this is not a sophisticated operating system like windows or Dos and it is only burned in software to a chip these serial connectors have been most generally used most to complete these tasks.

At the bottom of the page in FIG. 10 is the latest connectors which are also smaller in size physically, which is a great advantage to the invention and the space considerations of the PFN. But most importantly this new IEEE 1394 BUS system eliminates a lot of the bottle neck in the back of computer systems with respect to these hard ware connections and allow for greater coupling and networking of systems for all serial/digital interfacing for the unskilled as well as the skilled in the arts. Due to Sony, Micro Soft Philips, ect., just to mention a few because just about every major electronic supply corporation even in the auto industry is designing their products physical connections and software programs to be compatible to this new protocol IEEE 1394; it has made the PFN a very realistic and practical as well as necessary component for personal security of these sensitive and expensive items as well ideal modality to interface and control them and their functions with accountability. While much time could be spent in discussing specific past devices and all these interfaces as well as the newer ones most all the peripherals that will be added individually will be plug/install program/and play. And in most all the software watch dog programs will be able to search for the peripherals and identify their presents and control them as well as record their data when so indicated by the PFN's computer program or other legal mandate on board software program running.

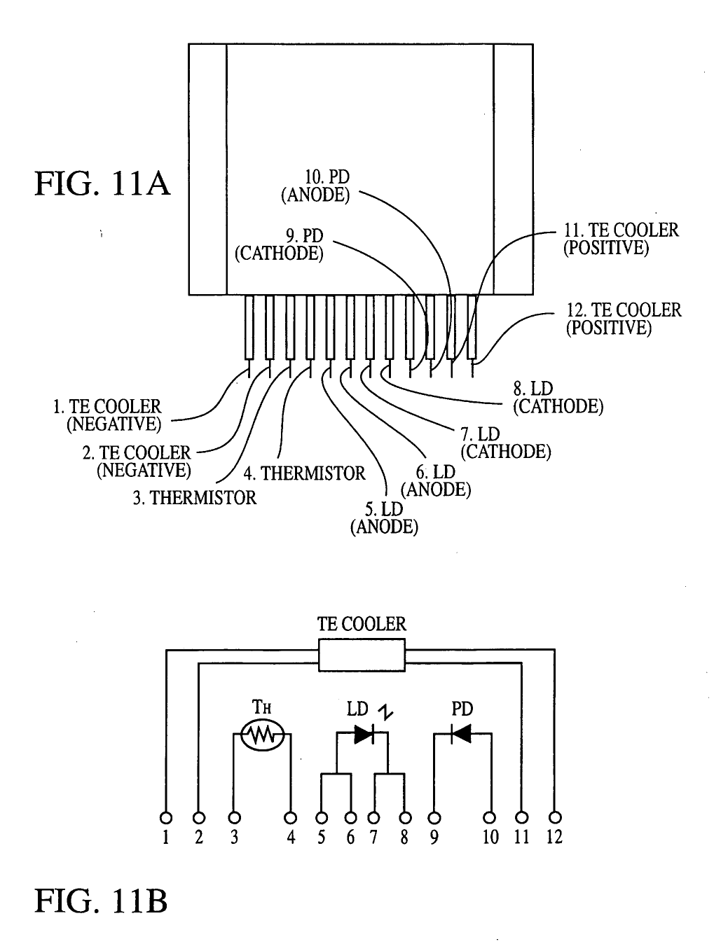

FIG. 11

Is a infrared laser diode component part chip emitter 1102 and detector 1101 to receive a light transmission and to emit a light data transmission between two devices e.g. camera and a lap top computer outfitted with these chips and a transceiver to processes the signal and condition the signal or convert it to a analogue signal or digital data stream which is usable by the devices. This of course is all preprogrammed software/firmware for this interface to take place. This is a usual use of this component along with the IrDA transceiver in both devices. Much more description of this type of interface will be covered in the third and following patent in parts series 1000 where the interfacing of digital systems will be done in some cases with fiber optics And or IrDA light transmissions in the exterior of any PFN modalities.

However for the internal functions in the PFN will for the foreseeable future use the Hewlett-Packard IrDA compliant transceivers 115 Kb/s, 4.0 Mb/s Discrete Emitters and detectors which will be employed for the prototypes and any IrDA interface with peripheral devices in the secure lock up. HP is being used to be more compliant to the vast amount of C.O.T.S. products Hewlett-Packard has supplied their IrDA interfaces to already. From Palm Tops, Lap Tops, Cameras, Cellular phone modems, etc. And finally for most all of the fiber optic plastic or glass fibers they will employ Patton modems to connect to standard RS232 computer ports like their Models 1110A, 1140A, ect. Or in the PFN computer an edge connector will support a quick connect card interface module where the fiber cable can plug directly in to a holled socket for the glass fibers and be decoded by the card and sent on to the inventions computers in the appropriate format.

There are so many vast amounts of interfaces to complete the unique functions of the inventions PFN to create an accurate accounting network and record system that it is necessary to name at the very least the most obvious. Because, all of these interfaces mentioned will be used in one industry application or in another to meet all the special needs and configurations the invention will be specifically designed for, and in this case e.g. EMF interference ect. is the major concern for some automotive applications. However the most efficient and least expensive system as well as the simplest will be three major considerations for any PFN construction or any other innovation of the invention.

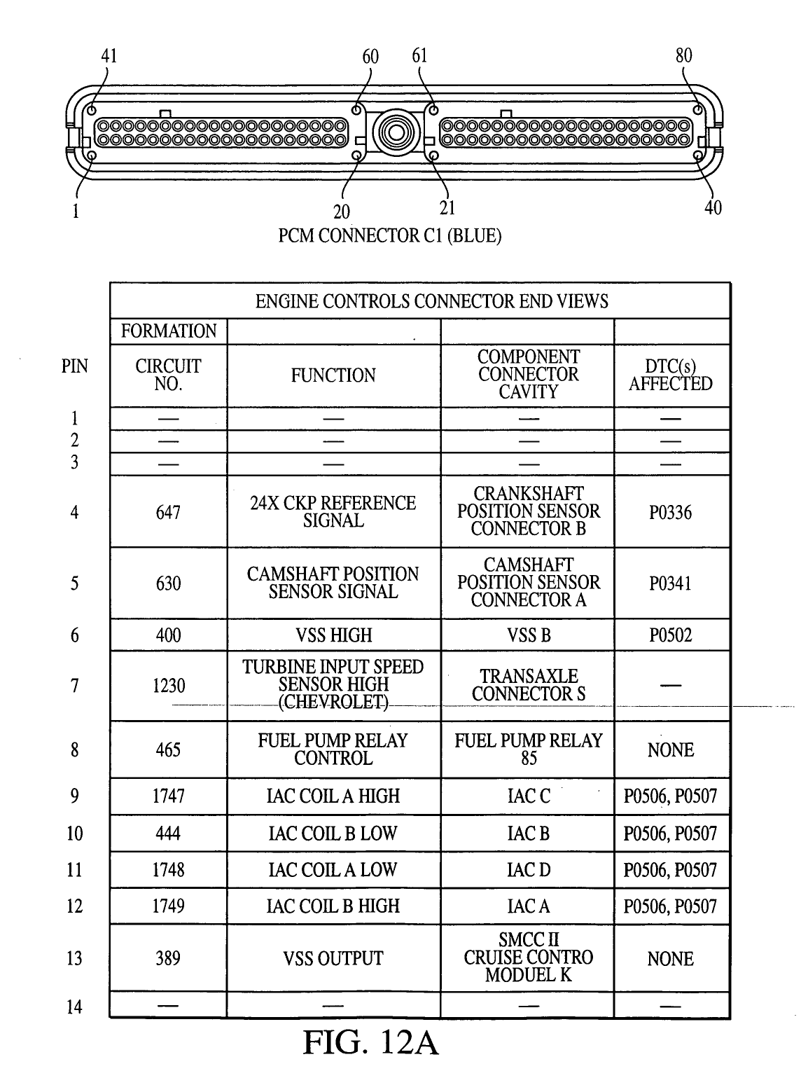

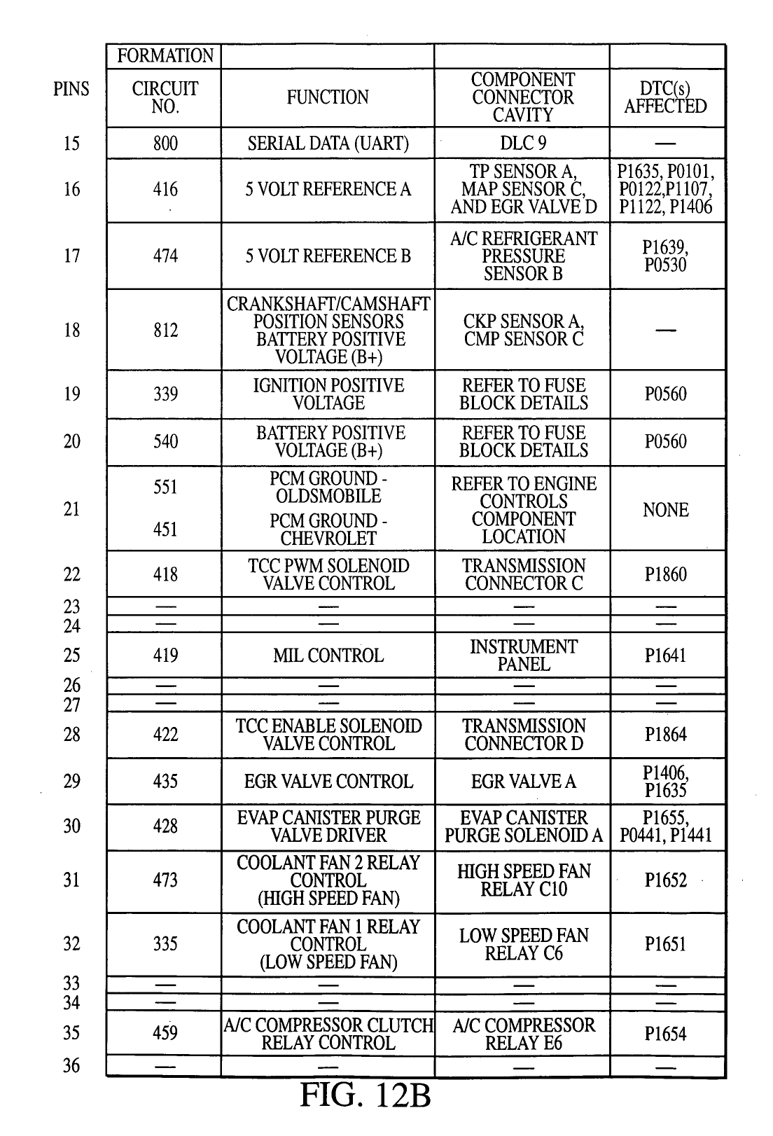

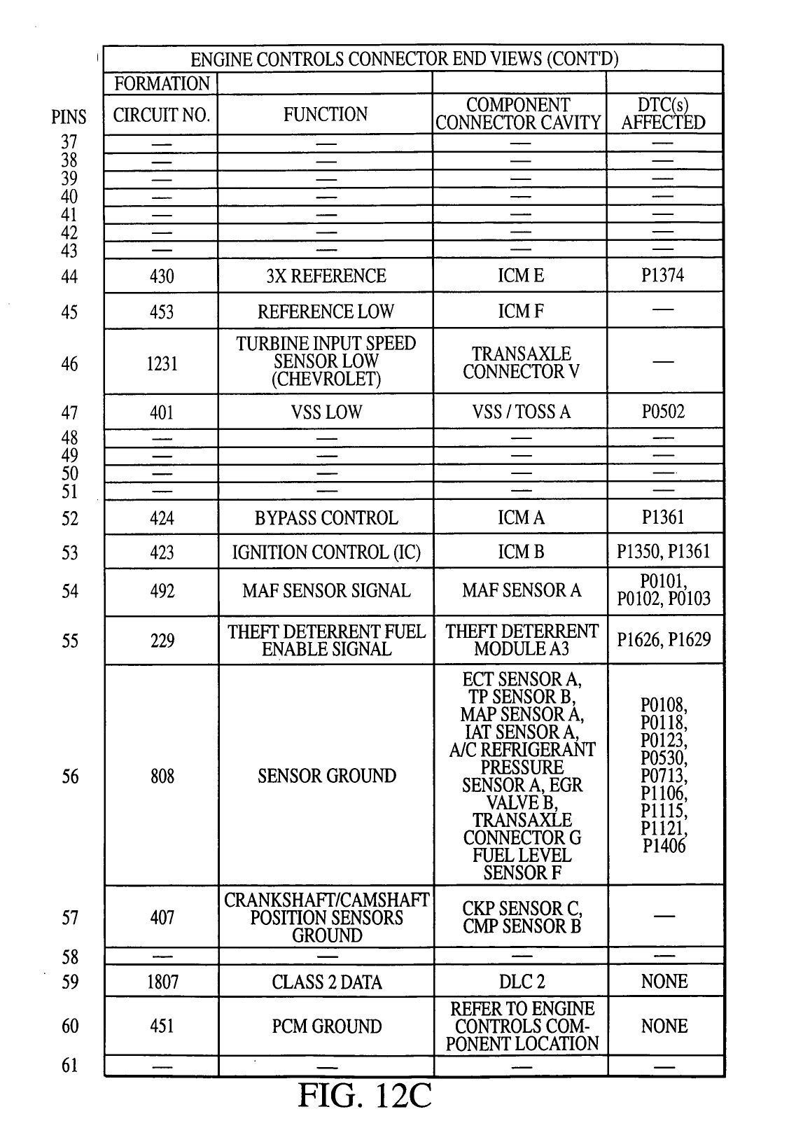

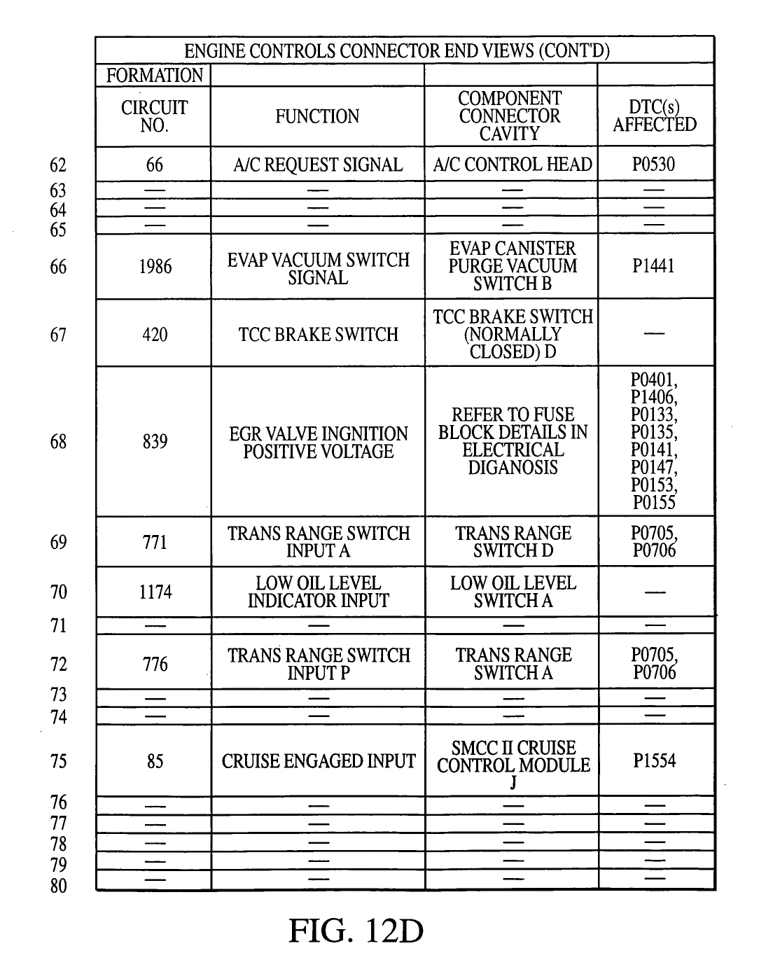

FIG. 12

This is an end picture of the powertrain control module connector and all eighty connection pins. This power train control module connector depicted in this drawing is from a GM 97 Chevy Lumina or Cutlass Oldsmobile. And it is being used because most of the prototype devices have been done on the Chevy Lumina. Most all automobile manufacturers have their own programmable controllers even if their connectors and pins may be different in placement and configuration and vary through out the years of manufacture.

Much of the connections will become more standard in the future between different cars because the electronic supply line manufactures are growing is size and simultaneously shrinking in number as they capture market share. And also because the telecommunication industries are merging with other radio communication industries as well as automobile electronics. This is the major reason for the invention developing a protected accountable interface platform to meet societies needs as well as take advantage of this more universal interfacing of electronic components for all of industry in the future.

However to accommodate present and backward technologies as well as address the functions of the invention and how it will utilize present day automobile sensors and devices as well as address the future more sophisticated sensors and the different monitoring systems for future different energy sources and quantity of energy use.

Using this GM PCM connector presently as an example on pin 16 the established 5 volt reference for the throttle position sensor, the mass air pressure sensor and the exhaust gas recirculation valve would be monitored for malfunction and reported on by any of it's trouble codes through the on board PFN computer to a phone node a small monitoring control system like (e.g., On Star). Of course the driver would receive all these error messages in real time as well and a reasonable time would be tolerated for them to interact with their service program and apprize their monitoring service if different than their service provider that they were going in for service at a specific date. At which time the monitoring service would ask the car through a preprogrammed date in the vehicle soft ware to run a full diagnostic on it's EPA systems to see if their was any unrepaired devices. Presently some of these systems work on analogue current and digital where their acceptable operational parameters are judged by a specific voltage reading or digital signal received in TTL, e.g., +5 −5 or a coded automotive language or serial Data UART.

Presently the monitored EPA pins would be [16]-TP sensor MAP Sensor and EGR Valve with the report criterion being The trouble codes ACTIVATED P1635, P01101, P0122, P1107, PP1122, P1406 and stimulated through pin [29] EGR. Also pin [30] EVAP canister Purge Valve Driver monitored through code activations in the PCM P1655, P0441, P1441, and pin [54] mass air flow sensor P0103.

And pin 56 would be monitored for activating the trouble codes for the presence of an increased level of ground through the sensor switches for the ECT, TP, MAP, IAT sensors and A/C Refrigerant pressure as well as the EGR valve. the trouble codes are: P0108, P0118, P0123, P0530, P0713, P1106, P1115, P1121

Much of the general operation of the vehicle can be monitored for normal operation in the same way for oil level or loss through Pin 70, brake switch control pin 67 ect.

However the sensors will be able to sniff the elements of vehicle exhaust and measure the level of toxic fluid levels in electric cars as well as report on how mechanically safe a vehicle is or it's road worthiness. Using sensors like the “Nose” all HC, No, So2 ect or any of the determined toxins will be monitored and recorded for their posse of them and their containment and any byproduct toxic impact of their use and the impact of the total vehicle when it is in use.

As has been discussed earlier and thoroughly Controller Area Network (CAN) is the direction the automotive manufacturing is headed to allow for the combination of all these different types of systems to be interfaced electronically. Philips semiconductors has a multitude of In Vehicle networks (IVN) that are finding wide application in today's vehicles so just a moment more will be taken to discuss the properties and products names that will be used in the PFN's of the invention as interface systems in the prototypes.

Basically Telematics networking is going to use the IEE1394 BUS for a standard high speed, high band width communication because it can in real time deliver the audio and visual thanks to the development of a dedicated layer for this multimedia Bus. This will prove to be most necessary for accurate inexpensive remote and automated controls, an therefore is planed for use in the inventions prototypes as a standard interface. It is also working its way into the automotive industry as well as all other related electronic fields, which makes interfacing a lot more easy.

For slower speed the universal Bus USB will be used in the slower or mid speed applications and also the USB-IrDA is planed for some PFN prototypes and is also seeing more use in the automotive field.

And finally the high speed Digital Data Bus-Optical will be used to carry control and source data D2B-O in the automotive (CAN's) and therefore will also be employed in the inventions PFN as a interface technology. It is off of this fiber-optic technology that the earlier mentioned invention's optical node to make simple multi connections for networking with a glass ball or conveyance node and branching fiber optic cables would be employed to transfer the optical signals to other devices either in the PFN or externally. This system shows a lot of promise because of it's electrical immunity. The other systems mentioned above are well designed to reduce EMF interference but none are as reliable as this light technology.

And of course, as was discussed earlier the standard US SAEJI850 mid speed (Class B) standard Bus will be one of the first employed in the PFNs as this standard bus is the most popular in the states at present and will be here for quite some time.

FIG. 13

FIG. 13 is an illustration of a by product interface of the invention. As was mentioned earlier this cordless phone option can be used to supply phone service to a PFN on a temporary basis or a permanent basis to augment or remotely change a machines pre-programmed functions or to diagnose malfunctioning parts by being a data link to OEM manufacturers' computerized repair service departments. When employed on a temporary basis the cordless phone would be to connected up directly as shown in FIG. 13. And if a permanent hook up was required the cordless phone would be energized and provide with a stable 3.6 vdc from the P.N. or connectable computer to insure that the phone would not fail due to a low battery.

The cordless phones very greatly in cost quality and capability to handle this type of data transfer interface. The major obstacle in the less expensive systems is band width limitation and speed of processing the large digital data streams which create much slower data transfer connections and unreliable connections with all the other slow old phone switching still around.

Some of the more sophisticated circuits can accomplish this data transfer by being connected from the computer modem directly to the front end radio transceiver circuit of the cordless phone. This connection is made on the output pin of the microprocessor chip that generates dialtones from the keypad switches activated in a standard dial up mode. This circuit is shown in block form at the bottom of the drawing because there are quite a large number of processor chips and circuits manufactured and some circuits are resisted and it is important not to be restricted by some resisters in making this connection in some for some of these circuits. The simple connection and circuit is depicted by circuit (A). And when or if an improved data transfer speed are desired as well as a more reliable and consistent data capable circuit; circuit (B) is designed to help solve the Band width dilemma and the bottle neck at this point. In another simple block drawing understandable to anyone in the art; this is accomplished with a digital\data compression chip in the hand set labeled 1313 and a decompression digital\data chip in the base station.

1300 in the drawing can be a PFN computer, however, here a personal laptop is used to show another application for this cordless interface by product. In this application the cordless phone can be used to give laptop users a quick way to be more portable without having a hardwire to drag out to a remote location, e.g., a patio, etc., for around the house or building use. This way one can receive faxes and or E-mail with out the cost of installing expensive land line alterations in the building, while enjoying the use of a portable computer or laptop in a remote or unusual location. A simplistic alteration to allow every sold cordless phone to provide web access for faxing and E mail as well as serve as a data link for any machine messaging.

1301 is a standard phone jack j-11 (in the proto type),(however a special mating notch for this J-11 female plug and accompanying male socket will be made for the commercial 1302 phone cord that connects the cord less phone to the computer which has a standard j-11 connector on the computer side. This special access j-11 1n 1304 handset is to prevent a person form accidentally connecting the cordless up directly to the land phone line and damaging the transceiver section of the cordless phone 1304 with standard phone line tip and ring current) (however a dual functional phone capability may also prove to be a marketable asset and the appropriate circuitry can easily be provided so that a phone can be cordless as will as support a direct line service for times when portable power supply is diminished. 1302 in the prototype is a standard phone cord with 1303 another standard j-11 phonejack, which has it's two center leads the standard green and the red wire connected, red to the red lead of the ear piece and the green lead to just past the resistor solder point where the output pin for the dialtone micro processor circuit connects to the input of the radio transmission portion of the cordless hand held receiver 1304, (These chips vary from manufacturer to manufacturer so this output circuit to transmitter input circuit most be located first and avoiding any resistors in the different circuits. All that remains is to turn on the cordless phone to get dial tone and start your program to get on line or to send a fax through an automated dial up of a preprogrammed number.

The computer by passes the microprocessor and generates the dial tones to connect with a data node or gateway over the standard phone lines. Of course the signal is first transmitted to the base station where it is converted and transmitted on the standard land based phone lines ideally ISDN.

And Of course the cordless can be designed to turn on when a phone signal is sent from the computer or a current sensing switch with a semi conductor driver could switch closed the power on circuit to turn on the cordless phone automatically or this could be a burnt in firmware in a small EEPROM processor chip and a computer command in the modem or computer software could perform this function as well.

1304 is the cordless phone, 1310 is the base station 1307 is another j-11 standard phone jack. 1306 is another standard phone line. 1305 is the standard phone in the wall j-11 jack. And 1308 is the DC line coming from a transformer for the base station and 1309 is the black cube transformer plugged into the standard 110 ac wall socket.

The drawing below shows in block form the two types of circuits to achieve this cordless phone interface for data transfer from computer modem to the phone line. 1300 once again is the P.N. or computer, 1311 is the standard modem and the two lines that come out of the left side of the 1311 modem block (A) goes right to the output pin of the dial tone processor 1319 then on to the radio transceiver 1312 an over to 1314 transceiver to be processed by 1316 and on out 1317 phone line in 1318 j-11 jack in the wall.

B circuit does the same except the signal first gets compressed after the modem 1311 in 1313 then it is routed to the radio transceiver 1312 in 1304 the hand set and then on to 1314 radio transceiver in 1310 the base station and is decompressed and processed by 1316 and on out the phone line 1317.

This in actuality is a two way transmission with firmware to hand shake and timed clock pulses between the cordless transfer of the computer modems digital data for compression and the decompression exchange with the digital data from the base stations transmissions. So in essence both the hand set 1304 and the base station 1310 will be compressing and decompressing digital data in this circuit arrangement. But to simplify the explanation and drawing; only one direction is shown here. And that is from the direction of the laptop and cordless phone to the Base station 1310.

The critical reason or criterion for this circuit is depending on the quality of the cordless phone and any Band width limitations to handling the modulation of expanded digital messaging over any radio signal. (traditionally 900 mhz.) For FCC approved cordless phone applications. Chips similar to Motorola digital data compression decompression protocols used to handle bandwidth problems for digital data for the paging industry are planned for in the prototypes to over come this possible band width difficulty or situation whereever necessary. However, there are a number of semiconductor manufacturers that produce these kinds of IC chips for this purpose and the mere mentioning of a particular prototype component or modality should not limit any claim to this innovation for cordless phones.

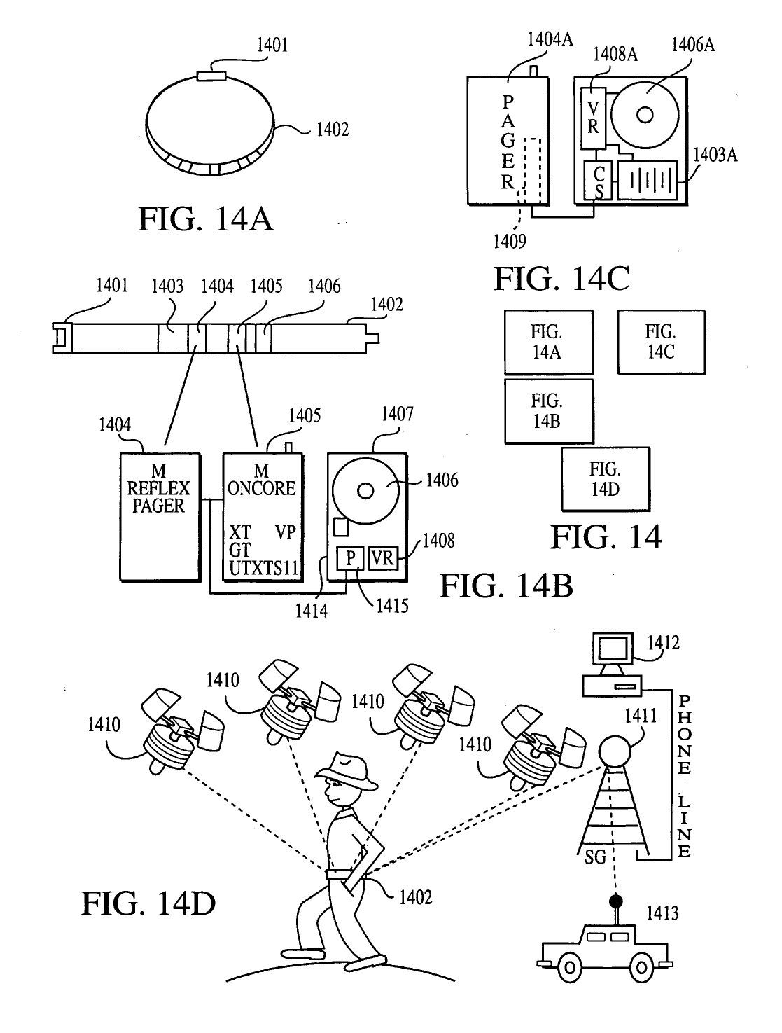

FIG. 14

1401 is a belt buckle that has a special key to release the locked buckle or electronic lock or any kind of locking mechanism. 1402 is a hard nylon or similar plastic flexible strap resistant to cutting in the most practical way, that has and inner liner of nylon strap so that one or two way pagers and or a G.P.S. system like Motorola “Oncore” XT, XTsII, GT, UT, VP or Philips G.P.S. chip set mentioned earlier in this application can be secure and concealed in an protected enclosure between the two nylon straps to store these G.P.S. components along with differing levels of transmitting devices that can receive signals or messages, transmit signal or messages, and or alert of sound alarms on both sides of these trans missions.

FIG. 14

FIG. 14 displays varying levels of one way and two way pagers and C.O.T.S. paging protocols as well as voice paging applications. However, as earlier mentioned; this invention provides for short RF signal transmitters with their transmissions received by every piece of equipment that has a P.N. and will ultimately all have RF transceivers to receive these emergency priority signals and condition the signals and repeat them in a pre programmed manner over what ever long distance communication hardware that exists in the PFN to the proper authorities. This is a repeater function deserving of special consideration and is not the same technology stated hear for the pagers in FIG. 14. As has been described and maintained through out all these applications. However, these types of carrying systems e.g. belt or bracelet or even clip or tape on systems and the qualities, properties and capabilities claimed demonstrated for FIG. 14 are the same as claimed for the repeater technology as well and while they can perform many of the same tasks they are two distinctly different technologies, and are herein so stated, however equally protected in this and the related patent applications.

The G.P.S. chip set or IC board is represented in FIG. 14 by #1405. 1407 is the patch antenna for the G.P.S. and this cable would be place into the belt and follow the contour of the belt to be concealed. 1403 is an extra battery in some equipment variations and a way to give longevity to the entire locator belts functions. 1406 is a speaker or a loud speaker if a monitoring protocol determines it to be the best option to send a message either via a pager or cell phone signal, e.g., Motorola reflex protocol to alert the person wearing the belt, e.g., criminal leaving a restricted area, or child lost and a public announcement is desired to seek aid from responsible adults in the area. The speaker could also emit a loud electronic whistle or shrill alarm intermittently to attract attention to the wearer of the locator belt or band.

All of this would be initiated from a remote phone page or cell phone call. Some of the C.O.T.S. Pager products that will be used in the proto types are the Creatalink pager processor both one way and two way, the standard one way and two way pagers (reflex protocols) using the interface technology detailed in earlier related patents e.g. current sensing as was done in the first patent and Binary/ASCII/NMEA BIN/Loran from the G.P.S. all processed into 20 bit data segments to meet the Motorola reflex protocols for transmitting return data. Either through soldered connections, or BNC connector DB9 for RS232 as already detailed. The software for these applications are available for product development for this product through Motorola and only the specific software commands must be written to create the desired functions. This is easily accomplished on the PC and downloaded into the chip set processors.

This is the case for all the interfaces described in these application and due to the many different types of combinations to achieve even this simple locator belt it is not practical to write the exact programs and in fact is much more clear to describe the functions verbally and list all the hardware parts and software components available for even the unskilled to write programs. Anyone skilled in the art and even a hobbyist who can read will be able to buy these parts and the software packages and write these basic controller programs in a matter of hours. This is why the functions are focused on rather than any specific basic programming command string.

1408 is a voice recording chip to give prerecorded messages as triggered from phone pages as described in the first related application for the stop and control box. 1415 is a processor if the Creatalink is not used and it could be a small stamp computer. A Stamp I although Motorola and Philips as well as Siemens Tech, Radio Shack and a host of others all make micro controllers or processors to turn on the voice chip and speaker or hailer when they receive and recognize a coded message from 1404. Or if the water sensor sends a signal (the small square [W} in 1408 indicates a water sensor which would go off if the wearer of the belt was being submerged in water. And Of course all the electronic equipment is made water proof.

1404a shows a C.O.T.S. standard one way pager with the inventions proprietary non intrusive battery peg 1409 connected to a current sensor chip exactly the same as the first patent for the stop and control box to sense a silent pager vibration activation. The chip is connected to the voice recorder chip so when a phone page is received it draws current down out of the battery peg circuit and creates a ground on one pin of the current sensor which triggers the voice recorder or howler or hailer through speaker 1406a message or noise. And or a small micro controller with a EEPROM can run firmware programs to alert the surrounding public or in a two-way pager reflex protocol application monitor 20 character bit audio sound bite of what the wearer is experiencing. And the power is supplied by the battery 1403a in the in the recording system. These systems could also use the same system as the P.N.'s and record the surroundings or report back sound and or data. So with special monitoring equipment on hand these pager locator belt systems could call in if someone had a medical emergency or hit a panic button.

1402 is a belt on a man walking on earth. 1410 shows 4 satellite a minimum for getting G.P.S. coordinates and most systems mentioned use at least 6 satellites and as much as 8 channels are available for taking a reading in all the Motorola chip sets. 1411 (SG) tower is a commercial server or land line phone node or gateway as has already been thoroughly described. 1411 tower will pick up the page signal or RF signal or Cellular system, if these technologies are employed and convert them through phone modem and transmit that signal down a ISDN phone line or comparable to at least one computer 1412 that is running a G.P.S. program to monitor the Bin/ASCII/NMEA earth coordinates and time coordinates data transmitted to 1411. Also as was described earlier the coordinates could be monitored from the car 1413 if the car was the phone data node or the car was able to network with 1412 to receive down loads for the data of earth coordinates. All easily accomplished as described earlier. The second figure down in upper left is the belly belt locator belt laid out flat. And 1401 is the lock buckle 1403 extra battery 1404 is the pager 1405 G.P.S. 1406 speaker or hailer or howler.

The following names the specific communication devices stored securely in the stop and control box or PFN that report or transfer data to remote monitoring and control systems, however the transmission of the data is two way transmissions for memory storage, recording, of remote control commands as well as all the on the vehicle sensing devices and or audio visual data records. A two-way pager is responsively connectable via a processor or a computer stored in a secure manner and capable of transmitting data to download it to at least one remote monitoring system. A cellular phone technology is responsively connectable via a processor and/or computer also or either stored in a secure manner and capable of transmitting data to download it to at least one remote monitoring system. A radio frequency transceiver is responsively connectable to a processor or computer or stored in a secure manner and capable of transmitting data to download it to at least one remote monitoring system. A physical connector interface port either on the stopbox or PFN or vehicle interior or exterior is responsively connectable to a processor or computer and or protected, shielded and/or maintained in a secure manner and is capable of transferring and/or transmitting data to download it to at least one remote monitoring system. An Irda or any optical light data transmission port is either on the stop and control box or PFN or vehicle interior or exterior and is responsively connectable to a processor or computer and/or protected and/or maintained in a secure manner and is capable of transmitting data to download it to at least one remote monitoring system. A multi-tasking law enforcement device (hand held gun) that has, radar, and any of the above-mentioned communication technologies, is capable, through electronic security protocols covered in these related patents, of “electronically handshake” with the stop and control box PFN processor or computer and download to at least one remote location (e.g., police cruiser) (also a function designed for the cruiser transmission equipment). A processor or computer, as detailed within the applications, is responsively connectable to memory and the above-described communication devices in a secure manner that can process by modem and or conversion hardware, firmware or software algorithms a specific electronic signal in to pre-programmed alpha-numeric text or ASCII, etc. and/or can re-transmit the signal or converted message over any other communication device responsibly connectable to the processor or computer to download the data either converted or not converted as repeated data to at least one remote monitoring system in real time or as a stored data transferred in a data down load (used to take short range Rf signals and connect them to long range communication systems. A processor or computer, as detailed with in the related application, is responsively connectable to a Global Positioning System (GPS) and the processor is also responsively connectable to the above-described communication devices all in the stop and control box PFN in a secure manner and capable of transmitting the GPS coordinate data (NMEA) protocol and or any other locating device signals as either separate data or error correcting data for the GPS to at least one remote. The monitoring system (cellular systems are going to be much more accurate for the location of the transmission and GPS) can benefit from the combining of these technologies for error correction of the GPS signal through the ionosphere if DOD will permit this combination of the two technologies. A processor or computer is responsively connectable to a magnetic card swipe device that can transmit via the communication devices detailed herein to at least one remote monitoring and or control system for the purpose of billing debiting or crediting for the use of piece of equipment that has a stop and control box or PFN on it. A processor or computer is responsively connectable to audio and video devices as well as the communication system detailed earlier for the purpose to to guide or control remotely a vehicle with a secure stop and control box or PFN. A processor or computer responsively connectable to a memory to storage system to record a audio or video signal and data used to control a vehicle remotely. A processor or computer is responsively connectable to an audio or video system or device that is remotely controlled by at least one remote location and with the vehicle running or not running, occupied or not occupied, via the communication devices in the stop and control box or PFN.

A claim is made for any combination of wireless communication device interfaced or integrated with a processor or computer control or controller circuit for remote controlling or remote switching when protected in a secure manner and is considered a component of the secure stop and control box or PFN (e.g., Motorola's CreataLink, Lojack, etc.). A claim is made for any combination of land phone wired and modem interface that is responsively connectable to a processor and or computer as an integrated or separate device system when protected in a secure manner.

A stop and control box PFN also is a space to store valuables in a secure manner of protecting personal property. It is interfaced and/or not interfaced or used in part as a physical storage with specially provided compartments as a antitheft, anti-fire impact resistance rough service proactive containment for (e.g., personal computers, laptops, palmtops, organizers personal communication devices, pagers, cellphones, radio equipment, expensive stereo systems, hand held GPS units, wallet, money, important papers, expensive watches or jewelry, etc.).

A claim is made that this stop and control box PFN could be an add-on device to retrofit older cars or specially outfit cars, e.g., taxi cabs with a locating system magnetic card swipe, a processor or computer and the above-mentioned communication devices so that the cab driver or limo driver can confirm a credit card in real time and bill the card right from the cab as well as store the data print the data retrieve a script or electronic signature from the card carrier and ID the card carrier through photo, fingerprints or pupillary ID.

A further claim is made that the PFN stopbox and control be made part of the vehicle in manufacturing and house and provide a secure environment for the vehicle processor or computer or any of the control circuits deemed necessary to be incorporated in the PFN.

A claim is made for the stop and control box PFN to have specialized compartments that hold these items in a particular place to provide interface technology for these devices in a plug-in, install program and play modality.

A claim is made that the compartmentalization of the stop and control box PFN has flexible versatility to change and rearrange the compartments for personal or commercial preference as to size and placement.

A claim is made that the stop and control box PFN can be located any where in the vehicle, but ideally place for easy access and use will be incorporated in most all designs.

A claim is made for manual locking mechanisms for multiple doors or access panels to the compartments.

A claim is made for electrically activated locks and or automated open and close and in and out functions for the drawers and access panels.

A claim is made to automatically activate those doors and panels in either direction by inertia sensors Sudden Impact Restraint Deployment Sensors or any distant sensing device or systems or any preprogrammed response from the processor or computer programming.

A report data management and memory storage network of the vehicle/machine receives the reports of this processed preprogrammed data from said operation sensors via any secured and or unsecured two way communication devices that are stored on the vehicle/equipment.

A report management and storage system is comprised of and layered geographically to be operated commercially, privately, publicly, and or governmentally, which provides mass data management, memory storage and or data transfer capability of processed and copied recorded data, and has routing functions to comprise a machine messaging network (MMN) for any purpose of monitoring or analysis from the smallest operation to the largest level of control and governance, and either operated separately or as a part of an entire network for socioeconomic and environmental reasons including monitoring, accounting, and/or any kind of monetary billing.

An off the vehicle/equipment report system is first comprised of personal, commercial and governmental owned and/or operated “communication interfaces” that provide wireless communication to land based phone nodes for computer networking via, RF signals, cellular phone signals, satellite communications, other land line based phone switching systems and or one and two-way pager systems, etc. to be referred to as “Gateways”.

A “personal or private Gateway” as described in the first patent application referenced can be a privately owned and operated control system using a home phone number and personal computer system with the software to process the modem conditioned machine message signal received from a stop and control box or the primary focal node PFN on the vehicle or equipment. This is for any monitoring purpose regarding: equipment operational sensors, environmental sensors, on board audio video equipment, any identification systems, e.g., cardswipe, fingerprint ID systems, pupillary ID systems operator physical monitoring devices, locating devices and programs It can be for any remote control or robotic functions to remotely, drive a vehicle, bill for use of a vehicle or machine, remotely operate any and all types of machinery, evaluate and diagnose malfunctions from the PC, to remotely order materials and service personnel to affect repairs, and quote the cost of repairs remotely, to remotely affect remote repairs electronically, to remotely shutdown equipment, etc.

The Gateway is for any networking with other computers or computer networks that manage data and store it, e.g., vehicle location, equipment technical assistance, personal accounting for machine or equipment use, e.g., tax credits, ect. Small businesses would use desktop computers or PC gateways outfitted with the appropriate accounting software for their vehicle and equipment maintenance D.O.T. requirements and Driver requirements incorporated into their accounting software spread sheets and company operational management software.

The PC would, if desired, be able to directly dial out to the company accounting firm or network to the accounting department for bigger firms and download data in real time. The PC would be able to deliver government required data to the government nodes if desired, or, if mandated due to, e.g., corporate bankruptcy or, e.g., if convicted for criminal negligence or unsafe operations or if just requested by the small business to receive government aid or support services. This could be done in a real time or near real time. If it is done for accounting purposes like taxing, fines, penalties or for crediting or giving credits, e.g., energy use, environmental improved waste discharges or to warrant providing aid or giving grants or to monitor loan provisions for monitoring equipment for health and safety concerns to the public. This is also applicable to larger commercial businesses government and organizations.

A “Gateway” phone and/or network node is also any of the vehicle/equipment remote receiving service or center for wireless communication and or land based lines that receives PFN machine messaging data as operational reports or requests for services.

A “Gateway” can analyze this data according to its preprogrammed software to determine appropriate service or services it is responsible to provide as a commercial service, (e.g., equipment mechanical diagnosis, dispatch personnel and locate repair provisions and materials, call emergency response personnel).

A “Gateway” also, according to its software, determines if it is suppose to network with any other computer systems or data base to report this data further or any portion of this data for further monitoring and storage or for billing purposes and/or regulation or legal compliance monitoring for either social economic and/or environmental impact.

A “Gateway” can be a local and/or toll free phone node to a specific government agency or a combined or multi-agency service node that can through its software route this machine data or manage and store it for local use and reference, regional and state use and reference, national use and reference, and international use and reference.

Also disclosed are billing or accountable tracking headers in any recorded data and or reported data either encrypted or not encrypted for any transcribed or converted text, graphics or audio video data as well as any Congressional mandated electronic security protocols deemed necessary (i.e., any billing or accrediting for PFN Data transferred to agencies, any billing or accrediting for PFN data transferred to commercial service providers, any billing or accrediting for PFN transfer of data for sale to commercial news agencies, and any monetary exchange for any reason completed through a PFN for billing and accrediting or any kind of accounting).

A “Gateway” can and should contain software and or the necessary personnel to process and post this machine data gathered in a Web page formate prescribed for a local public Web account page on the World Wide Web so that the public can monitor plan for and control their society, economy and their environment as well as compare and voice opinions on issues and data presented as compared to neighboring communities and the rest of the nation and world. This disclosure is for this type of system if operated publicly or if such a network is owned and or operated as a private access system having (Firewalls) or even it is publicly owned but is composed of guarded or protected information or system either partial or as a complete monitoring and control system.

Also disclosed are any machine message data from a PFN that is used to compile data for any public media or web page, either electronic, digital, analogue, text conversions audio or video signals or digital conversions; any interactive open forum webpage to voice opinion on issues involving data initially acquired from the Machine Messaging Network MMN of primary focal nodes PFN's; any webpage designed to organize issues for public integration and discourse on geographic levels and/or governmental structure, that also incorporates data initially acquired through a Primary Focal Node PFN, either related or unrelated to any issues, public news bulletins; any commercial presentation of data contained on any web page that is initially originated from the Machine messaging network MMN or via any PFN on any piece of equipment.

A state web account page would be maintained by the separate state agencies also receiving, processing, storing and managing this machine data for government, financial planning, taxing and any regulating purpose. This could be done either by commercial companies contracted and licenced to perform these services in a prescribed manner, or government staffed and controlled and or a combinations of both commercial and governmental services coordinated to process and provide the machine data for government, commercial and public review.

A national web account page will be constructed and serviced by all the government agencies of a nation, and those agencies will also provide all state and local web account web pages with the most current data that is pertinent to any specific geographic area that has been compiled at a national and world level. This will be accomplished with data prepared by the government agencies and or commercial contractors governed, licensed controlled and awarded contracts to perform data management and storage services. The technology to supply data to the web account pages from the local to the international level will vary with the types of mass management and data storage technologies employed today and the world wide web technology. This is continually be altered and improved. Some data will be delivered through client and server type programs like “Gopher” but most all World Wide Web (WWW) is supplanted with “Hypertext” presently.

The Hypertext client programs that will be used presently are Netscape and or Mosaic which are browser technologies, already employed and widely utilized by most government and commercial agencies companies, and organizations on the web today.

Future super computing links for data transfer will be developed by The National Center for Supercomputing Applications (NCSA) and commercial software groups like Netscape Communications Corporation, etc. All these web account sites will be Network Information Center (NIC) approved and given specific domain names and registered with a (Gov nomenclature) if governmentally sanctioned and or regulated and stipulated strictly through government controls.

Any commercial attempt to provide this type of web account page for public or private review as described herein at any and all of these levels is also within the claims of this invention, e.g., any small industry monitoring and/or data communications network to any large national news gathering and story development data or financial market analysis for projecting futures for industry and their safe practices of doing business. One goal is to develop more tools for the “Netizens”. Who, by definition, are supposed to have civic responsibility and participate in world communication through the WWW (as defined by Matisse Enzer's Glossary of Internet Terms). If this a future goal it has to be designed into our technology of today as communication technology and machine automation is merging at a record pace. The world population has doubled in the last thirty years and it is judging free enterprise and democracy as a way to live.

This requires the management of resources and the exploitation of them at the very least to be perceptive as fair and reasonable if any real peace and security in the world is to have longevity. Otherwise all the technology that is already in place could end up doing real harm and in the most rapid and humanly devastating ways, so that, no physical protection or monetary security could ever be designed to resist. It is important now to design technology to educate and fairly fulfill the needs of the worlds populous commercially and economically within a proper environmental balance in the exploitation of this planets resources so that people can act decent and be social at the very least.

The invention's energy and environmental accountable claim for mobile devices will be for the stop and control or PFN box—all geographic area traveled or used will be registered, recorded, and reported to a monitoring “gateway” which will bill for highway use (collect wear and tear tax for all non-oil energy based vehicles). For electric cars with specific charging stations this data will be downloaded from a on board PFN while charging, this can even be done at home and can be accomplished with land line connections.

The time a geographic area's roadways are used will be reported and recorded and billed and paid for automatically and or on the spot with the card swipe system in the vehicle (this ultimately removes the need for any commuter tax in close or multi jurisdictional areas, i.e., MD, D.C., VA), just the exact time a vehicle used the road and or was running in an area.

The type of fuel or energy used can be measured as a product and or timed as operational machine use. This will dictate the impact on the road as well as weight and emissions ratings for atmospheric impact as well as any other environmental sensors. And any such system that monitors the real time use of a vehicle and bills for that impact with these criterion they fall within the scope of this invention (i.e., the amount of fuel or energy used, type of waste product produced, the amount of the waste product produced, etc.).

Socio-economic Impact Functions (Spider Eyes)

Audio/video capture traffic impacts and record and report to at least one remote monitoring system for accident investigations and or any machine accidents in the highest credible and data secure manner. Insurance investigations decide claims and assign liability. Legal proceedings determine liability and accountability for govemment agencies to determine safety parameters and make rules, regulations and laws. Audio/video captures criminal incidents by activating unattended vehicle PFN's AV systems to a report criminal event by first waking up all machines from a sleep cycle in a cell or page area which is responsively connectable to a PFN processor or computer to give eyes to law enforcement through remote control in an emergency response situation or any other legal reason.

Audio/video captures news events as witnessed by a machines AV systems and to account for the data reported to receive remuneration for the data (e.g., weather conditions, traffic conditions).

Operational sensors are responsively connectable to a processor that is receiving high way conditions and speed limits, etc. and make the PFN an automated traffic enforcement device for certain driving behaviors such as speeding, reckless driving, drunken driving, road rage, pensive or inefficient driving.

The present invention is used to control machines/vehicles/equipment in a remote control fashion to equal equipment use for payment received and to account for that use, analyze that use, identify that equipment, identify an electronic serial number proprietary in these applications and their use in a secure manner, and to apply any accounting function with regards to any of these processes all fall with in the nature and scope of the invention.

The terms servers, providers and or Gateways throughout this document are inclusive of any commercial interest, governmental agencies, public or private organizations or individuals that receive data from a host machines (PFN) via, pager, RF transmitters, cell phone technology, telecommunication and or nodes, and/or any additional networks of these systems or any other remote control capable devices and performs any analysis, accounting, for any reason either for monetary assessment purposes and/or information gathering and/or public service and/or to remotely control uses or functions on a host piece of equipment with respect or use of any accounting process as has been described throughout any and all of these applications (e.g., stop box, black box or billing box functions) fall within the nature and scope of the invention.

This also includes any hard wired land based phone systems that have modems attached to a host piece of equipment for the purpose of accounting and/or billing as to the impact and uses the host piece of equipment that might have a socio-economic function and/or environmental impact, e.g., the latest utility transmitters to measure electrical power use or gas, oil or water flow when they are coupled to the (MMNWWW) which is part of the inventions control and monitoring system that determines energy cost for equipment use, i.e., lights, heaters, etc.

Any deliberate securement of these control circuits/devices lines, and report back and/or record keeping devices to restrict access for any of the above stated purposes fall within the nature and scope of this invention, even if it is for the use of diagnosing and machine augmentation or remote control when involving direct telephone line connections.

This is especially true when it is to secure any accounting function that can control the uses of a host piece of equipment for public and environmental safety and/or to apply any monetary charge for repairs, utilization and asses or record abuse as well as remotely control those uses or augmented functions and/or any services provided though the entire system as here in described as the invention.

Any pager, cell phone and/or RF device employed by any provider/server to make sure that machine use is equal to payment received, and thereby determines authorized use of equipment as per any pre-agreed contract between any financially involved companies, e.g., service energy use, repairs, loans, leasing, and the like, and equipment purchasers/leasers and/or operators also are all within the nature and scope of this invention.

The invention also includes any interface standard telephone or cell phone modem device that employees security features. This means any securement, concealment or technical integrated circuitry which makes it difficult to tamper with these systems also fall within the nature, scope and purpose of this invention, which is to insure accountable control and records over a piece of equipment and to receive moneys for that use and as a result of that function. The invention will be able to give service support to the public in an environmentally safe way, as well as a financial way.

For the interactive highways and the smart cars to use GPS effectively in the PFN it has to be constant hot position readings and more accurate. It is possible to get accuracy to the center meter level with error correction technology (A second stable signal). The Department of defense is very protective of its error correction multi modulation technology for a GPS signal to keep commercial accuracy only to about 30 meters due to the interference of the ionosphere. The invention's improved cell phone locating system mandated by congress can greatly aid GPS accuracy on land based locating operations in general as most cell towers follow major highway arteries and are fixed locations on the earth. The PFN technology may be advantageously used to direct any smart cars on interactive highways or robotic vehicle operations. There are also more sophisticated GPS systems that already use a additional land based signal for error correcting algorithms but none using this new cellular system.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

1. A real-time vehicle recording and optionally reporting system for a vehicle located on or remote from the vehicle, comprising:
at least one operation sensor recording the operations of the vehicle as a recording signal, the recording signal indicative of at least one of socio economic impact, environmental impact, predetermined impact, and an arbitrarily determined impact relating to usage of the vehicle;
a memory located in or on the automobile/machinery in a secure manner, storing the operations of the automobile received from said operation sensor in a secure manner;
a secure enclosure housing said memory and protecting said memory from unauthorized access thereto; and protecting said memory from the elements as well as fire and impact or any kind of rough service.
a processor responsively connectable to said memory, receiving the recording signal, and determining the at least one of socio economic impact, environmental impact, predetermined impact, and an arbitrarily determined impact for use in assessing at least one of vehicle owner and vehicle operator.

2. A real-time vehicle recording and optionally reporting system according to claim 1, wherein said real-time vehicle recording system is substantially stored in a stop and control box to prevent unauthorized access thereto and the vehicle.

3. A real-time vehicle recording and optionally reporting system according to claim 2, wherein the stop and control box is stored in or on the vehicle.

4. A real-time vehicle recording and optionally reporting system according to claim 1, wherein the operations of the automobile received from said operation sensor and stored in said memory are downloaded to at least one of a remote monitoring system, a remote billing system, and a remote data analysis system.

5. A real-time vehicle management system including a security function that restricts unauthorized access thereto, comprising:
at least one operation sensor recording the operations of the vehicle as a recording signal, the recording signal indicative of at least one of socio economic impact, environmental impact, predetermined impact, and an arbitrarily determined impact relating to usage of the vehicle;
a memory located in or on the automobile\machine in a secure manner, storing the operations of the automobile received from said operation sensor in a secure manner; and
a processor responsively connectable to said memory, receiving the recording signal, and determining the at least one of socio economic impact, environmental impact, predetermined impact, and an arbitrarily determined impact for use in assessing at least one of vehicle owner and vehicle operator.

6. A real-time vehicle management system according to claim 5, further comprising at least one communication device stored securely optionally in a stop and control box, said at least one communication device reports or transfers data to at least one remote monitoring and control system with transmission of the data being optionally two way transmission for memory storage recording of remote control comands, the recording signal from the at least one operaiton sensor, audio data records and visual data records, said at least one communication device comprising at least one of:
a two way pager responsively connectable via at least one of a proccessor and a computer stored in a secured manner and capable of transmitting data to download to at least one remote monitoring system;
a wireless telephone responsively connectable via the at least one processor and computer stored in a secure manner and capable of transmitting data to download to the at least one remote monitoring system;
a radio frequency transceiver responsively connectable to the at least one processor and computer stored in a secure manner and capable of transmitting data to download to the at least one remote monitoring system;
a physical connector interface port responsively connectable to the at least one proccessor and computer and at least one of protected, sheilded and maintained in a secure manner, and capable of transfering data to download to the at least one remote monitoring system;
an optical light data transmission port responsively connectable to the at least one proccessor and computer and securely maintained, and capable of trnsmitting data to download to the at least one remote monitoring system;
a multi-tasking law enforcement device capable, optionally through electronic security protocols, to communicate with the at least one proccessor and computer and download to the at least one remote location;
at least one processor and computer responsively connectable to at least one memory and at least one auxiliary communication device in a seure manner that can be processed to any other communication device responsibly connectable to the proccessor or computer to download the data to the at least one remote monitoring system;
at least one proccessor and computer responsively connectable to a Global Positioning System (GPS) and responsively connectable to other communication devices in a secure manner and capable of transmitting GPS coordinate data protocol to the at least one remote monitoring system;
at least one processor and computer responsively connectable to at least one magnetic card swipe device that can transmit via other communication devices to the at least one remote monitoring system for at least one of billing, debiting and crediting;
at least one processor and computer responsively connectable to at least one of audio and video devices and other communication systems to at least one of guide and control remotely a vehicle;
at least one proccessor and computer responsively connectable to at least one memory to record at least one of an audio and video signal, and data used to control a vehicle remotely.

7. A real-time vehicle management system including a security function that restricts unauthorized access thereto, comprising:
a memory located in or on the vehicle in a secure manner, storing information in a secure manner preventing unauthorized access thereto, including storing a plurality of interface protocols for interfacing and communicating with a plurality of external devices;
at least one processor responsively connectable to said memory, and implementing the plurality of interface protocols for interfacing and communicating with the plurality of external devices; and
at least one wireless communication device interfaced or integrated and resposively connectable to said processor to remotely controll or remotely interface with the plurality of external devices.

8. A real-time vehicle management system according to claim 7, wherein said real-time vehicle recording system is substantially stored in a stop and control box to prevent unauthorized access thereto and the vehicle

9. A real-time vehicle management system according to claim 7, further comprising a payment mechanism in or on the vehicle, responsively connectable to said at least one processor, said payment mechanism collecting vehicle information and providing real-time billing, debiting or crediting from the vehicle, and retrieving at least one of a script or electronic signature from a card carrier, and verifying the identity of the card carier via at least one of photograph, fingerprints, and identification.

10. A real-time vehicle recording and optionally reporting system according to claim 7, further comprising at least one operations sensor recording operations of the vehicle, and wherein the operations of the vehicle are received from said operation sensor and stored in said memory and downloaded to at least one of a remote monitoring system, a remote billing system, and a remote data analysis system.

11. A real-time vehicle recording and optionally reporting system according to claim 10, wherien said at least one operations sensor further comprises at least one of equipment operational sensors, environmental sensors, on-board audio or video equipment sensors.

12. A real-time vehicle recording and optionally reporting system according to claim 7, wherein said at least one processor peforms at least one of the following functions:
remotely controlling at least one of robotic functions to activate and control vehicle operations, remotely billing for use of the vehicle, remotely operating at least one machine, evaluating and diagnosing computer or processor malfunctions, remotely ordering materials and service personel to perform at least one of service and repairs, remotely performing price quotes for cost of the at least one of service and repairs, remotely performing repairs electronically, and remotely shutting down equipment;
remotely controlling data exchange representing a monetary exchange via a focal node to perform a secure and protected containment function of: to restrict unauthorized use of equipment, to record and preseve data in an acceptable legal manner, and to bill at least the vehicle user, thereby providing a total accountability system;
at least one of networking and communicating with at least one gateway to other computers and computer networks that manage data, said gateway determining whether the other computers and computer networks are to be at least one of networked and communicated with to further monitor and store data for at least one of billing, regulatory compliance and legal compliance, and optionally for at least one of social economic and environmental impact;
at least one of networking and communicating with at least one of other computers and computer networks that manage data, including at least one of vehicle location, equipment technical assistance, personal accounting for machine or equipment use, billing, debiting, crediting, vehicle operations, service and repairs; and
monitoring equipment for health and safety conditions potentially adversely affecting the public, including at least one of reckless driving, driver impairment, pollution, vehicle unsafety.

13. A real-time vehicle recording and optionally reporting system according to claim 7, wherein said at least one processor peforms at least one of the following functions:
collecting machine message data from said real-time vehicle recording system used to compile data for a public media or web page, and transmitting the machine data thereto;
presenting the machine message data on at least one web page that originated from at least one equipment on said real-time vehicle or from a machine messaging network;
recording and reporting to a monitoring gateway for billing for highway use by the vehicle;
collecting and storing data corresponding to charging at least one electric vehicle;
reporting, recording and billing automatically using a real-time billing system in the vehicle corresponding to time a geographic area roadway is used;
determining impact on environment including roadways, using at least one sensor recording at least one of:
weight and emmissions ratings for atmospheric impact type of at least one of fuel and energy used;
time of operational machine use;
amount of fuel or energy used;
type of waste product produced;
amount of the waste product produced.

14. A real-time vehicle recording and optionally reporting system according to claim 7, wherein said at least one processor performs at least one of the following functions:
recording at least one of audio and video traffic vehicle impact, and recording and reporting to at least one remote monitoring system for at least one accident investigation and machine accidents in a data secure manner;
recording information used in insurance investigations to decide claims and assign liability;
determining liability and accountability to be used in legal procedings and optionally to be used in determining safety parameters, rules, regulations and laws;
recording at least one of audio and video captured crimial incidents by activating unattended vehicle systems to report criminal events through remote control;
recording at least one of audio and video captured news events as witnessed by a machine system including at least one of weather conditions, and traffic conditions.

15. A real-time vehicle recording and optionally reporting system according to claim 7, further comprising at least one operations sensor recording information including at least one of operations of the vehicle, highway conditions, speed limits, driving conditions including speeding, reckless driving, drunken driving, road rage, pensive or inefficent driving, and wherein the information of the vehicle are received from said operation sensor and stored in said memory and downloaded to at least one of a remote monitoring system, a remote billing system, and a remote data analysis system.

16. A real-time vehicle recording method administered via a stop and control box, said method recording use of a vehicle, comprising the steps of:
(a) recording the operations of the vehicle as a recording signal, the recording signal indicative of at least one of socio economic impact, environmental impact, predetermined impact, and an arbitrarily determined impact relating to usage of the vehicle;
(b) storing the recording signal received from said operation sensor in a secure manner; and
(c) determining, responsive to the recording signal, the at least one of socio economic impact, environmental impact, predetermined impact, and an arbitrarily determined impact for use in assessing at least one of vehicle owner and vehicle operator.

17. A real-time equipment management system including a security function that restricts unauthorized access thereto, comprising:
a memory located in or on the equipment in a secure manner, storing information in a secure manner preventing unauthorized access thereto, including storing a plurality of interface protocols for interfacing and communicating with a plurality of external devices;
at least one processor responsively connectable to said memory, and implementing the plurality of interface protocols for interfacing and communicating with the plurality of external devices; and
at least one wireless communication device interfaced or integrated and resposively connectable to said processor to remotely controll or remotely interface with the plurality of external devices.
